(19) United States
(12) Patent Application Publication
(10) Pub. No.: US 2025/0031938 A1
(43) Pub. Date: Jan. 30, 2025

(54) KITCHEN STORAGE COMPARTMENT SYSTEM FOR USE IN A HABITAT

(71) Applicant: Benjamin David Jeton Steeper, Cypress, OH (US)

(72) Inventor: Benjamin David Jeton Steeper, Cypress, OH (US)

(21) Appl. No.: 18/784,330

(22) Filed: Jul. 25, 2024

Related U.S. Application Data
(60) Provisional application No. 63/529,107, filed on Jul. 26, 2023.

(51) Int. Cl. A47L 15/00; A47B 77/08; A47J 43/24; A47L 15/42

(52) U.S. Cl. CPC A47L 15/0084; A47B 77/08; A47J 43/24; A47L 15/4217; A47L 15/4285

(57) ABSTRACT

A storage system for use in a habitat includes at least one compartment housing one or more kitchen item cubbies which are individually and separately sprayed with fluid, and are connected to at least one conduit operably disposed in the habitat to receive and convey fluid to or from the compartment and can be independently operated manually or automatically.

The present invention relates to the field of washing and storing various types of kitchen items 23, especially those that need to be regularly stored, accessed, heated, cooled, washed and/or rinsed. Such items include dishes pots, pans, utensils, ladles, mugs, wine glasses, straws, plates, bowls, etc. and food items 23 such as beverage containers, vegetables, fruits, meat, and food containers.

### BACKGROUND OF INVENTION

Broadly speaking, our current habitat includes processes performed in a kitchen, involving moving food, drinks and dishes to and from large appliances and storage areas such as fridges, freezers, stoves, sinks, dishwashers, cabinets, drawers, countertops, microwaves etc (FIG. 179). In this regard, these appliances and storage areas are referred to herein as “kitchen locations”. Appliances today are typically large box-shaped units that house many items at once.

Each appliance also usually only serves one function, or a limited number of functions. For example, fridges cool food, cabinets store dishes, and dishwashers wash dishes. Each “box” (i.e. fridge, dishwasher, cabinet etc.) is designed to serve a particular function to all elements inside the box. Fridges may keep all the food and drinks cold, but they don't wash your dishes. Some example kitchen locations include: fridge, freezer, dishwasher, cabinets, drawers, countertops, sink, and eating areas.

Currently, users move dishes, food and drinks from one kitchen location to another, in order to change the states of the dishes, food or drinks from an undesired state to a desired state. For example, a user may take a warm bottle of apple juice and place it in the fridge to change its state from warm to cold. A user may also load and start the dishwasher to change the state of each dish from dirty to clean. The instant application refers to these items that are moved by users (e.g. a bottle of juice, a fork, a bowl, carrots, stored leftovers, bread, cheese, bowls, plates, cups, mugs, glasses, spoons, forks, chopsticks, pots, and pans, etc. as “kitchen items”.

Each kitchen item can exist in various states. For example, a bowl can be clean and in storage, soaking in the sink, or sitting dirty on the counter. A bunch of carrots may be in room temperature storage in the cabinet, dirty (unrinsed) and in cold storage in the fridge, or rinsed and in cold storage in the fridge. The instant application will refer to the various possible states of kitchen items as “kitchen item states”. It is important to note that a kitchen item is able to exist in one or more states at a time (e.g. cold and clean). Some example kitchen item states include: frozen, cooled, heated, in storage, rinsed, soaking, washed, washing, dried, and drying.

There is a need to improve the current kitchen environment and manner for managing the states of kitchen items. Particularly, there is a need to improve managing kitchen item states in moving them from one kitchen location to another, often needing to complete a task or multiple tasks at the location before moving the kitchen item to a new location.

A dish can embody many different shapes and sizes and serve various functions. The typical dishwashing cycle involves a combination of handwashing and using a dishwasher appliance. For example, users will often hand scrub their greasy pots and pans in the sink, but place their mugs and cups upside down in the top rack of their dishwasher appliance. Traditional dishwasher appliances house large batches of dishes together and put them through a wash cycle. A dishwashing cycle typically involves washing, rinsing, and sometimes drying the dishes. It's important to note that some users don't have dishwashers and solely rely on washing by hand. Others have small countertop dishwashing appliances they use in combination with hand washing. Some users even use their dishwasher racks as storage for their clean dishes, instead of the cabinets and drawers. Regardless of the user and their specific methodology, however, the current dishwashing process always requires users to be responsible for managing the various states and locations of their dishes. Dishes can exist in various combinations of states. Some of the key dish states in the dishwashing process include:
Dirty & Dry: a dish that is contaminated by food or drink and the food or drink has solidified on the dish surface;
Dirty & Unsolidified: a dish that has been recently contaminated by food or drink and the food or drink has not yet solidified on the dish surface;
Dirty & Rinsed: a dirty & unsolidified dish that has been rinsed or a dirty & solidified dish that has been soaked and scrubbed (typically left in the sink). Note in this state the dish has still not yet been fully washed, only rinsed;
Soaking: a dirty dish soaking in water (often in the sink with hot soapy water) Clean & Wet: the dish has been washed and rinsed, but is still wet and drying; and
Clean & Dry: the dish is clean, dry and ready for use.

To transition dishes from an undesired state to a desired state, users typically move them through a cyclical sequence of locations, defined here as the dishwashing “pipeline”. This pipeline starts and ends where the dishes are ultimately stored in the clean and dry state (typically a cabinet or drawer). Listed below are some of the main dish locations along with a brief description of their key functionalities. The primary goal of this section is to define the key stages (also known as locations) in the typical pipeline of washing the dishes (see FIG. 1).

Cabinets provide an isolated storage area for the user to place or stack clean dishes. Drawers also offer a storage area for dishes, namely utensils. Protection: When closed, cabinets and drawers help to protect dishes from outside contaminants such as dust, germs or falling debris.

When dirty dishes are left out for too long they become ‘Dirty & Solidified’, and are much more difficult to clean. Countertops provide extra buffer space for clean or dirty dishes as they traverse through the dishwashing pipeline.

The sink can serve as a place to store dishes when 1) the dishwasher is running, 2) the dishwasher is full or not yet unloaded, or 3) the user wishes to drop the dish quickly and conveniently to deal with later (either due to laziness or lack of time). The sink also functions as a place to rinse dishes before loading them into the dishwasher, soak dishes that are very dirty or solidified, and wash dishes by hand. With insertable sink-compatible drying racks the sink can also serve as a place to dry dishes.

Dish racks hold and space out dishes allowing them to dry faster. Dish racks often double as extra storage space for clean dishes, especially when cabinets and drawers are overflowing, or when users fail to load their clean and dry dishes back into storage.

Dishwashers typically have washing, rinsing, and sometimes drying. These are the key functions involved in the typical dishwashing cycle. Dishwasher racks are sometimes used as storage space for dirty dishes or clean dishes. They are especially used as storage space for clean dishes when the dishwasher is not used (e.g. when hand washing is preferred).

Exemplary steps can include where the user grabs a clean dish from the cabinet or drawer and uses it to eat or drink, dirtying the dish. At this point the dish is in the ‘Dirty & Unsolidified’ state. A competent user will bring the dish to the sink immediately to be rinsed, transitioning its state almost immediately to ‘Dirty & Rinsed’. An incompetent user will allow the dirty dish to sit for a while, transitioning its state to ‘Dirty & Dry’ over time. ‘Dirty & Dry’ dishes almost always need to be hand scrubbed in the sink or soaked before being either hand washed or placed in the dishwasher. Once the dirty dishes are prepared for washing (i.e. rinsed, scrubbed or soaked if necessary), the user has two methods to choose from: 1) the hand-washing method, and 2) the dishwasher method.

In hand washing, the user washes and rinses the dirty dishes with soap and water in the sink by hand. The ‘Clean & Wet’ dishes are typically placed in a drying rack to dry. After waiting for some time, the user then moves the now ‘Clean & Dry’ dishes from the drying rack into the cabinets and drawers.

With a dishwasher, the user loads the dirty or ‘Dirty & Rinsed’ dishes into the dishwasher. It will typically take a few cycles of meals before the dishwasher is filled up, depending on how many dishes are used and how many users are sharing the kitchen.

Once the user deems the dishwasher adequately full, the user starts the dishwasher and waits for the cycles to complete. The now ‘Clean & Dry’ dishes are then unloaded from the dishwasher into the cabinets and drawers. If the dishes are still wet after the dishwasher cycles are complete (as is often the case), the user will need to either 1) wait some extra time for them to dry in the dishwasher, or 2) unload them into the drying racks to dry before moving them into the cabinets/drawers.

The current dishwashing process as described poses several problems, much of which can be traced back to bottleneck issues in the dishwashing pipeline. Some of the main problems are set forth. Dirty dish overflow is a tendency for dirty dishes to build up in the sink and countertop area, becoming a large and inconvenient future task for the user to bear. This can be due to user laziness, a busy schedule, or dishes being blocked by a full dishwasher (whether full and dirty, running, not yet unloaded etc.)

Clean dish overflow occurs sometimes when users run out of available storage space for their clean dishes, forcing them to stack arbitrarily sized dishes tediously on a drying rack or squeezed in a tight cabinet space. This is why some users choose to use their dishwasher racks as extra storage space for clean dishes. This method is especially popular among users who live in smaller living spaces.

Cross contamination (unsanitary) occurs due to the proclivity for dirty dishes to build up, dirty dishes often contaminate less dirty dishes unnecessarily while dishes sit together in limbo, awaiting the next phase of the bottleneck (e.g. grease from a pan leaking onto a water glass in the sink). Cross contamination makes dirty dishes even dirtier, which is the opposite effect desired in any dishwashing process.

Dishes are held up in many bottlenecks before moving onto the next phase or stage in the dishwashing pipeline as shown in FIG. 1, FIG. 3, and FIG. 4. Space efficiency under the current system is not very good. At any given moment, if you add up the total combined volume of the cabinets, drawers, dishwasher, and countertop/sink space used in the dishwashing pipeline, much of the space goes unused. This is in part due to the fact that the large boxes in the dishwashing pipeline (namely the cabinets and dishwasher), are constantly being emptied and filled again. Safety in reaching for steak knives or other sharp objects in the dishwasher, drying rack, or sink can be dangerous since their position is unpredictable (ex: they could be facing blade side up). Dishes may also topple over unexpectedly in this type of unpredictable unstandardized environment, injuring users or causing them more future work. Escaping utensils can occur, such as chopsticks or forks can sometimes fall through the dishwasher or drying rack, requiring them to be “fished” out. This can be inconvenient. Lack of standardization of dish sizes can be problematic. Dishes and the dishwashing pipeline is one of the least standardized processes in the kitchen. Dishes come in all sorts of different shapes and sizes.

Users alone are responsible for moving dishes from one location in the pipeline to the next. These are repetitive and laborious tasks for the user to bear. Bringing dirty dishes to the countertop and sink area to rinse and soak, loading and unloading the dishwasher, moving dishes to and from cabinets, drawers and drying racks (see FIG. 1, FIG. 3, and FIG. 4).

Users typically have to get their hands wet at some point to rinse or soak dirty dishes, even when using a typical dishwasher (since many dishes still need to be pre-scrubbed, pre-soaked or pre-rinsed before being loaded into the dishwasher). This is an inconvenience, and also potentially dangerous.

When placing dishes in the dishwasher racks, users need to pay attention to dish orientation, positioning on the rack wires, angle and proximity to other dishes. For example, bowls cannot be placed facing upright, and dishes shouldn't be touching or blocking other dishes from the sprayers' view. Similarly, in the drying rack (often next to the sink), there is often not enough room for many dishes of different sizes and shapes to fit nicely. Dishes will often need to be awkwardly and creatively stacked on top of one another, to ensure that they are oriented in an ideal drying position (e.g. ensuring adequate spacing between dishes). This adds extra complexity and is extra tedious, inconvenient and time consuming for the user.

Throughout the dishwashing pipeline process, users are sometimes required to halt working and return to a task later on. For example, once the dishwasher has been started, users need to wait for the cycle(s) to finish, dry, then come back again (context switch) to unload. Users may also choose to rinse some dishes in the sink and then leave them there to deal with later, whether due to bottlenecks, laziness or time constraints. This added context switching is burdensome for users. It's always difficult to halt a task and then return to it later.

It can be argued that washing a large batch of dishes together in one large box, is not a very efficient approach, especially since the box is rarely filled to its maximum capacity. Consider the following fitting analogy. Which of the two options is the more efficient carwash method? A car-wash in an airport hanger washing large batches of cars all together at once with one giant sprayer, or a typical drive-through car-wash containing and washing only one car at a time? The latter would most likely be far more efficient. Current dishwashers are simply one excessively large container. It can be argued that numerous smaller specialized containers could more efficiently allocate energy and water resources to their respective dishes, like a car-wash. This is especially true if the dishes are standardized and designed to fit a particular compartment, since the compartment can be designed to be no larger than necessary to fit that particular dish. Less volume and a standardized environment in the compartment probably means less water would be needed, and most likely less overall energy as well.

The current dishwashing pipeline often requires more dishes than users actually need: Most users won't find it worthwhile to run the dishwasher with only a few dirty dishes inside. Instead, it's usually expected for the dishwasher to be full or close to full before running. This means that in small groups, users are incentivized to have a large number of dishes to be able to fill the big box (dishwasher appliance). This is also why many users who share a kitchen with a small number of people, prefer to keep just a few dishes and hand wash them in the sink rather than use their dishwasher. It's also the rationale and typical target market behind tiny countertop dishwashers (simply make the box smaller).

Regarding pain points related to overall kitchen operations (namely food and drink management), the typical flow involves grabbing food or drinks from the fridge or cupboards, optionally bringing them to the stove or microwave to cook, eating or drinking, and then returning any leftovers to tupperware containers to be stored in the fridge. For example, a user may grab a bag of carrots from a drawer in the fridge, rinse them in the sink, chop some up for a salad, then return the remaining carrots back into the bag and put the bag back in the fridge. When the drawer in the fridge becomes empty, another food item will eventually take its place. Drawers, shelves and compartments in the fridge are rarely ever cleaned. With the multifunctional compartment system, however, the carrots could be stored in a small temperature controlled vegetable-specific compartment. The user could simply press a “rinse” button on that compartment and rinse the carrots inside. The user could then take the carrots out, chop them up and return the remainder of the carrots back into the compartment. When the compartment eventually becomes empty, the user could simply press a “wash” button and wash out the compartment so that it will be clean before reloading the compartment with new vegetables in the future. Meat, liquids or other fridge items could also have their own compartments which are individually temperature controlled and able to be individually washed or rinsed, just like the multifunctional compartments housing dishes.

Accordingly, there is a need to improve over the current dishwashing and storage methods and devices which currently exist. The present invention aims to overcome the deficiencies in the above mentioned devices and methods.

### SUMMARY OF INVENTION

One aspect of the invention is to provide a smaller kitchen storage system 10, which sits on a countertop (FIG. 59). The countertop approach diminishes the bottleneck problem especially for small living spaces where space is limited and less kitchen items 23 are needed in everyday life. Other forms of the invention include a multi-compartment kitchen storage system being integrated into the cabinets (FIG. 1), embedded within the countertop or sink (FIG. 94), or placed underneath the countertop in the form of drawers (FIG. 102).

A primary objective is to minimize the amount of user work involved in working and managing a kitchen. Ultimately a goal is to combine all the “dish locations” mentioned earlier, into a single system 10, so that the user no longer needs to manage the process of moving dishes 23 from one location to another in order to manage dish states. Ideally, instead, the user should be able to discard a dish or kitchen item 23 in an undesired state, and then pick up the item in a desired state, with no unnecessary tasks in between (with the exception of possibly interacting with an interface 45, like pushing a few buttons 41 42). To make this possible, multiple functions (e.g. storing, cooling, heating, washing, rinsing, drying) needs to be available to each individual compartment cubby 27 containing a dish or kitchen item 23 within the one system 10.

It is an object to assemble these elements involved in kitchen operations, i.e., kitchen locations, kitchen items, kitchen item states.

This invention combines the functionality of a cabinet, dishwasher and sink into one storage space for various items. It can be characterized as a compartment system of small cubbies 27 isolating each kitchen item 23, each individual cubby 27 serving the functionality of storing, washing, rinsing, drying, and heating/cooling each kitchen item 23 independently.

The invention can be described as a set of multifunctional kitchen compartments connected to a backend which can provide numerous services (or functions) to each compartment cubby 27 individually, such as storing, washing, rinsing, drying, heating, and/or cooling. To make this possible, the backend can provide water (with the option of infusing soap into the waterline) and possibly air, both at a controlled temperature. The cubby 27 and subsequently its kitchen item 23 temperature can also be controlled with a heating element around or inside each compartment, or by other methods. Additionally, a compartment can consist of a set of partitions, where one compartment shares a wall with an adjacent compartment. Each individual space for a kitchen item inside a partitioned compartment is called a cubby 27. Kitchen item cubbies 27 can house various kitchen items 23, such as dishes (plates, bowls, cups, mugs, pots, pans, forks, knives, spoons etc.), food, drinks or other items. It is contemplated, each cubby 27 serves as a location for a single kitchen item 23 to be stored, washed, rinsed, dried, heated, and/or cooled independent from the other cubbies 27.

A compartment access point is the point and method by which the user opens or closes the compartment. Therefore since a compartment may contain multiple cubbies 27, two or more cubbies 27 may share a common access point. If sharing a common access point, when the access point is “opened”, any fluids that are being delivered to the affected cubbies 27 will be temporarily shut off. When the access point is “closed” again, the fluids will resume being delivered to the same cubbies 27 as before. So in short, opening an access point pauses fluid delivery to all cubbies 27 sharing that access point. There can be several different types of access points, namely: shared cubby hinge lid 21 (FIGS. 73-76, 94, 95), single cubby hinge lid 20 (FIGS. 33-52, 79-93), rotating lid 22 (FIGS. 165-170), drawer 19 (FIGS. 53-58, 102-113, 115-153). Note that the pot and pan shown in FIG. 142 (and some other drawings) is a single cubby drawer in that particular example, not a shared cubby drawer like the other drawers in that embodiment. Additionally, hinge lids can have two “doors” with hinges on both sides similar to a traditional trap door design, instead of the “single door” designs shown in the drawings. For cylindrical compartment designs a round pipe rotating inside the compartment may also function as a lid. The lid also functions as a way to block the access to the drain conduit 18 while the compartment is open (FIGS. 171-174). The reason a drawer or “bottom-hinge” lid design is typical for side access designs is so that falling debris from dirty dishes has somewhere to be caught when loading dishes into the compartment.

It is contemplated that the compartments can be laid out in various orientations. These include: vertical plane cubby layout 49 (FIGS. 1-16, 21-32), horizontal line cubby layout 50 (FIGS. 59-72, 77, 78), horizontal grid cubby layout 51 (FIGS. 94-101), and vertical plane drawer layout 52 (FIGS. 115-153). Compartments and drawers in a “vertical plane” layout can be oriented in either a line or a grid. The vertical plane cubby layout 49 can be integrated into traditional cabinets or be mounted on the wall as the cabinets themselves. In the future they could be embedded into the wall itself. The horizontal line compartment layout and the horizontal grid compartment layout can either sit on top of the countertop or be embedded into the countertop or sink.

A number of fluid direction control devices 48 are contemplated. In this regard, one or more static (not moving) mechanical valves 48 per kitchen item cubby 27, a static (not moving) solenoid valve 48 or other electronically actuated valve 48 per cubby 27, or a moving spray head behind or under the compartments (either 1 dimensional movement or 2 dimensional movement) can be controlled with a single fluid direction control device.

For static (non moving) mechanically actuated valves 48, each cubby 27 can have its own allocated mechanically actuated (opened or closed) valve(s) 48. Typically this means that the valve or valves are operably connected to the compartment access point mechanism so that when the user opens or closes the access point, the valve or valves are opened or closed. It is contemplated there can also be other mechanisms such as a spring loaded or hydraulic timer which shuts off the valve(s) 48 automatically after a delay once the access point is shut with a dirty dish 23 inside. This type of valve would be self-closing, similar to how “delay faucets” work. Static mechanical valves 48 can also be simple regular valves which are opened and closed by the user (FIG. 65), although this is less convenient than self-closing options.

As for the static solenoid method, each valve for a given cubby 27 can be opened and closed electronically depending on various inputs. For example, opening and closing the lid may trigger the valve 48 to open (activated by an electrical contact 35, e.g., two plates of metal make contact), or a distance or weight sensor can be employed to detect that a new kitchen item 23 is inside 47 (FIG. 52). As for turning off the valve, a simple timer could be used, or a more complex system of detecting when the dish is clean could be used.

Like other design aspects of this invention, the spray head can either be underneath the compartments pointed up, or behind the compartment facing towards the user. The moving spray head design can be fitted on both top access and side access designs. Additionally, instead of nozzles mounted to the spray head, another variation of this design instead aligns a tube on the “moving head” with another opening on the compartment, which then spreads water throughout the compartment (similarly to how a space shuttle connects to the space station, then later detaches).

A number of spray mechanism configurations are contemplated to target the compartment and its contents with fluids. In considering a spray method, the goals are to minimize space, ensure adequate force to clean, ensure full coverage, and minimize complexity (and therefore potential fail points).

Each compartment can be modular, meaning they can be removed and attached to the backend to create customized compartment layouts (FIG. 18). Modularity, however, is not a requirement. Compartments can also be permanently connected to one another sharing walls with neighboring compartments, similar to a cubby storage organizer (FIGS. 94-96).

As for water pressure, the device can 1) use the home's natural water pressure (assuming pressure is sufficient), 2) a pump 38 can be added to the delivering fluid line 16 to boost and regulate pressure to keep pressure constant, and include a controller to control pressure or 3) a miniature boiler or “pressure cooker” design can be implemented, where water is heated in a sealed container and then released in bursts, optionally with steam as well. This could be dangerous but highly effective. High grade metal and seals can be used, along with a heating element (or another heating method) to heat the water. In fact, if the water is hot enough, soap might not even be needed at all to effectively clean the dish.

It is envisioned that soap can be infused into a delivering fluid line 16 using a fluid direction control device 48. For design options involving multiple valves 48 (one for each cubby 27), multiple soap valves 48 could also be used. There is also the option of mechanically dispensing soap into the cubby 27 or onto the contents of the cubby 27, or mechanically infusing soap into the line 16. This could be done when the access point closes, for example, squeezing a pouch or cell which releases one “dose” of soap into the fluid line 16. Soap is not necessarily required however, and other cleaning agents could be added to the water such as vinegar. Certain agents like vinegar could also remove the need for a rinsing phase and the added complexity of designing and managing soap infusion (and potentially reduce the number of required fluid lines 16). However, soap is still the main approach being pursued currently.

Cubby 27 contents or empty cubbies 27 themselves can also be rinsed or rinsed out. Rinsing can occur on its own or after a washing session with a cleaning agent like soap, to flush out the cleaning agent from the fluid line 16 and inside the cubby 27. If using soap for instance, after soap is finished being infused into the waterline 16 by either electrical or mechanical means 48, the fluid (e.g. water) can continue to run through the line to rinse out the remaining soap. If the water continues to run for a given amount of time there will be no more soap left in the line and the cubby 27 can then enter the “rinse” phase of the cycle.

A fan or other mechanism can circulate air through a separate pipe or channel designated for air or the drain conduit itself 18, which can also have the possibility of doubling as a source of temperature control 40. In its simplest form, however, this pipe or air channel would have a fan at one end, and be able to pass moving air behind or underneath the kitchen item cubbies 27. Air can either pass through all the cubbies 27, or separate valves 48 can be assigned to each cubby 27, connected to the air channel. Another even simpler option to dry dishes 23 is to have the access point pop open after cleaning to air dry (like hanging clothes on a line). This would only work for single compartment access points 20 (or a single rotating lid design 22) however, not shared access points 21 (or a shared drawer 19). The compartment access point could also remain closed, but vents (for example small openings or slits in a part of the container) can be added so that the compartment is only partially sealed. The air channel just described could pass behind these vents to form a vacuum effect, sucking air out of each cubby 27. These openings or vents could also allow built up steam to escape each cubby 27 during cleaning if very hot water is used. There are many options to dry out the cubbies 27 and their contents 23.

A drainage conduit carries dirty fluid away from the compartments towards a centralized waste disposal area, such as a sink (FIG X). While PVC piping is one example of the structure, the invention doesn't require it to be pipe. It can be any type of drainage channel (like a gutter) which collects and directs the dirty water outside the system.

To control the temperature inside each kitchen item cubby 27 individually, a number of methods can be used. Cold or hot air could be blown into the compartment for drying or heating/cooling through a delivering fluid line 16. Also heating elements can be used either inside the cubby 27 or attached to the cubby 27 to heat dishes or food or drinks. For cooling, methods similar to how fridges work could be used to run a cooling line to each cubby 27. For temperature control to work effectively, each cubby 27 will need to be well insulated (namely the cubby 27 walls) so that the environment or the temperature of one cubby 27 does not affect the temperature of another cubby 27 too much.

Accordingly, a broader aspect according to the invention is directed to a kitchen storage system. The kitchen storage system includes one or more individual compartments containing one or more cubbies 27 which are connected to at least one conduit. The conduit is operably disposed in a habitat to receive and convey fluid and/or air to or from the cubby 27. The cubby 27 can be configured with one or more devices designed to control the direction 48 or characteristics 39 of fluid flow (specially to increase velocity 38) as it exits (or enters) the cubby 27. In one embodiment, there can be multiple conduits where one delivering fluid line 16 can removably interconnect to a water line, such as a kitchen sink faucet, and the cubby 27 to deliver water to the cubby 27 and another removably connected removing fluid conduit 18 takes fluid and other waste from the cubby 27 to a sink 63 or a drain area. In another embodiment, the delivering fluid line 16 can be operably connected to a fluid/air temperature altering device 40 for altering the temperature of the fluid and or air delivered to the cubby 27.

A more full understanding of the invention will be apparent from reading the following description and viewing the drawings hereto.

### BRIEF DESCRIPTION OF THE DRAWINGS

FIG. 1 depicts plate, bowl, and cup compartments (from left to right) laid out in a cabinet form (vertical plane compartment layout) 49. Three delivery fluid lines 16 and one drainage conduit 18 connect each compartment 12 to a sink area 63 in a traditional countertop unit 62. In the depicted embodiment, cups are positioned upside down, and bowls and plates are positioned on their side. Depicts a frontal view.

FIG. 2 is the see-through version of FIG. 1. The dotted lines inside the compartments show plates, bowls, and cups 23 as well as the dish retainers, which suspend the dishes in their compartments.

FIG. 3 depicts an isometric view of FIG. 1. Notice the cabinets are only one compartment 12 deep, making them shallower than traditional wooden cabinets.

FIG. 4 depicts a right side view of FIG. 1.

FIG. 5 depicts FIG. 2, except from an overhead view. Access point handles 26 can be clearly seen, as well as the sink 63 or disposal area where drainage conduit 18 flows into.

FIG. 6 is the see-through version of FIG. 5. The dotted lines depict outlines of the dishes and dish retainers inside each compartment.

FIG. 7 depicts a closeup of the compartment system of FIG. 1 excluding the countertop and sink. Note that this layout does not need to be located over a sink and countertop. It can be embedded into the wall itself or located anywhere with access to fluid line(s) 16 and a disposal area.

FIG. 8 depicts a see-through version of FIG. 7 with empty compartments. Since each compartment 12 is empty, the kitchen item retainers 24 inside are clearly visible.

FIG. 9 depicts FIG. 8, except with compartments filled with dishes instead of empty.

FIG. 10 depicts the isometric view of FIG. 7.

FIG. 11 depicts the right side view of FIG. 7.

FIG. 12 depicts the see-through version of FIG. 11. Notice the “shower head wall” grooves 59 in this embodiment, illustrated by the dotted concentric circles.

FIG. 13 depicts the overhead view of FIG. 7.

FIG. 14 depicts the overhead see-through view of FIG. 7 with empty cabinets.

FIG. 15 depicts the overhead see-through view of FIG. 7 with cabinets filled with kitchen items 23.

FIG. 16 depicts the bottom view of FIG. 7. Notice the delivering fluid lines 16 forking off to each compartment 12.

FIG. 17 depicts FIG. 7, except with some compartments 12 missing. This illustrates the ability for compartments to be removable and modular, docking and undocking from the “backend” (frame, delivery fluid lines 16, drainage conduit 18, electrical connection etc.). This way layouts can be customized, and faulty compartments can be removed and repaired or replaced.

FIG. 18 depicts the isometric view of FIG. 17.

FIG. 19 depicts a frontal view of the delivery fluid lines 16 and drainage conduits 18 of FIG. 7, without the compartments 12.

FIG. 20 depicts the isometric view of FIG. 19.

FIG. 21 depicts nine cup compartments 12 with “single compartment hinge lid” access points 20 laid out in a vertical plane compartment layout 49. The compartments 12 are filled with cups 23, shown by the dotted lines.

FIG. 22 depicts the isometric non see-through view of FIG. 21.

FIG. 23 depicts the frontal view of nine bowl compartments 12 with “single compartment hinge lid” access points 20 laid out in a vertical plane compartment layout 49.

FIG. 24 depicts the see-through version of FIG. 23, showing bowls 23 inside with the dotted lines.

FIG. 25 depicts the isometric see-through view of FIG. 23, with empty compartments 12. The “shower head wall” grooves 59 are clearly visible in each compartment shown by the dotted lines.

FIG. 26 depicts a side view of FIG. 23. Notice the three delivering fluid line stem connectors 58 connected to each compartment 12.

FIG. 27 depicts the see-through version of FIG. 26. The “shower head wall” grooves 59 can be clearly seen, as well as each compartment's interface housing 45, access point handles 26, and kitchen item retainers 24. Also notice the slight slope 11 of each compartment 12 floor leading to the compartment drainage opening 15.

FIG. 28 depicts the frontal view of ten plate compartments 12 with “single compartment drawer” access points 19 laid out in a vertical plane compartment layout 49.

FIG. 29 depicts the see-through version of FIG. 28 with compartments 12 filled with kitchen items 23.

FIG. 30 depicts FIG. 28, except with one compartment sliding drawer 53 open (bottom row, second from the right). Notice the open compartment appears elevated slightly from a frontal view, due to the sloped floor 11 of the compartment 12.

FIG. 31 depicts the isometric view of FIG. 28.

FIG. 32 depicts the isometric view of FIG. 30.

FIG. 33 depicts the multi-view orthographic projection of a closed cup compartment 12 with a “single compartment hinge lid” access point 20. In this embodiment, cups 23 are stored upside-down. This embodiment also has three fluid line stem connectors 58 attached to an interface housing 45 at the front of the compartment 12. This particular interface consists of a wash button 41, a rinse button 42, a temperature control knob 43 with a small screen 44 to display the compartment's current temperature or other information.

FIG. 34 depicts the see-through version of FIG. 33 filled with cups. See the “shower head wall” grooves 59 on the floor, wall and ceiling of the compartment 12. In this embodiment, fluids spray up from the floor and down from the ceiling of the compartment through cone shaped nozzle holes 30 towards the cup 23.

FIG. 35 depicts FIG. 33, except a cup 23 is inside the compartment 12 and the compartment hinge lid 20 is open. Notice with this cup compartment hinge lid design, the lid does not need to swing open the full 90 degrees (only about 25-50 degrees) for the cup to be retrieved or dropped.

FIG. 36 depicts the see-through version of FIG. 35. Notice in this embodiment the kitchen item retainer 24 holding the cup consist of just two wires protruding from the hinge lid.

FIG. 37 depicts the multi-view orthographic projection of a closed bowl compartment 12 with a “single compartment hinge lid” access point 20.

FIG. 38 depicts the see-through version of FIG. 37, with empty compartments.

FIG. 39 depicts FIG. 37, except the compartment hinge lid 20 is open and the compartment 12 is empty. Notice in this embodiment, the kitchen item retainer 24 is more complex, consisting of a rolling frame that slides forwards and backwards as the lid opens and closes.

FIG. 40 depicts the see-through version of FIG. 39.

FIG. 41 depicts FIG. 39, except the compartment 12 contains a bowl 23. Notice how the rolling cage 24 holds the bowl, and slides in and out of the compartment 12 as the hinge lid 20 is opened and closed.

FIG. 42 depicts the see-through version of FIG. 41.

FIG. 43 depicts a close up isometric view of a closed bowl compartment 12. Notice the interface housing 45 with a wash button 41, a rinse button 42, and a temperature control knob 43 with a screen 44 to display temperature. Also notice the little handle 26 on the top of the hinge lid 20.

FIG. 44 depicts the see-through version of FIG. 43. Notice the hollow “shower head wall” grooves 59 visible as concentric circles on the left and right walls.

FIG. 45 depicts FIG. 43, except with the hinge lid 20 in the open position and the compartment 12 empty. Notice the kitchen item retainer 24 structure on wheels which rolls out onto the lid, and outside the compartment 12 as the lid is opened. Notice the tiny circles visible on the far inside wall of the compartment. These are the cone shaped spray holes 30. FIG. 46 shows the interior structure of the wall behind the spray holes 30.

FIG. 46 depicts the see-through version of FIG. 45.

FIG. 47 depicts FIG. 45, except filled with a bowl.

FIG. 48 depicts the see-through version of FIG. 47.

FIG. 49 depicts a right side see-through view of the bowl compartment of FIG. 43. The compartment 12 is empty and closed.

FIG. 50 depicts the compartment of FIG. 49, except the compartment lid 20 is open.

FIG. 51 depicts a right side view of the bowl compartment of FIG. 43, with an open lid 20 and a bowl 23 in the kitchen item retainer 24 cart. Notice the advantage of a rotating bottom hinge lid design 20 over a drawer design 19, is that the access area is larger since both the front side and top side are unblocked. Drawers can only be accessed from the top side, not the front side. This is why drawers are more suited for waist level and below (e.g. below countertop), and cabinets are more suited for higher levels (e.g. above countertop).

FIG. 52 depicts the see-through version of FIG. 51. Note that the fluid direction control device 48 (e.g. solenoid valve) is in the interface housing 45 connecting the fluid line stem connectors 58 with the interface buttons and knobs 41, 42, 43.

FIG. 53 depicts the multi-view orthographic projection of a plate compartment 12 with a “single compartment drawer” access point 19. Notice the “U”-shaped handle 26 on the front door of the compartment and the interface 45 similar to the interface in FIG. 33.

FIG. 54 depicts the see-through version of FIG. 53.

FIG. 55 depicts FIG. 53, except with the drawer 53 in the open state and empty. Notice the slope of the drawer 11 in the side views, for fluids to be directed into the compartment drainage opening 15.

FIG. 56 depicts the see-through version of FIG. 55. Notice the grooves in the walls 59 for fluids to travel.

FIG. 57 depicts FIG. 55, except there is a plate 23 loaded and sitting in the open drawer's kitchen item retainer 24.

FIG. 58 depicts the see-through version of FIG. 57.

FIG. 59 depicts a frontal view of a set of compartments 12 oriented in a “horizontal line” layout 50. The hinge lid 20 is missing from this drawing to showcase the dishes inside the compartments.

FIG. 60 depicts the see-through version of FIG. 59.

FIG. 61 depicts the isometric view of FIG. 59.

FIG. 62 depicts the right side view of FIG. 59.

FIG. 63 depicts the overhead view of FIG. 59.

FIG. 64 depicts the see-through version of FIG. 63.

FIG. 65 depicts a close up of the countertop embodiment of FIG. 59, excluding the traditional countertop 62 and sink 63. The hinge lids 20 are visible and in the closed position in this figure.

FIG. 66 depicts a see-through version of FIG. 65, with all the compartments empty.

FIG. 67 depicts a see-through version of FIG. 65, with all the compartments 12 filled with dishes 23.

FIG. 68 depicts the isometric view of FIG. 65.

FIG. 69 depicts the left side view of FIG. 65. Notice how in this design, the fluid lines and valves 48 forking off the delivering fluid line 16 can be positioned at different angles. Also notice the drainage assistance valve (left bottommost valve) 48, which flushes out any lodged debris down the drainage conduit 18.

FIG. 70 depicts an overhead see-through view of FIG. 65, with empty compartments 12. The drainage assistance valve 48 is the leftmost valve in the drawing. The dotted outlines of the kitchen item retainers 24 can also be seen in this drawing.

FIG. 71 depicts FIG. 70, except with filled compartments.

FIG. 72 depicts the back view of FIG. 65.

FIG. 73 depicts a shared compartment 14 designed to house multiple smaller items such as utensils or straws 23. The compartment's shared hinge lid access point 21 (side hinge door) is open, and the compartments are empty. Two fluid line stem connectors 58 are visible, one connected to each double-sided wall on the left and right side. The fluid line stem connectors connect to a T connector which then connects to a valve 48 and then the delivering fluid line 16. This shared compartment 14 is a unique variation to all other compartments, since it contains more than one item. All items in the compartment are sprayed at the same time. Admittedly, this design does bring back the very type of bottleneck this invention is trying to avoid. For example if all the forks are currently being washed, users will need to wait for the mini wash cycle to complete before being able to open the lid and grab a fork. Users will likely also wait to complete a wash cycle until all or most of the forks inside are dirty. Clean forks may also be washed several times again. However, this variation is still contemplated to reduce the number of separate compartments, valves and connectors required for small items. This added simplicity may be worth the pain point of a small bottleneck. Of course it's also possible for each small item (e.g. fork, butter knife, straw) to have its own compartment 12, such as the straw compartment shown in FIG. 59.

FIG. 74 depicts FIG. 73, except that the shared items compartment 14 is filled with utensils 23.

FIG. 75 depicts a right side see-through view of the FIG. 73 with empty compartments. Notice each compartment 14 has two cone shaped nozzle holes 30, which are all connected to one shared groove pathway 59 in the “shower head wall”. Typically two or more compartments cannot be connected to the same valve, but this variation makes that exception for reasons explained in FIG. 73. The sloped floor 11 of the compartment and the compartment drainage opening 15 are also shown in this drawing.

FIG. 76 depicts FIG. 75, except the shared items compartment 14 is filled with spoons 23. This helps to visualize where the cone spray nozzles 30 could make contact on a utensil 23.

FIG. 77 depicts an isolated close up view of the large utensil compartments 12 shown in FIG. 59. The lids are missing in this drawing to showcase the dishes 23 and other internal elements. This drawing helps to illustrate that a large variety of kitchen items-beyond just the basic cups, bowls, plates, and regular utensils-can have their own compartments as well.

FIG. 78 depicts the see-through version of FIG. 77. Dotted outlines of the cross-shaped “shower head wall” grooves 59 are visible as well as the fluid line stem connectors 58 connecting to each cross. Five cone-shaped nozzles 30 are cut into the bottom interior wall of each compartment-one on each of the four corners of the cross and one in the center. The compartments' kitchen item retainers 24 consist of the squiggly wires at the base of each utensil, and the horizontal dowels passing through the compartments above.

FIG. 79 depicts an isolated close up view of the compartment 12 housing a whisk 23 in FIG. 77. The side hinge lid 20 and whisk are visible, and the lid is in the open position.

FIG. 80 depicts the see-through version of FIG. 79 with the lid 20 in the closed position.

FIG. 81 depicts the isometric view of FIG. 79.

FIG. 82 depicts the right side see-through view of FIG. 80.

FIG. 83 depicts the frontal view of a single cup compartment 12 of FIG. 59, with an open lid 20 and a cup inside. Notice the single vertical fluid line stem connector 58.

FIG. 84 depicts the see-through version of FIG. 83.

FIG. 85 depicts the frontal view of a single bowl compartment 12 of FIG. 59, with an open lid 20 and a bowl 23 inside. Notice the double horizontal fluid line stem connectors 58.

FIG. 86 depicts the see-through version of FIG. 85.

FIG. 87 depicts the isometric view of FIG. 85, with a closed lid 20.

FIG. 88 depicts the see-through version of FIG. 87.

FIG. 89 depicts the right side view of FIG. 88.

FIG. 90 depicts the frontal view of a single plate compartment 12 of FIG. 59, with an open lid 20 and a plate 23 inside. Notice the tall thin shape of the compartment and double horizontal fluid line stem connectors 58.

FIG. 91 depicts the see-through version of FIG. 90.

FIG. 92 depicts the isometric view of FIG. 91 with a closed lid 20.

FIG. 93 depicts the right side view of FIG. 92.

FIG. 94 depicts the isometric view of an in-sink design laid out in a horizontal grid formation 51 with a shared hinge lid access point 21. The lid is open and the shared items compartment 14 is filled with kitchen items 23.

FIG. 95 depicts the same kitchen storage system 10 from FIG. 94, without the traditional countertop 62 or sink 63 included in the drawing. Notice the compartments 14 in this embodiment are not removable or modular. Rather each compartment is permanently attached to the others around it, sharing walls.

FIG. 96 depicts the isolated shared items compartment 14 of FIG. 95, with no dishes 23, fluid delivery lines 16, or spinning sprayers 57. The kitchen item retainers 24 are visible along with the drainage conduits 18 running through the bottom center of each row. Notice these compartments are not removable, they are fixed and attached to one another, sharing walls.

FIG. 97 depicts a right side see-through view of FIG. 95. The slope 11 of each drain conduit 18 and some of the spinning spray arms 57 can be seen with the dotted lines. The fluid velocity altering device 38 and temperature altering device 40 are also visible.

FIG. 98 depicts an overhead see-through view of FIG. 95.

FIG. 99 depicts the internal components of FIG. 95 without the shared items compartment 14. This includes the delivering fluid line 16, solenoid valves 48, spinning sprayers 57, fluid velocity altering device 38, fluid temperature altering device 40, soap tank 37, soap injector 39, and central processing unit 36.

FIG. 100 depicts FIG. 99 except with kitchen items 23 in place to visualize how the spinning sprayers 57 are positioned either beside or underneath each dish 23. Notice the angled nozzles 30 on the spinning sprayers 57.

FIG. 101 depicts the see-through version of FIG. 100.

FIG. 102 depicts a frontal view of a vertical plane drawer layout 52 kitchen storage system 10, which consists of a grid of sliding drawers 53, each functioning as a separate drawer access point 19.

FIG. 103 depicts the isometric view of FIG. 102.

FIG. 104 depicts FIG. 103, except with five sliding drawers 53 open. The open sliding drawers house utensils, mugs, bowls, plates, and a pot 23.

FIG. 105 depicts a right side view of FIG. 104. Notice the slope 11 of the drainage conduit 18 at the base of each sliding drawer 53.

FIG. 106 depicts the see-through view of FIG. 105.

FIG. 107 depicts the same kitchen storage system 10 in FIG. 102, without the traditional countertop 62 visible.

FIG. 108 depicts the isometric view of FIG. 107.

FIG. 109 depicts FIG. 104, except without the traditional countertop 62 visible.

FIG. 110 depicts a side see-through view of FIG. 108.

FIG. 111 depicts a side view of FIG. 109.

FIG. 112 depicts the see-through version of FIG. 111.

FIG. 113 depicts the shell of the kitchen storage system 10 of FIG. 108, with all but the bowl drawer 53 hidden from view. The bowl drawer access point 19 is open and the internal horizontal shelf 55 is visible. The horizontal shelf housing 55 contains one or more sliding drawer housings 54, which each contain a sliding drawer compartment 53. The sliding drawer compartment contains one or more partitions, each containing a kitchen item 23 (in this case a bowl). Fluid delivery lines 16 and valves 48 can also be seen, as well as nozzle holes 30 connected to the internal wall grooves 59.

FIG. 114 depicts the shell of the embodiment of FIG. 108, with just one internal horizontal shelf 55 visible. In this drawing a matrix of valves 48, delivering fluid lines 16, and drainage conduits 18 are visible, which run under, behind and around the drawers. In the bottom right corner or the drawing the central control units are visible, including the fluid velocity altering device 38, fluid temperature altering device 40, soap tank 37, soap injector 39, and central processing unit 36.

FIG. 115 depicts an isolated close up of the utensil drawers of FIG. 108, both in the open position. The smaller sliding drawer 53 on the left houses regular utensils 23 (forks, spoons, knives), and the larger sliding drawer 53 on the right houses larger kitchen utensils 23 (spatula, whisk, tongs, salad fork, salad spoon, cutting knife, metal spatula).

FIG. 116 depicts the see-through version of FIG. 115.

FIG. 117 depicts the see-through version of FIG. 115, except with the drawer closed.

FIG. 118 depicts the overhead view FIG. 115.

FIG. 119 depicts the see-through version of FIG. 118.

FIG. 120 depicts FIG. 119, except with the drawer closed.

FIG. 121 depicts the right side view of FIG. 115.

FIG. 122 depicts an isolated close up of the cup drawers of FIG. 108, all three sliding drawers 53 are in the open position. Note that despite being a subset of FIG. 108, this drawer unit on its own could be considered a kitchen storage system 10 oriented in a vertical plane drawer layout 52.

FIG. 123 depicts the see-through version of FIG. 122.

FIG. 124 depicts the overhead view of FIG. 122.

FIG. 125 depicts the see-through version of FIG. 124.

FIG. 126 depicts FIG. 125 with the drawer closed.

FIG. 127 depicts a left side see-through view of FIG. 122.

FIG. 128 depicts an isolated close up of the mug drawer 53 and water bottle drawer 53 of FIG. 108. Both drawers are in the open position.

FIG. 129 depicts the see-through version of FIG. 128.

FIG. 130 depicts the overhead view of FIG. 128.

FIG. 131 depicts the see-through version of FIG. 130.

FIG. 132 depicts FIG. 131 with the drawer closed.

FIG. 133 depicts a right side view of FIG. 128.

FIG. 134 depicts an isolated close up of the bowl and tupperware drawers of FIG. 108. All sliding drawers 53 are in the closed position.

FIG. 135 depicts FIG. 134, except with all bowl and tupperware drawers 53 in the open position.

FIG. 136 depicts the overhead view of FIG. 135.

FIG. 137 depicts the see-through version of FIG. 136.

FIG. 138 depicts the right side see-through view of FIG. 134.

FIG. 139 depicts the right side see-through view of FIG. 135.

FIG. 140 depicts a frontal view of the plate, pot, and pan drawers of FIG. 108. These are the bottommost and largest drawers in that embodiment. All drawers are in the closed position.

FIG. 141 depicts the see-through version of FIG. 140, filled with dishes.

FIG. 142 depicts the isometric view of FIG. 140 with all drawers open.

FIG. 143 depicts the overhead view of FIG. 142.

FIG. 144 depicts the see-through version of FIG. 143. In the top right corner of the drawing there is extra space for the control units 36, 37, 38, 39, 40. In this embodiment, the pot and pan are just single drawers in order to make room for this control unit behind them.

FIG. 145 depicts the right side view of FIG. 142.

FIG. 146 depicts the see-through version of FIG. 145.

FIG. 147 depicts the right side see-through view of FIG. 140, filled with dishes 23.

FIG. 148 depicts an exploded view of the various components that make up a shared drawer system for cups. These include the sliding drawer 53, the drawer housing 54, the fluid delivery lines 16, and solenoid valves 48. The solenoid valves and input fluid lines are housed inside the drawer housing on the bottom, underneath the drawer housing drainage slope 11.

FIG. 149 depicts the see-through version of FIG. 148.

FIG. 150 depicts an exploded view of the various components that make up a shared drawer system for bowls. The bowls are sitting inside the sliding drawer 53.

FIG. 151 depicts the see-through version of FIG. 150.

FIG. 152 depicts an exploded view of the various components that make up a shared drawer system for plates 23.

FIG. 153 depicts the see-through version of FIG. 152.

FIG. 154 depicts the frontal see-through view of an empty cup compartment 12. The “shower head wall” grooves 59 in the top and bottom walls as well as the right side wall can be seen, along with the cone shaped nozzle holes 30. The fluid line stem connector 58 is also visible.

FIG. 155 depicts an isometric view of FIG. 154. In this view the path for the fluids to travel from the bottom wall through the grooves 59 up the side wall to the top wall can be clearly seen.

FIG. 156 depicts the frontal see-through view of an empty bowl compartment 12. The “shower head wall” grooves 59 in the left and right walls are visible, along with several cone shaped nozzle holes 30. Two fluid line stem connectors 58 are also visible.

FIG. 157 depicts the isometric view of FIG. 156.

FIG. 158 depicts the side view of a single “shower head wall” piece. The fluid line stem connector 58, grooves 59, and cone shaped nozzles 30 are all visible.

FIG. 159 depicts an exploded view of the example wall in FIG. 158.

FIG. 160 depicts the see-through version of FIG. 159.

FIG. 161 depicts the multi-view orthographic projection of FIG. 158 (not see-through).

FIG. 162 depicts the see-through version of FIG. 161.

FIG. 163 depicts one embodiment of the “spinning dish” cleaning method. In this embodiment the kitchen item 23 (in this case a bowl) is placed upside down on a rotating kitchen item retainer 24, which sits on top of a thrust bearing 60. Two static spray nozzles 30 (typically with a flat spray pattern) target both sides of the bowl 23 from the top and bottom at a slight angle, causing the bowl to spin.

FIG. 164 depicts another embodiment of the “spinning dish” cleaning method. In this design, the bowl 23 sits on top of wheel bearings 61, which allow the bowl to freely spin in place when sprayed by the static spray nozzles 30.

FIG. 165 depicts an isometric view of a compartment 12 with a rotating lid access point 22 in the closed position.

FIG. 166 depicts the compartment of FIG. 165, but with the “rotating lid” 22 partially open and a bowl 23 inside. Notice the kitchen item retainer 24 is connected to the rotating lid.

FIG. 167 depicts the compartment of FIG. 165, but with the “rotating lid” 22 in the open position.

FIG. 168 depicts a left side see-through view of FIG. 165. The lid is closed, meaning there is an opening between the compartment and the drainage conduit area.

FIG. 169 depicts FIG. 168, except with the lid 22 partially open. Notice the compartment 12 has partial access to the drainage opening area 15.

FIG. 170 depicts FIG. 168, except with the lid 22 fully open. Notice how the lid 22 conveniently blocks the compartment drainage opening 15 when the lid is in the open position.

FIG. 171 depicts a cylindrical compartment 12 with a rotating lid 22 in the closed position.

FIG. 172 depicts the see-through version of FIG. 171. Notice the drainage conduit opening 15 is unblocked.

FIG. 173 depicts the compartment of FIG. 171 with the rotating lid 22 in the open position. Notice the drainage opening 15 is conveniently blocked when the rotating lid 22 is open. The kitchen item retainers 24 are also visible along with a static spray nozzle 30.

FIG. 174 depicts the see-through version of FIG. 173.

FIG. 175 depicts a frontal view of a spinning nozzle sprayer 57, shaped like a disc.

FIG. 176 depicts the see-through version of FIG. 175.

FIG. 177 depicts the isometric view of FIG. 175.

FIG. 178 depicts the see-through version of FIG. 177.

FIG. 179 is a schematic illustrating a current task cycle performed within a kitchen. The current dishwashing cycle using a normal dishwasher. Notice the many bottlenecks and additional tasks that are needed for the user to complete compared to FIG. 180. Each location (cabinet, sink, and dishwasher) represents a separate bottleneck, where dishes accumulate over time, creating more future work for the user.

FIG. 180 is a schematic illustrating a current task cycle performed within a kitchen using the invention. An improved dishwashing cycle for doing the dishes and managing a kitchen. This flow is much simpler. Users can drop a dirty dish or pick up a clean dish whenever they desire with no additional bottlenecks in the system. Food or drinks can also be grabbed and dropped off in these compartments, and the compartments can be rinsed when they are full with food (ex: vegetables) or washed out when they are empty. To summarize, the sink is the first bottleneck where dishes tend to accumulate. Depending on user competence, dishes are moved from the sink into the dishwasher in intervals. This process must be repeated until the dishwasher is adequately full to be worth starting. This incentivizes users to use more dishes than they need, just to fill a big box (the dishwasher). Then users must wait, and return back to the task (which takes additional energy and inertia) of unloading the dishwasher back into the cabinets. Compare that system with the proposed system, where users simply drop a dirty dish into a stack or a compartment, and pick it up after a few minutes when the machine is finished. Note, not all dishes will always be used at once, so most of the time a compartment with a clean dish will be waiting and ready to go (meaning the user won't need to wait for the dish they just dropped to finish, they can just grab another one).

### DETAILED DESCRIPTION OF THE PREFERRED EMBODIMENTS

Referring now to the drawings, there is provided a kitchen storage system. Which is generally designated with the numeral 10. The kitchen storage system 10 includes one or more compartments responsible for storing kitchen item(s) 23. Three types of compartments are contemplated: fixed single item compartment 12, fixed shared items compartment 14, and sliding drawer compartment 53. Fixed shared items compartment 14 and sliding drawer compartment 53 can house more than one kitchen item 23 separated by partitions. Each individual storage space for a kitchen item 23 is called a kitchen item cubby 27. There can be no more than one kitchen item 23 per kitchen item cubby 27. Fixed single item compartment 12 contains only one cubby. Fixed shared items compartment 14 and sliding drawer compartment 53 can contain multiple kitchen item cubbies 27.

Every kitchen item cubby 27 includes a sloped floor 11, a drainage opening 15 leading into a drainage conduit 18, a designated fluid direction control device 48, an access point (19, 20, 21, or 22), a kitchen item retainer 24, and an associated fluid spraying mechanism (defined in section [0245]).

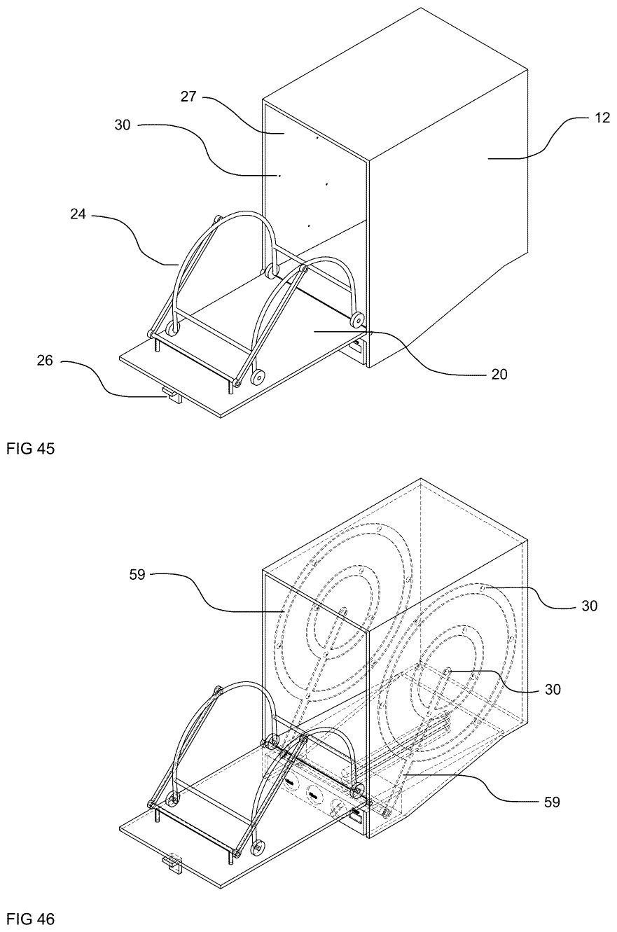

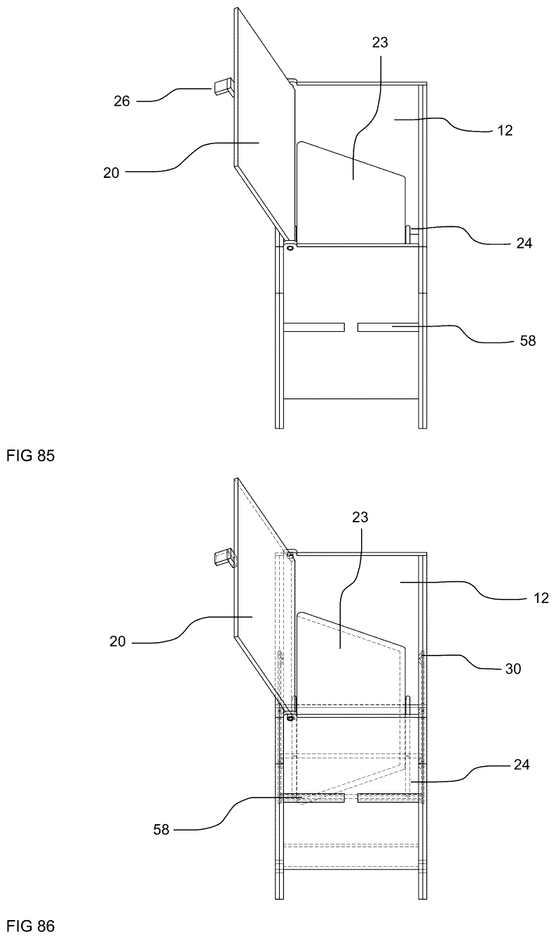

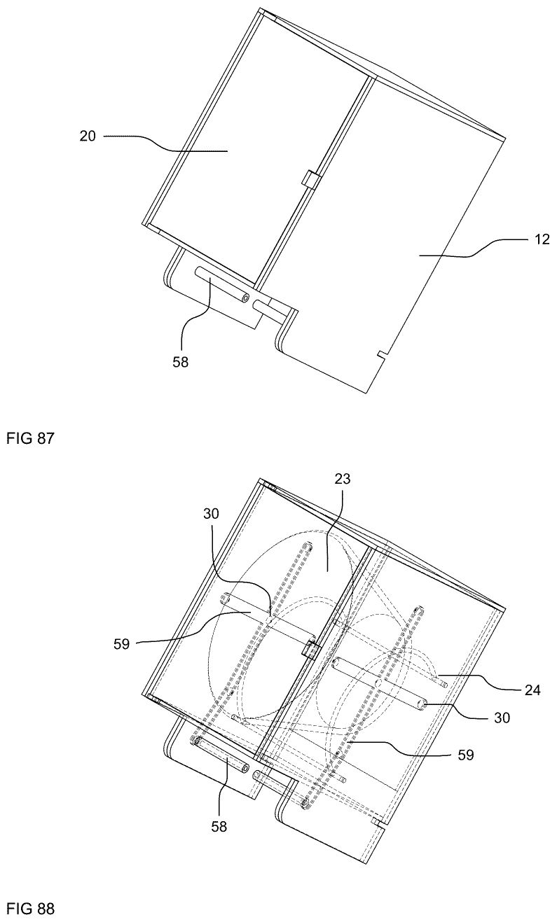

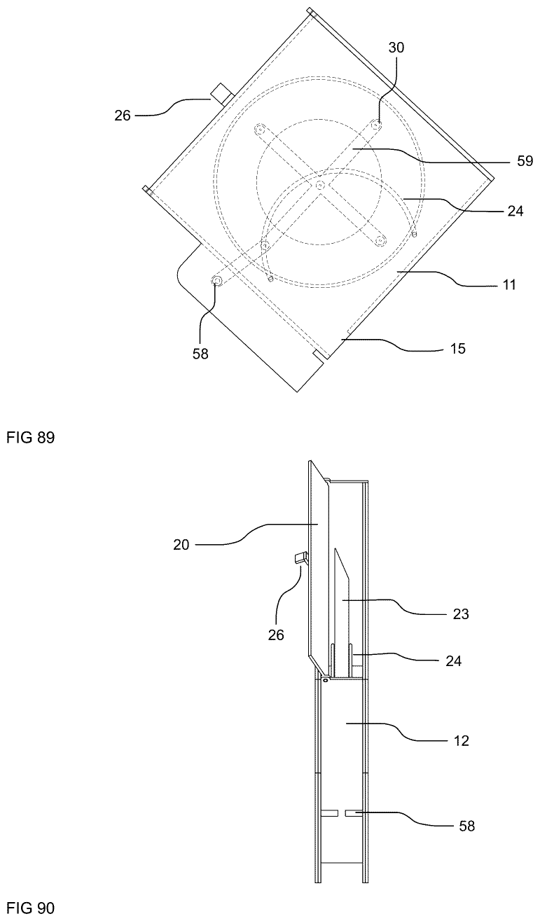

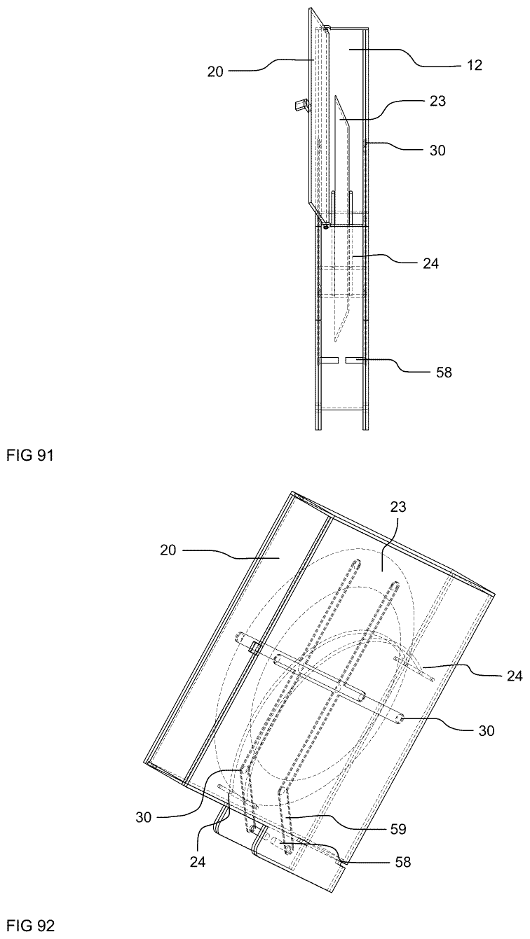

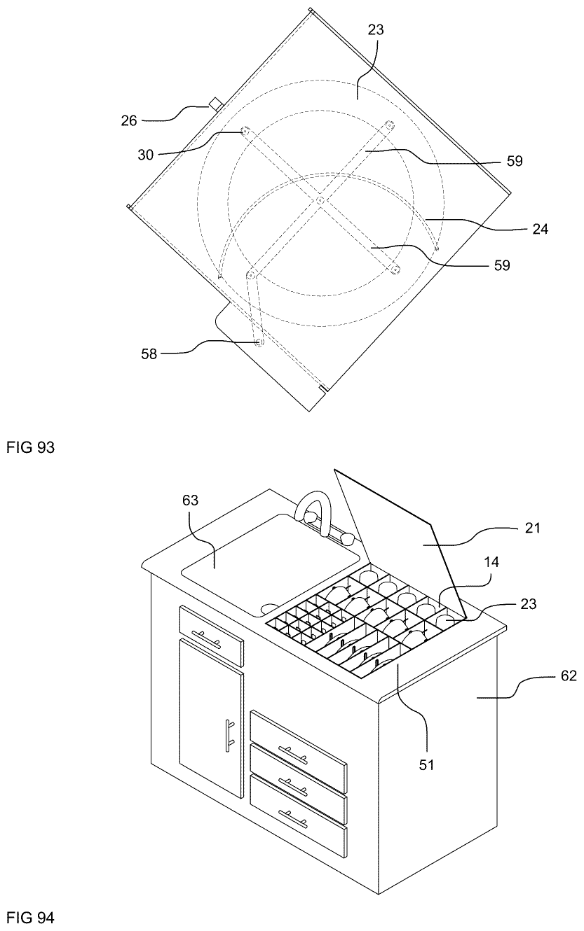

Three kitchen item cubby 27 layouts are contemplated: vertical plane cubby layout 49, horizontal line cubby layout 50, and horizontal grid cubby layout 51. “Horizontal” implies that the access point handle 26 is generally on top of the compartment (top access) as shown in FIG. 85, while “vertical” implies the access point handle 26 is generally on the side of the compartment (side access) as shown in FIG. 45. Sliding drawer compartment 53 orients cubbies in a horizontal line layout 50 (FIG. 128, 148). Two or more sliding drawer compartments 53 can be laid out in a vertical plane drawer layout 52, to create a 3D grid of cubbies (FIG. 104).

Two main configurations for the delivering fluid line 16 are contemplated. There can be a single shared delivering fluid line 16 used for all fluids (FIG. 68, 99), or a separate delivering fluid line 16 for each fluid type (FIG. 19, 20). The advantage of a single shared fluid line 16 is that it requires less materials, less space, and simpler valves 48. However, with a shared line 16, two separate cubbies 27 cannot receive different types of fluids at the same time, and it may take extra time to flush out an old fluid and replace it with a new fluid. Using a separate fluid line 16 for each fluid is faster, and allows for multiple kitchen item cubbies 27 to be sprayed by different fluids at the same time. However, this would require more complex valves 48 to connect multiple fluid lines to a single output targeting each cubby 27 (such as a 3 way 2 position valve or a selector valve).

Each kitchen item cubby 27 is associated with a spray mechanism, which targets the cubby 27 with fluid originating from the delivering fluid line 16. Five spray mechanisms are contemplated: static nozzle spray mechanism 65, internal grooves spray mechanism 59, spinning nozzle spray mechanism 57, spinning kitchen item spray mechanism 56, and moving nozzle spray mechanism 64. A combination of spray mechanisms can also be employed. For example, a moving spray nozzle 64 may stop to spin a bowl 23 sitting on thrust bearing 60 in a kitchen item cubby slot 27 of a fixed shared items compartment 14.

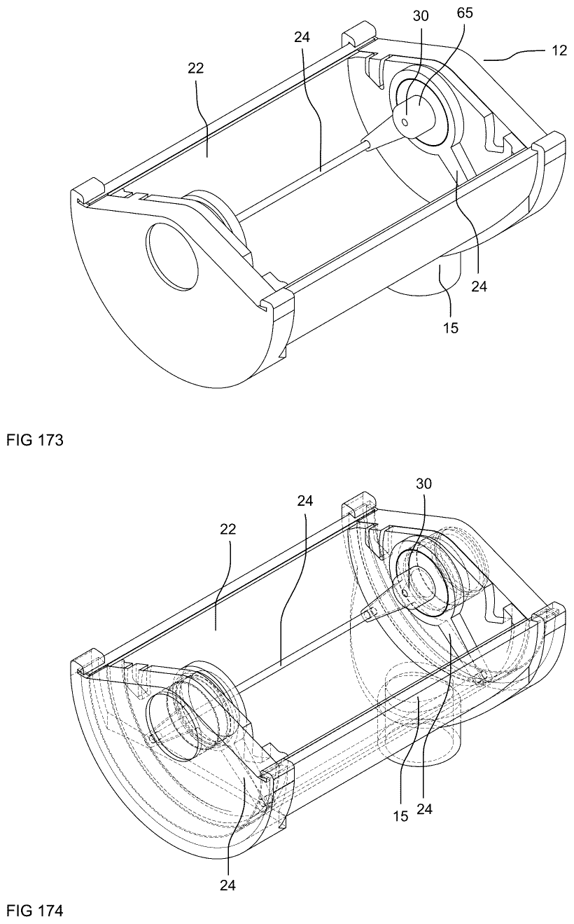

The static nozzle spray mechanism 65 simply employs one or more fixed nozzles pointed towards the kitchen item 23 inside the cubby 27 (FIG. 173). However this can take up space, and result in only partial coverage.

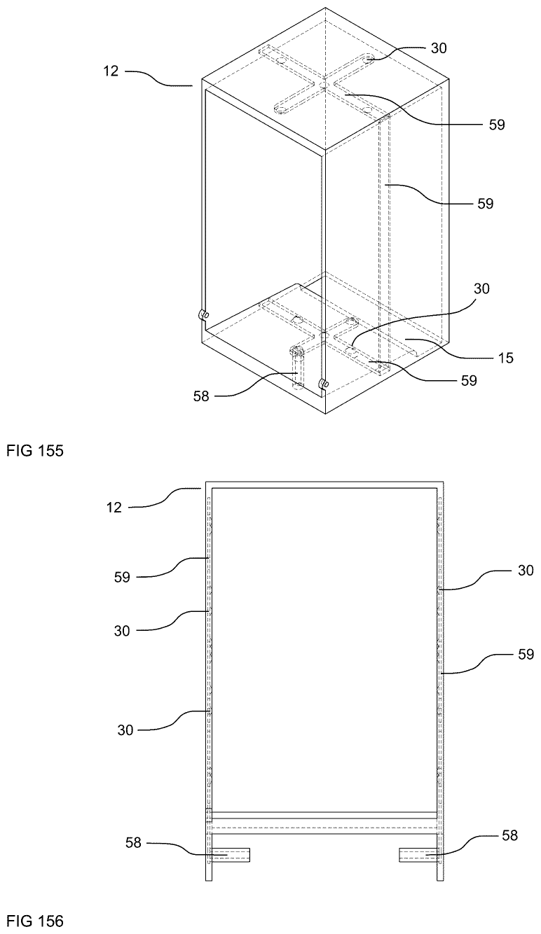

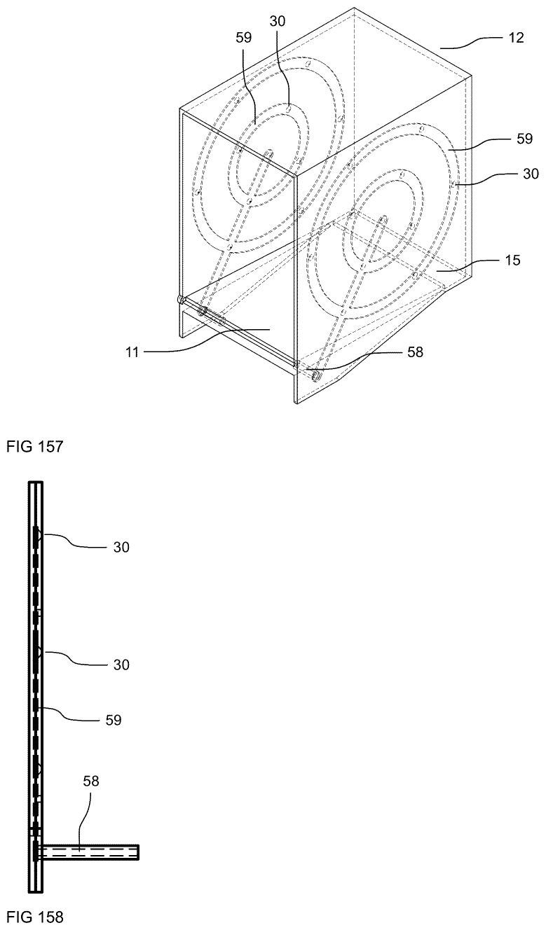

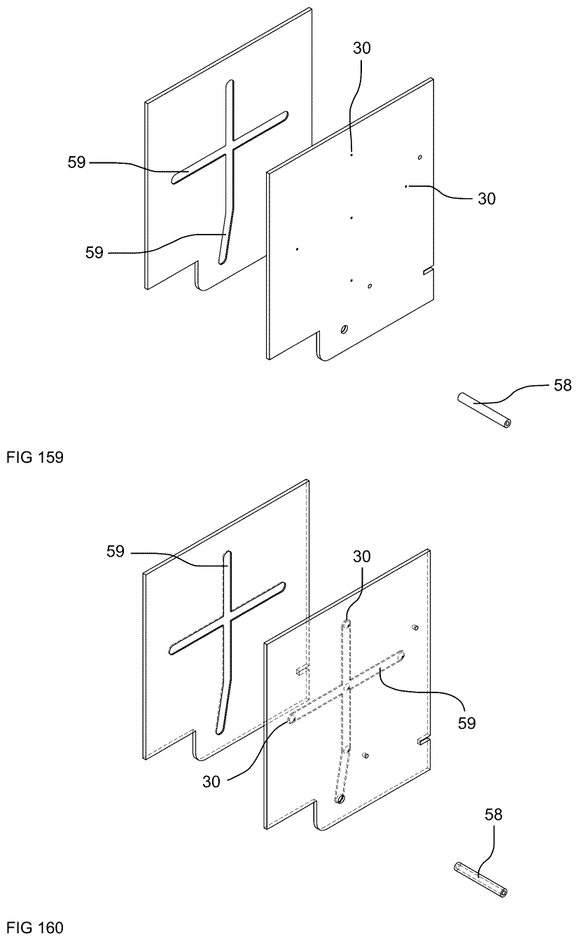

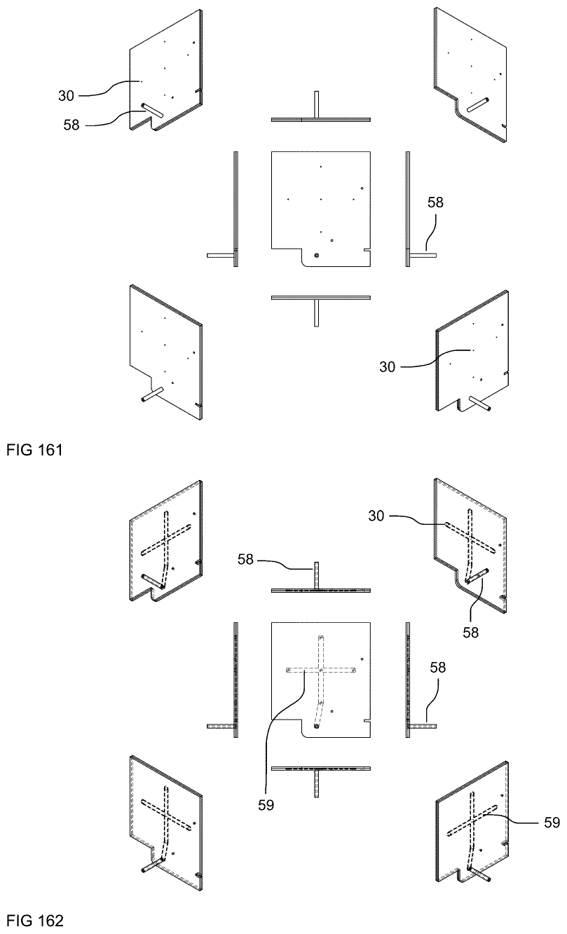

The internal grooves spray mechanism 59 (a.k.a. “shower head wall method”) employs one or more hollow walls in the cubby or compartment, which are either fully hollow or have grooves running through the inside of the wall for fluids to flow through. The side of the wall facing the kitchen item 23 (interior side) then has nozzle holes 30 over where the wall is hollow or the grooves are located, similar to a flat shower head. The holes 30 are typically cone shaped for wider coverage. The fluid delivery line 16 connects to the fluid direction control device 48, which connects to the fluid line stem connector, which connects to the hollow part of the wall (filling it with fluid), which then travels out the holes 30 and towards the kitchen item 23 (FIGS. 154-162). The advantage of this method is there are no moving parts, the walls can be thin taking up little space, and wide coverage can be maintained.

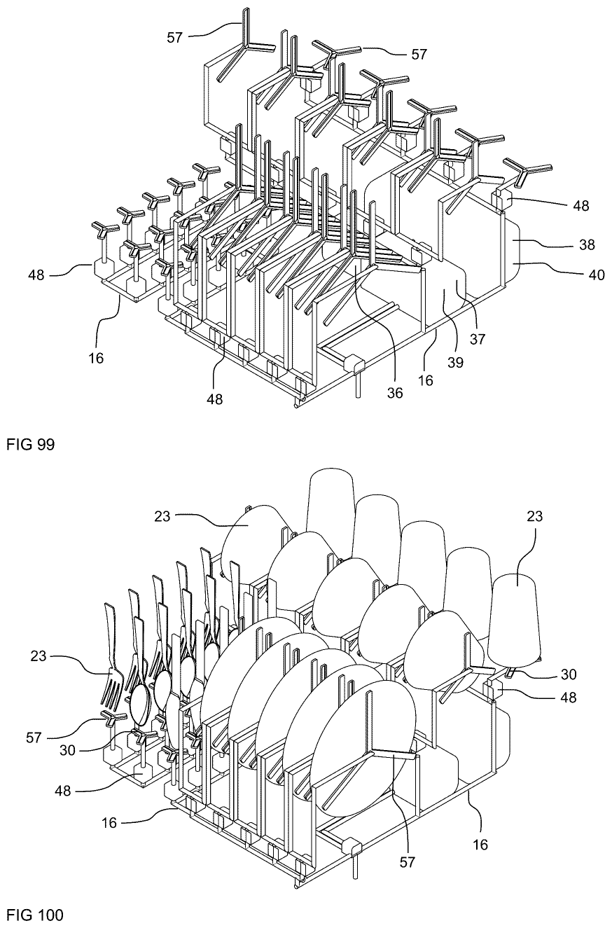

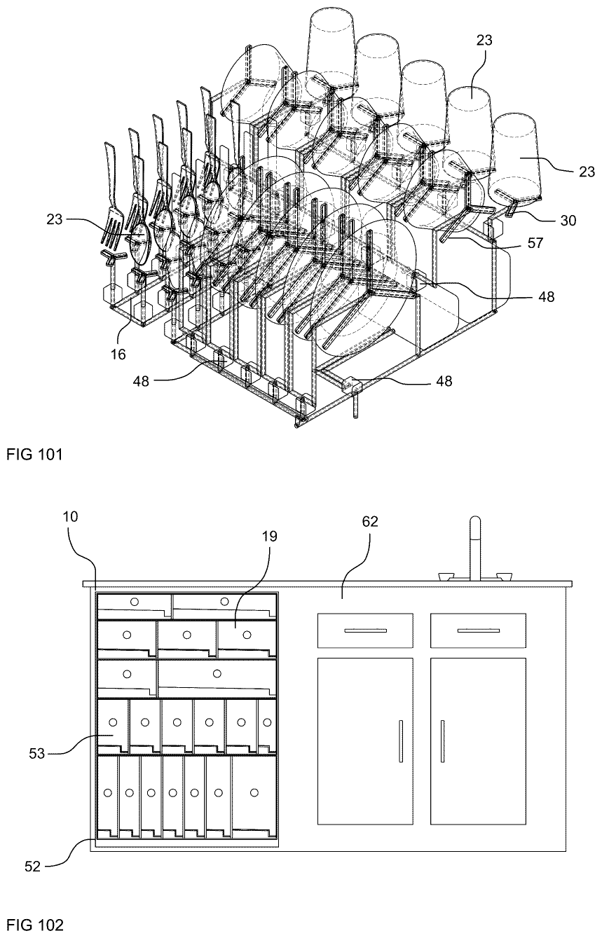

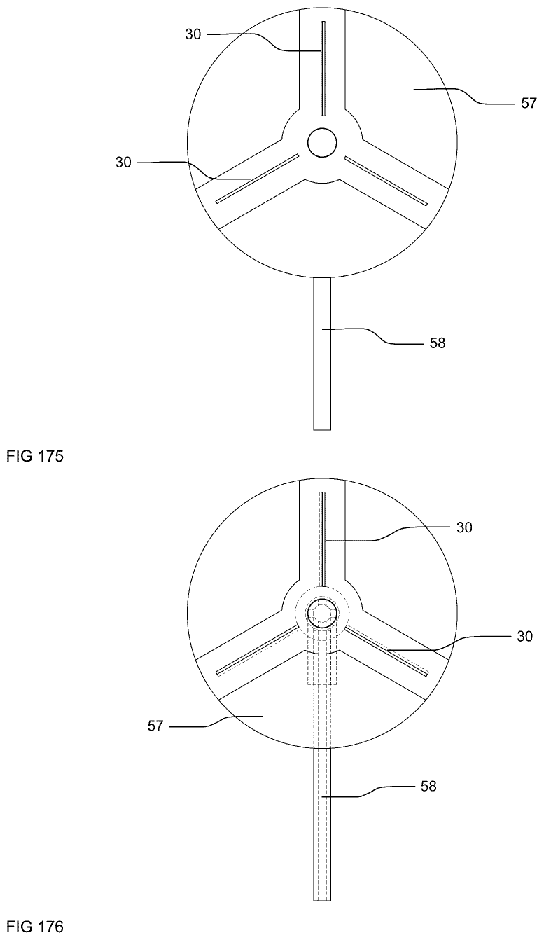

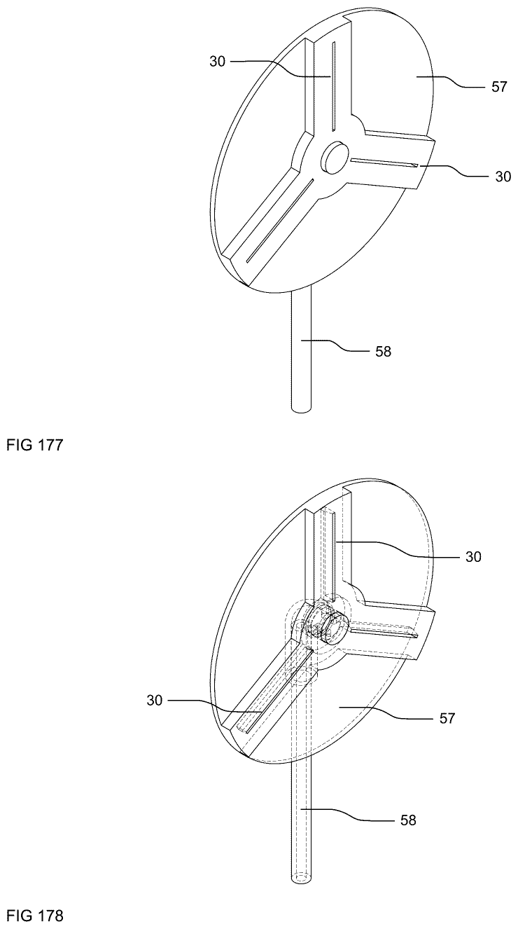

The spinning nozzle spray mechanism 57 utilizes fluid pressure to spin a spray arm (FIGS. 99, 175-178), flat disc (FIGS. 175-178), hemisphere-shaped nozzle, or other nozzle device directed towards the kitchen item 23. This is very similar to how regular dishwasher spray arms work, only on a smaller scale, and just targeting a single kitchen item 23. The advantage to this method is the compartment or cubby walls are simpler to make, however there are moving parts involved which could fail with time. Spinning motion is utilized to ensure 100% coverage of the kitchen item 23.

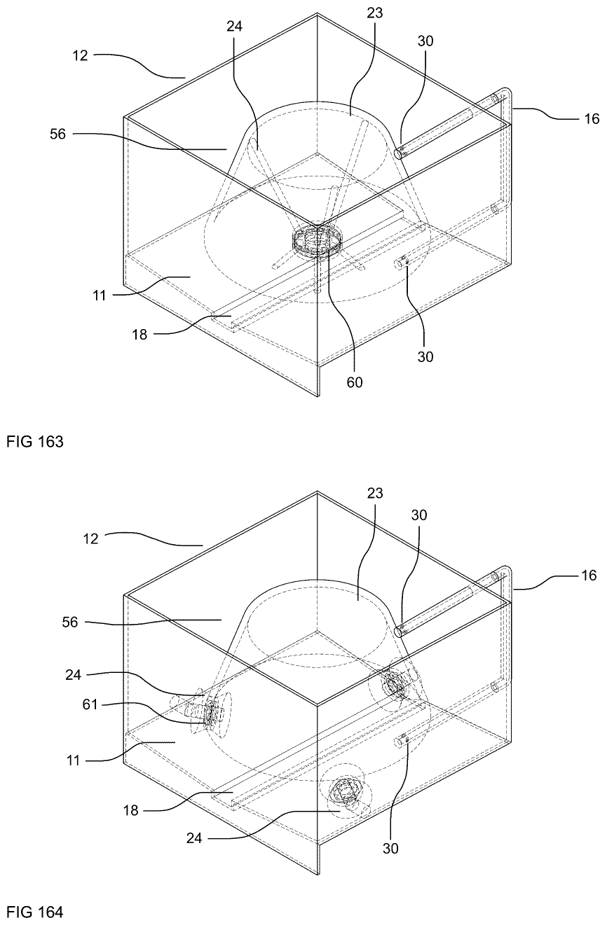

The spinning kitchen item spray mechanism 56 involves one or more fixed nozzles (typically flat spray nozzles) positioned towards the kitchen item 23, typically at a slight angle. The kitchen item 23 sits on top of one or more bearings, causing the kitchen item 23 to spin when fluid shoots out of the nozzles. Two types of spinning dish bearing designs are contemplated, the thrust bearing 60 design (FIG. 163) and the wheel bearing 61 design (FIG. 164). The advantage of this method is the nozzles can be in a fixed position (simpler design), while also ensuring 100% coverage of the dish as it spins. However bearings may wear and tear over time and dishes must be strictly standardized to fit on the bearing(s) mounts 24.

The moving nozzle spray mechanism 64 employs a spray head (usually holding one or more nozzles 30), which can be mounted on a rail, which can slide back and forth in either one or two axes/directions (i.e. it can move in a single line back and forth or in a grid like the X and Y axes of a 3D printer). The spray head's plane of movement can be either vertical or horizontal depending on how the kitchen storage system 10 is oriented (e.g. top access or side access). The mechanism which moves the spray head can be a timing belt, threaded rod, gear on a track, or other type of actuator.

A flexible waterline can be connected to the moving spray head, which can be managed as the spray head moves around, so that the line does not interfere with operations or become tangled. Another option is for the fluid to pass through the rail itself or a rigid tube in a future design, so that managing a separate delivering fluid line 16 is not needed. In this design, only a single moving electronically actuated valve 48 would be needed, instead of a separate valve 48 for each kitchen item cubby 27 which could be expensive. However, the additional moving parts involved to move the valve 48 around and manage fluid lines 16 may also be expensive and extra complex.

Each spray mechanism can be configured with one or more device 30, a nozzle for example, to control the direction or characteristics of fluid flow (specially to increase velocity) as it enters the kitchen item cubby 27.

Each kitchen item cubby 27 can preferably include a retainer 24 for retaining the received kitchen item 23 in a desired manner for a predetermined application, such as washing, rinsing, heating, or cooling. The retainer 24 can be disposed to suspend the kitchen item 23 and in this way better accommodate the desired action desired.

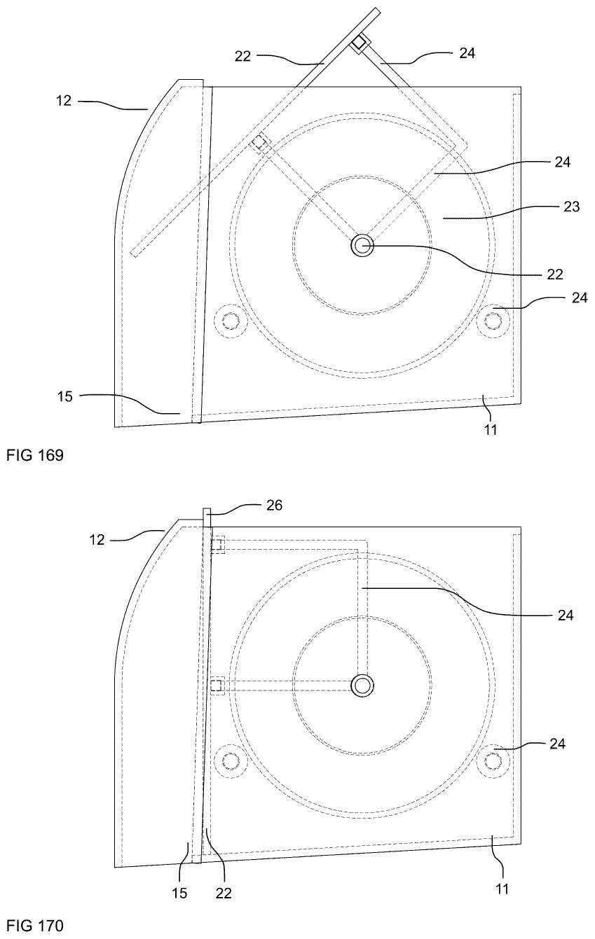

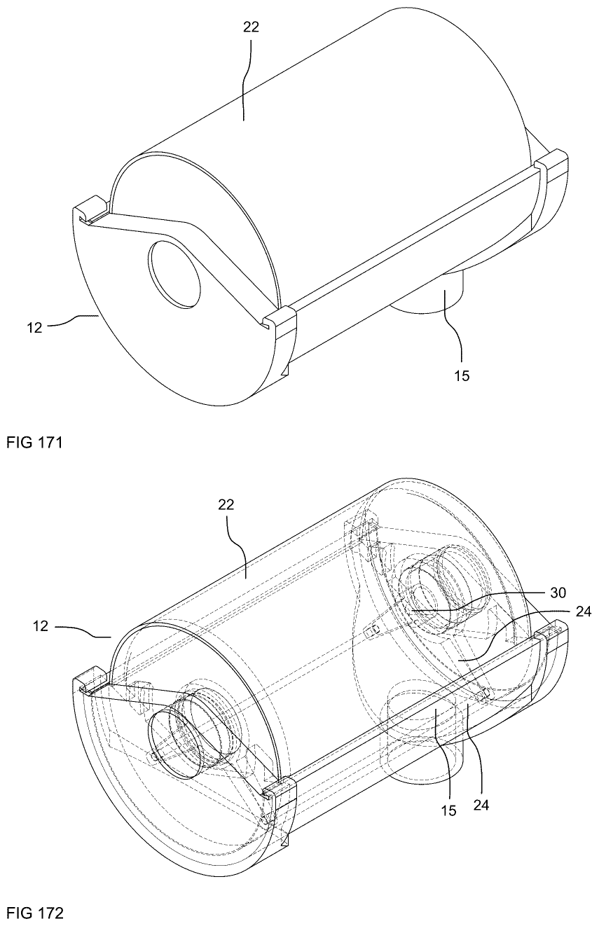

Each compartment or cubby 27 when connected to the backend, can preferably have a mechanism of blocking access to the drainage conduit 18 (although this may not be totally necessary for simpler designs). Both top access and side access designs can implement this drainage blocking mechanism. This way, steam and/or waste from other cubbies 27 which are in the process of being washed at the same time, cannot contaminate clean cubbies 27. Vents and airflow control with negative pressure can also solve this issue alone. A flap which opens and closes can be employed for controlling access between waste drain and each individual cubby 27. This flap can also be connected to the access point mechanism, so that the opening and closing of the access point opens up or closes off access to the drainage conduit area 18. Drainage blocking mechanisms can include the type seen in FIGS. 168-170, or the concentric tubes shown in FIGS. 171-174. In the mentioned examples, the lid itself blocks the drainage access opening, however, it can also be an intermediate mechanism connected to the lid or access point which controls the opening and closing of access to the drainage area.

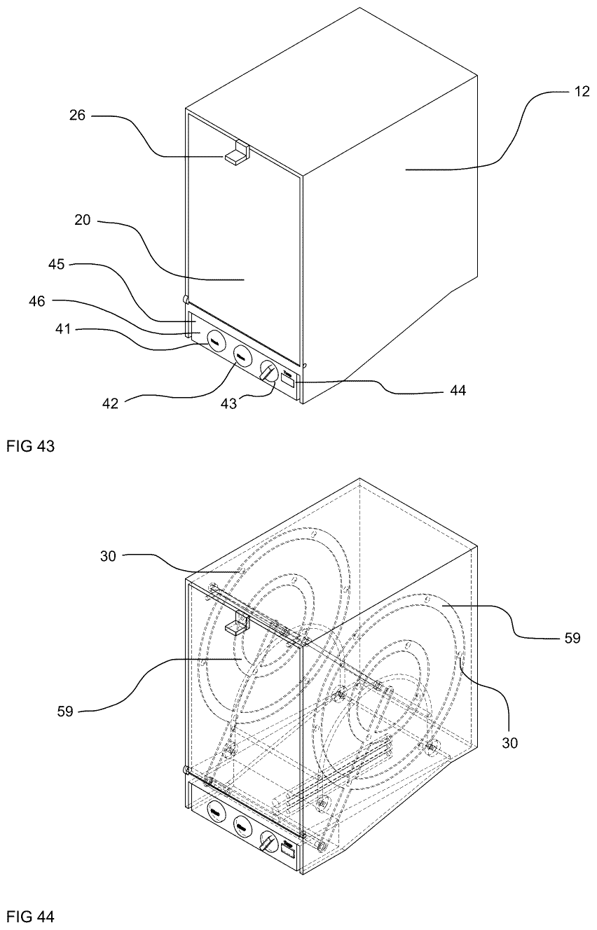

In another embodiment, the delivering fluid line conduit 16 can be operably connected to a fluid/air temperature altering device 40 for altering the temperature of the fluid and or air delivered to the kitchen item cubby 27. For example, such temperature control in action can include introduction of heat to heat plates before lunch, or adding an electric cooler such as a Peltier cooler, i.e., a thermoelectric cooling device being able to “chill” a few wine glasses before dinner by actuation of one or more electrically operated button or by turning a knob 43 on the desired compartment interface. Similarly, for cubbies 27 containing food, the temperature in each cubby 27 can be tailored to that food item in particular. For example, the optimal temperature to store vegetables may be different from the optimal temperature to store certain meats. It is contemplated that the cubby 27 could be introduced with sufficiently hot air to cook food items therein. Each cubby 27 can have its own dedicated interface to manage temperature control or other functions (preferred method for maximum customizability), or groups of compartments could also share interfaces. The temperature of each kitchen item cubby 27 can be controlled by air lines 16 or heating elements which can either be built into the backend or be a part of the cubby 27 itself (e.g. built into the kitchen item retainer 24). For example, the interface 45 in FIG. 43 displays a temperature control knob 43 for controlling temperature, which is displayed on screen 44.

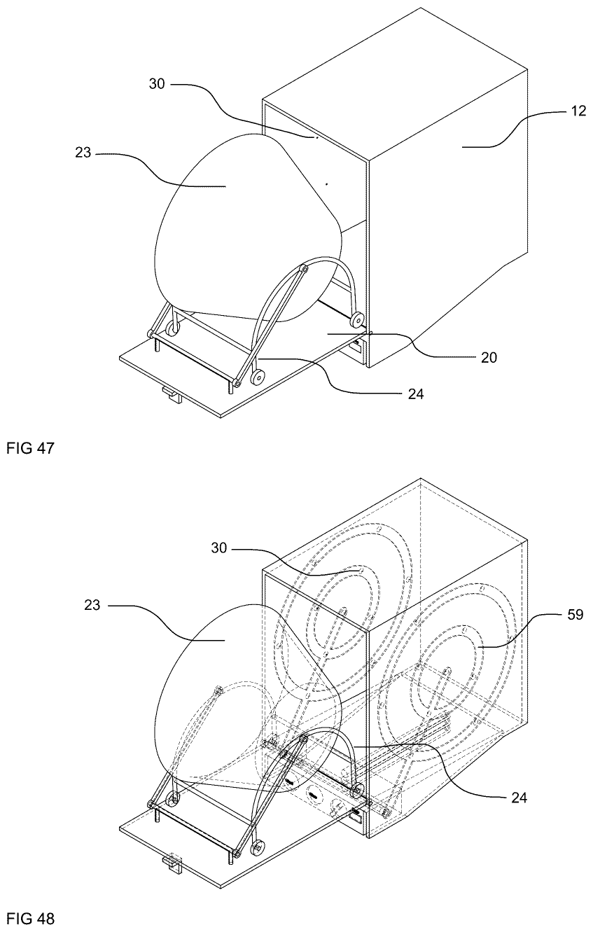

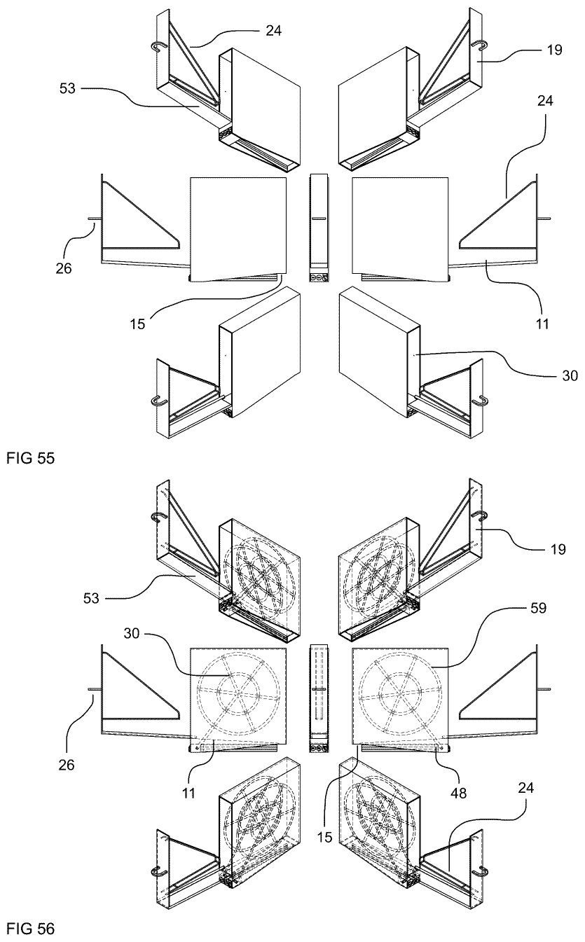

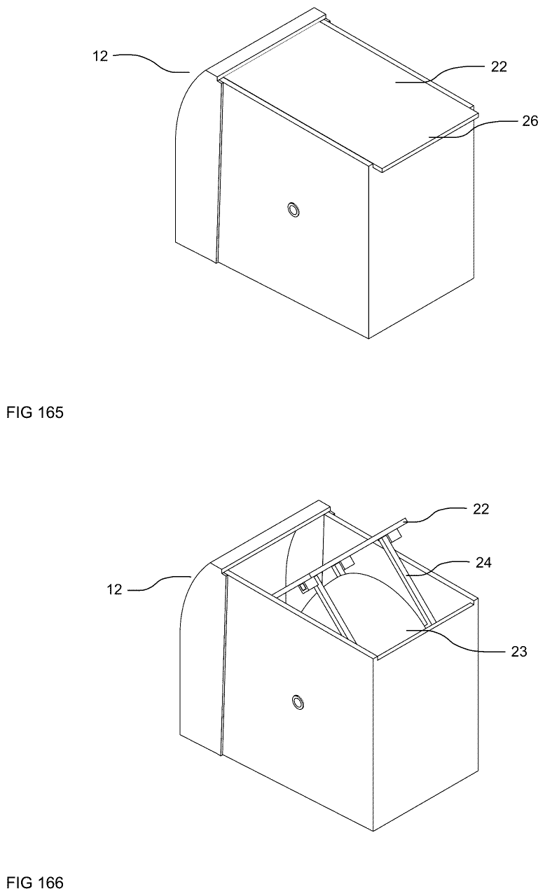

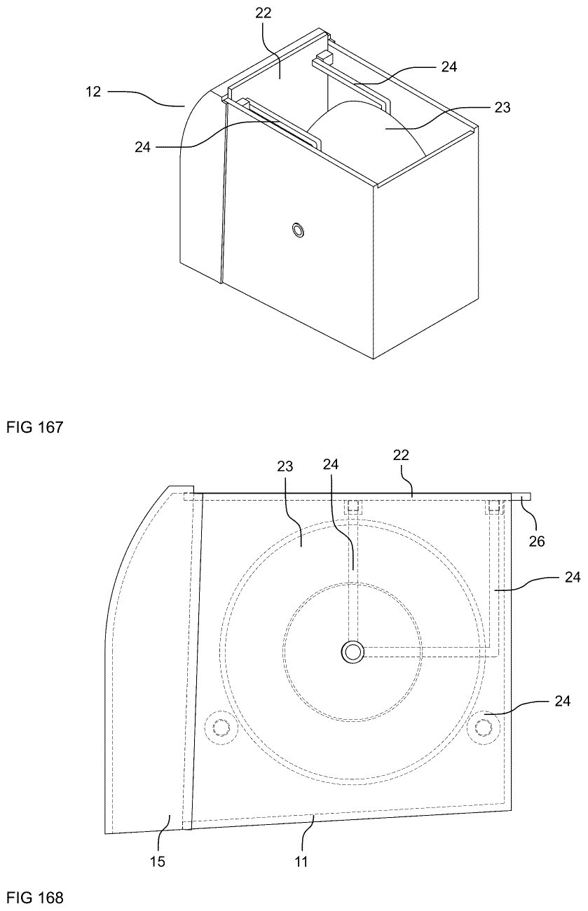

Every fixed single item compartment 12 contains one and only one kitchen item cubby 27 (FIG. 45). This makes the design more modular. In the drawings, compartment 12 is shown having three possible types of access points: drawer access point 19 (FIG. 55), single cubby hinge lid access point 20 (FIG. 47), and rotating lid access point 22 (FIGS. 165-174). The compartment 12 may also include an interface 45 (FIG. 43) and can be configured in a variety of geometric shapes, such as rectangular (FIG. 39) or cylindrical (FIG. 171) for example. In an embodiment, there can be multiple conduits 16, 18 where conduit 16 delivering fluid line can removably interconnect to a water line, such as a kitchen sink faucet (not shown), and the compartment 12 delivering water to the compartment 12 and another conduit 18, which can be a pipe or trough, removably connected to compartment 12 removing fluid and/or waste from the compartment 12 to a disposal area, such as a sink 63 or a drain (not shown).

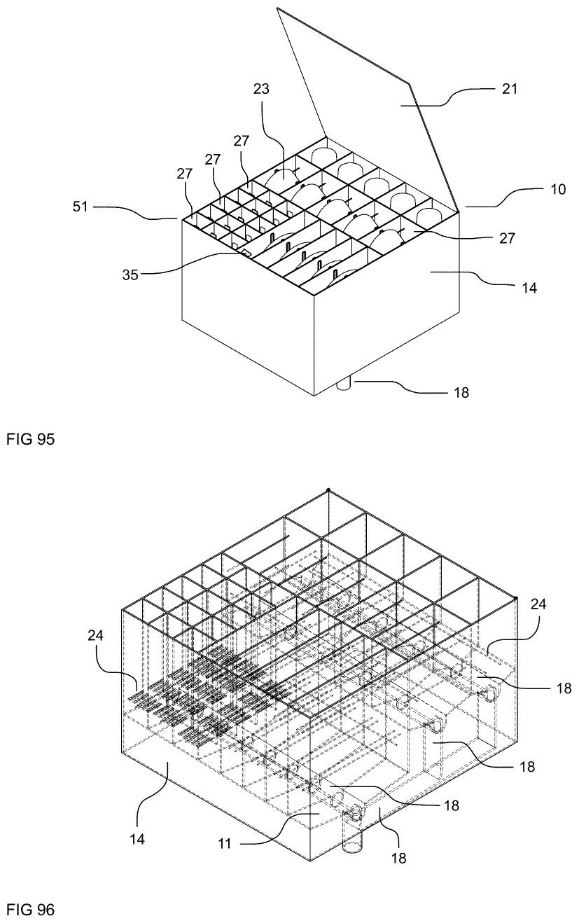

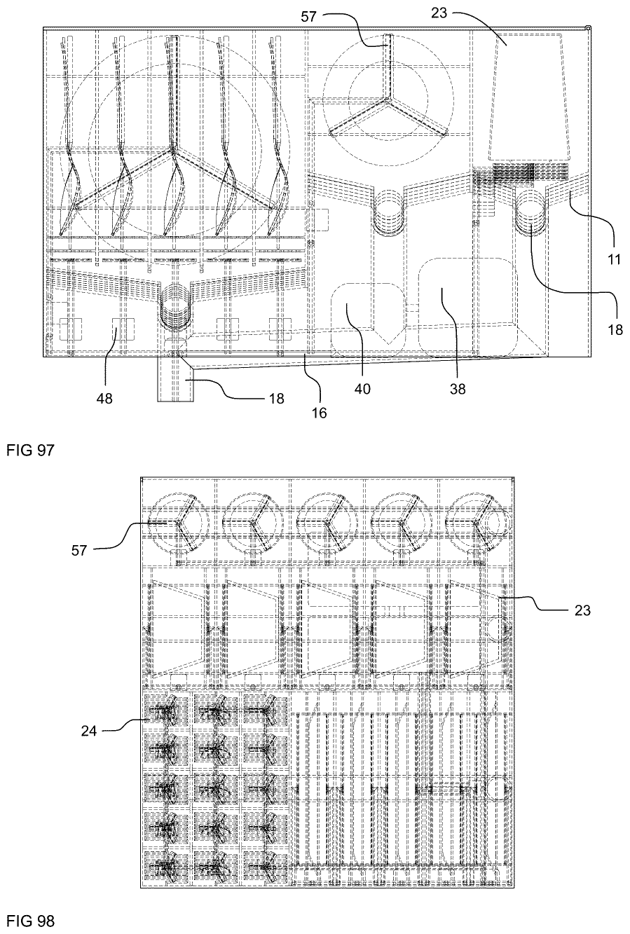

Every fixed shared items compartment 14 contains two or more kitchen item cubbies 27 (FIG. 95). A compartment 14 can lay out kitchen item cubbies 27 in either a 1D line or a 2D grid pattern. FIG. 95, for example, depicts a shared compartment 14 in a horizontal grid cubby layout 51. The shared compartment 14 is less modular than the single compartment 12, since multiple cubbies 27 are associated with a single immutable housing with shared walls between cubbies 27.

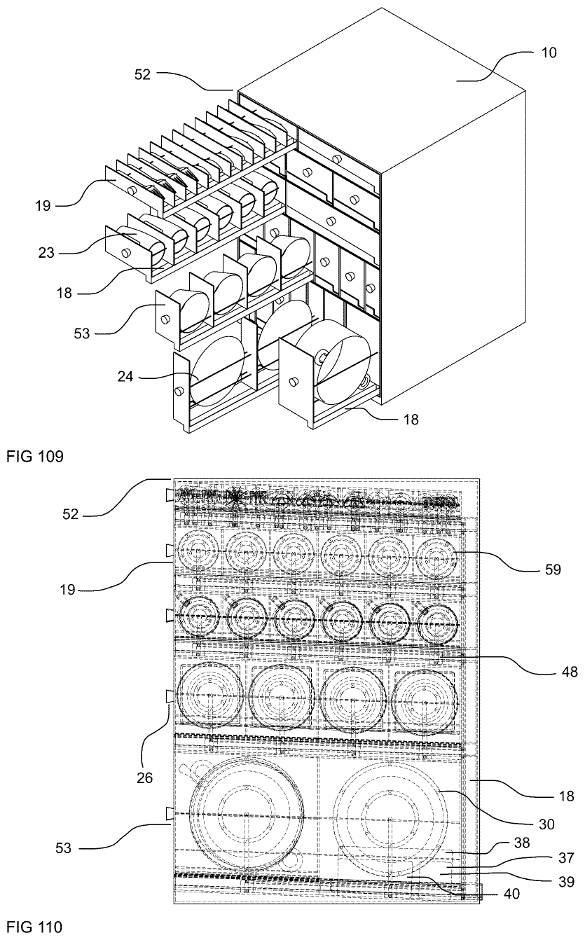

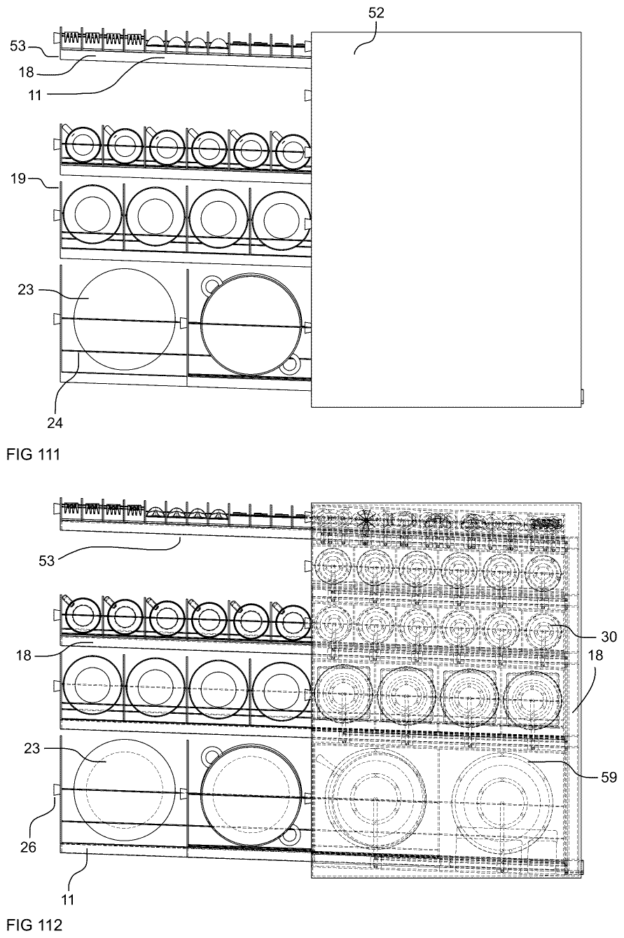

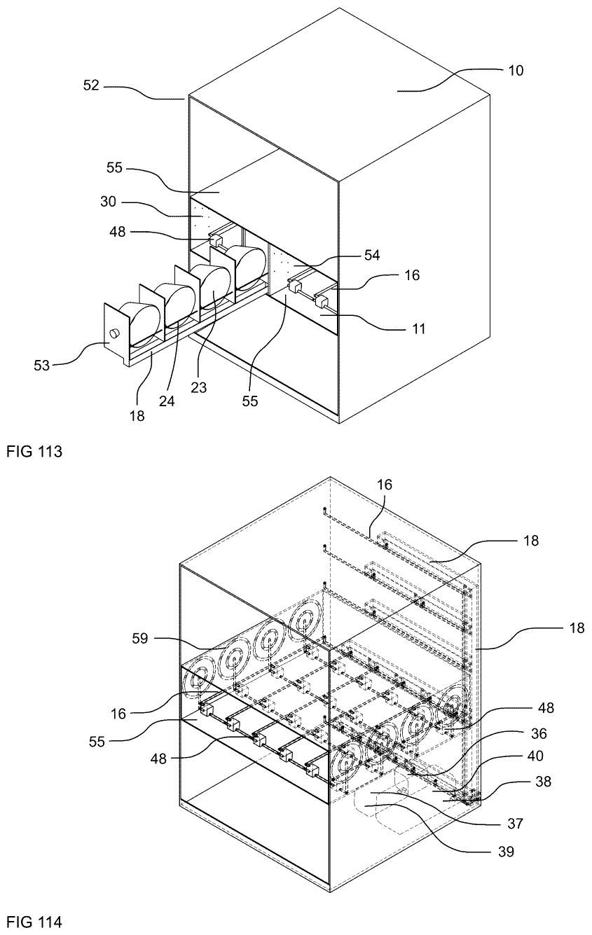

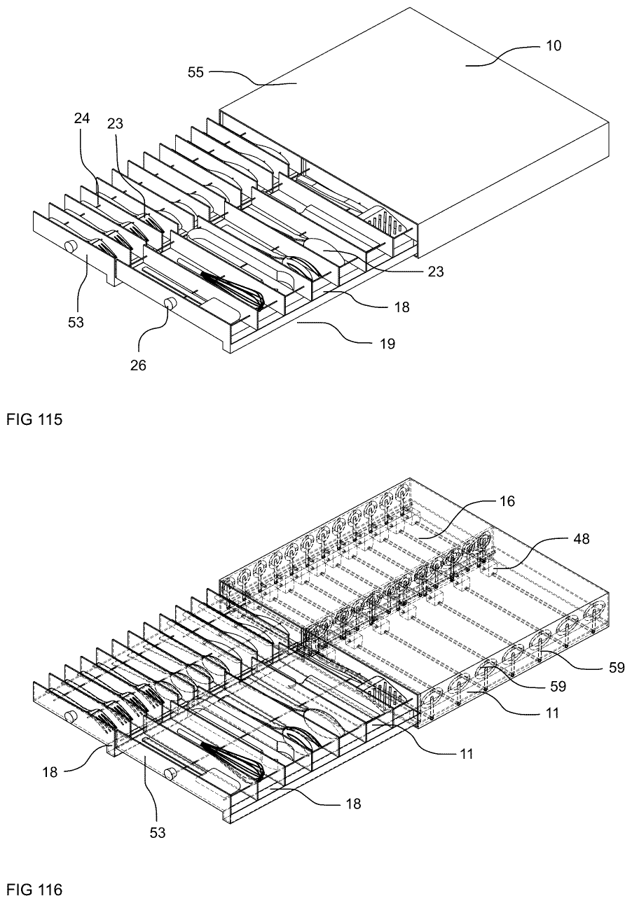

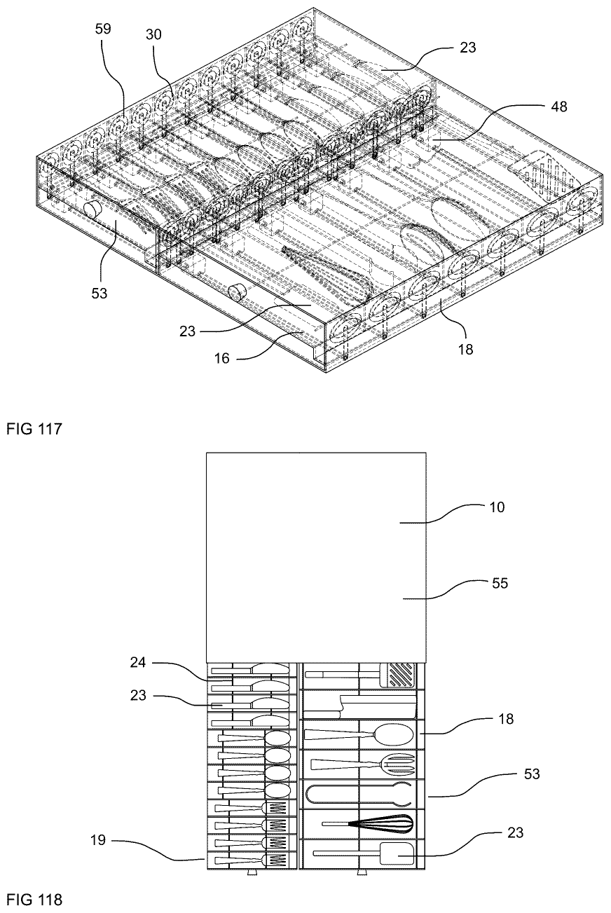

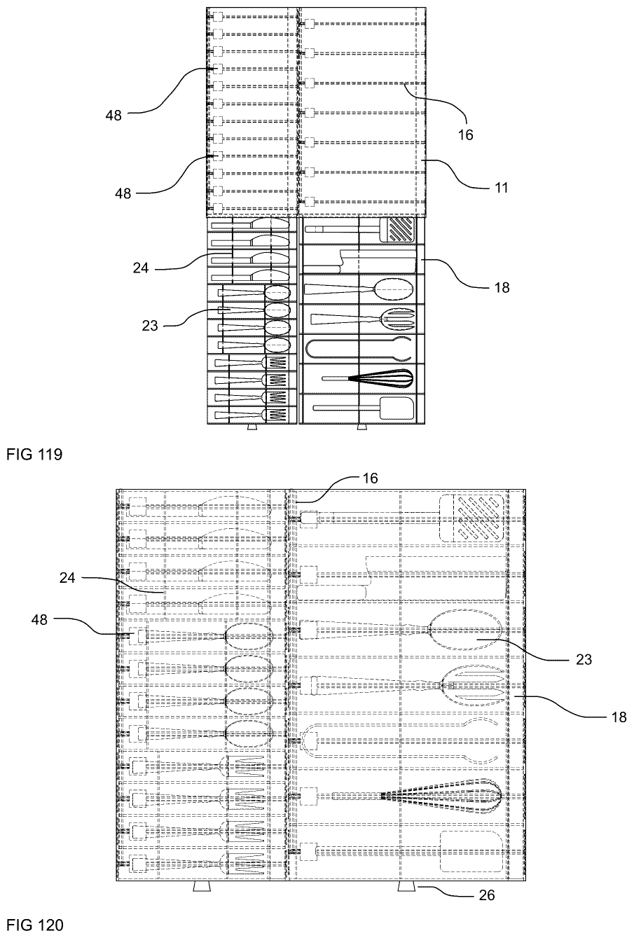

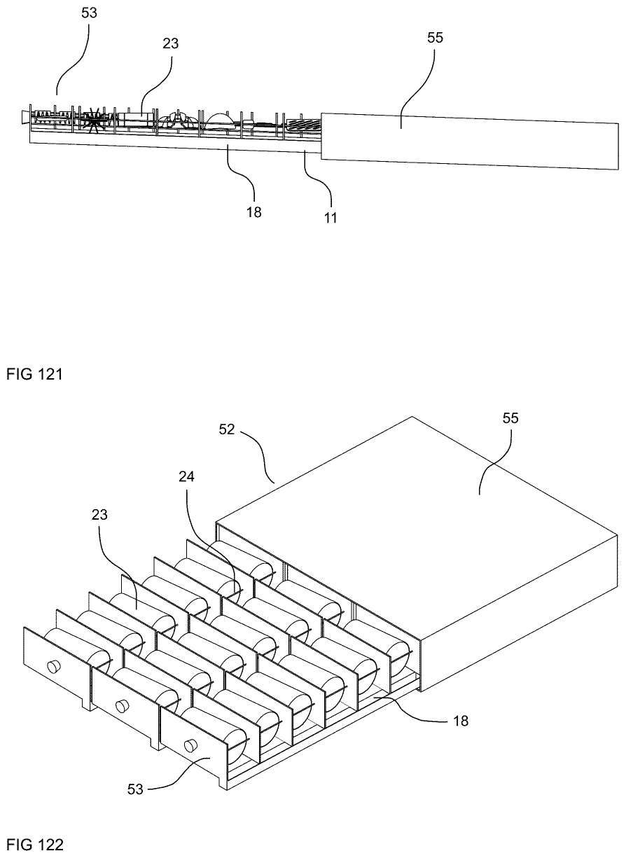

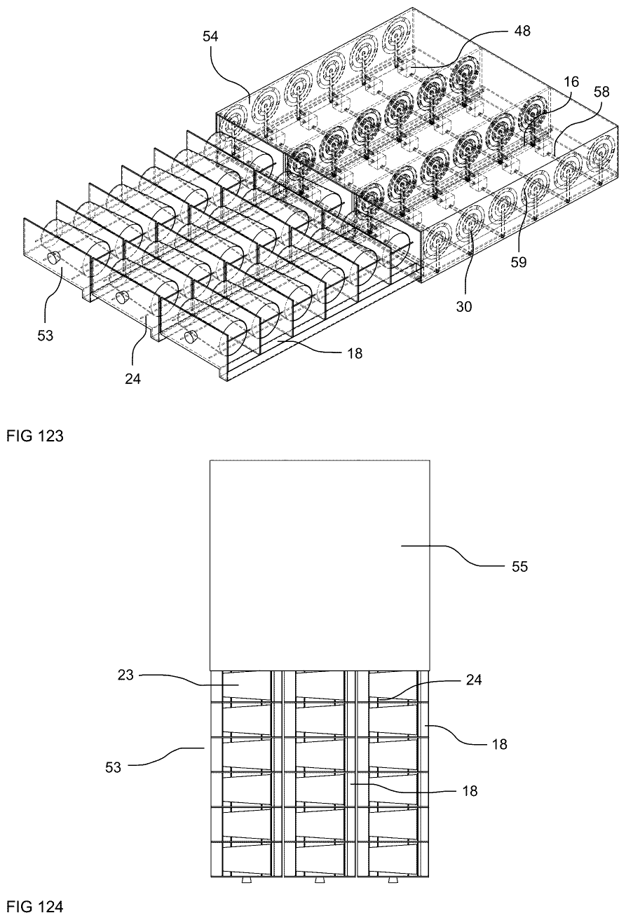

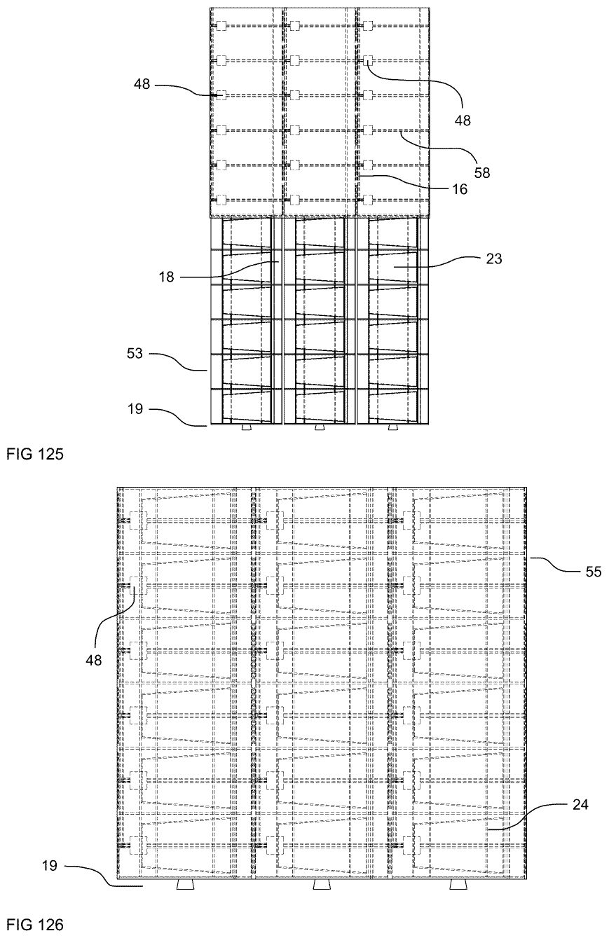

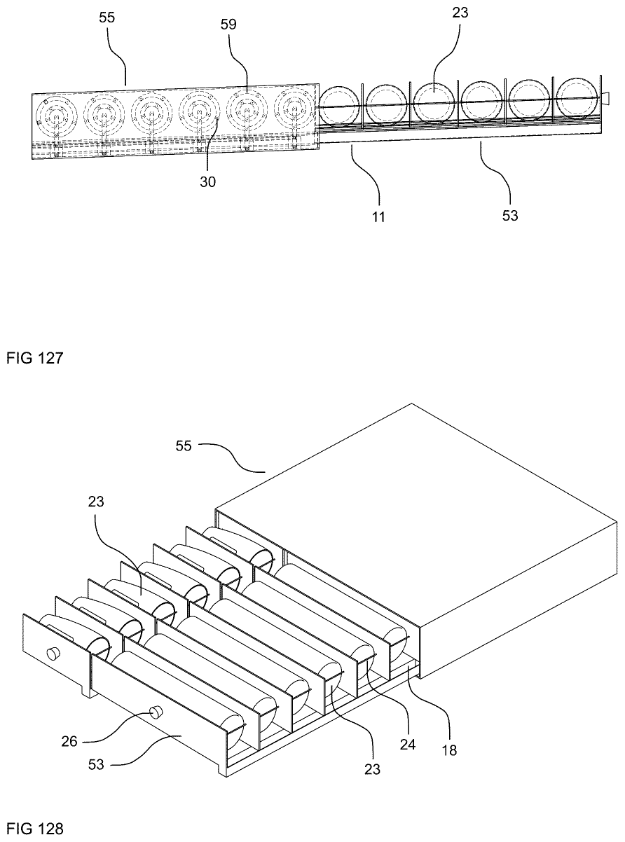

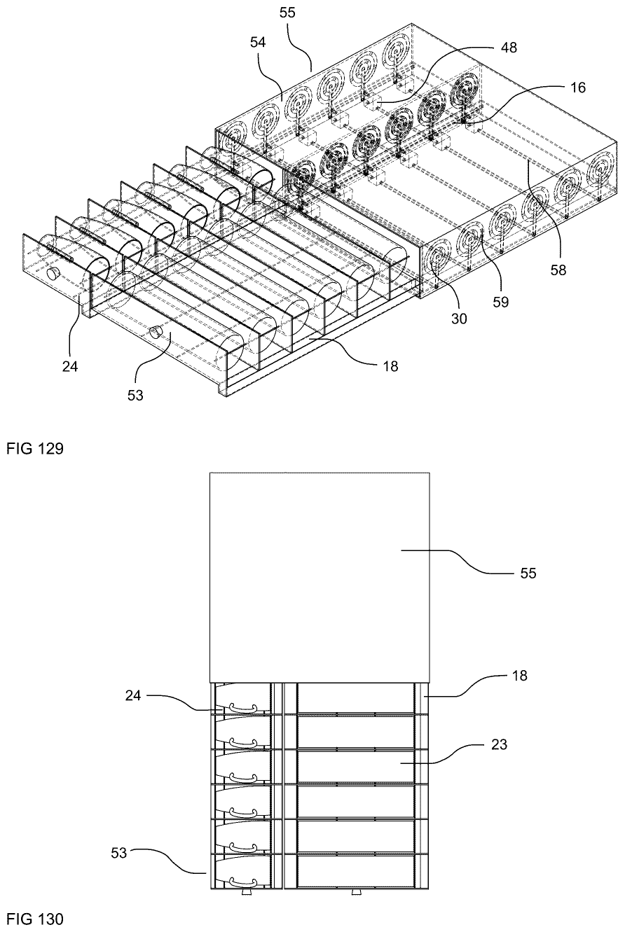

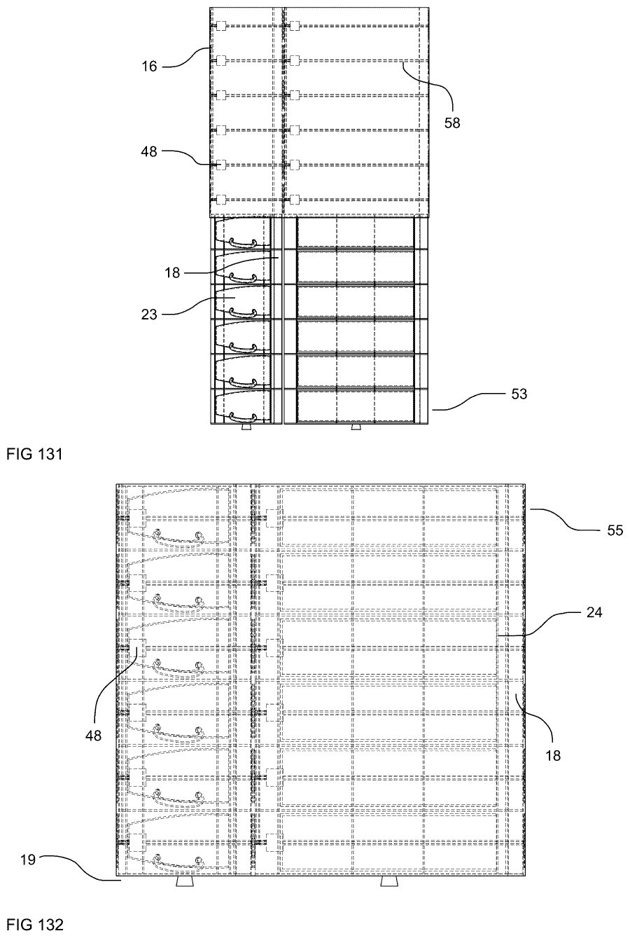

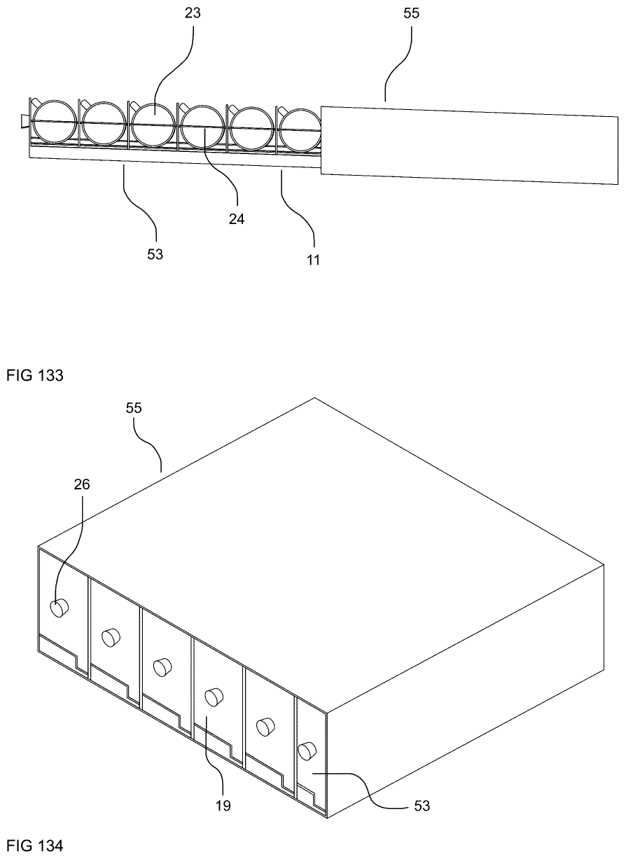

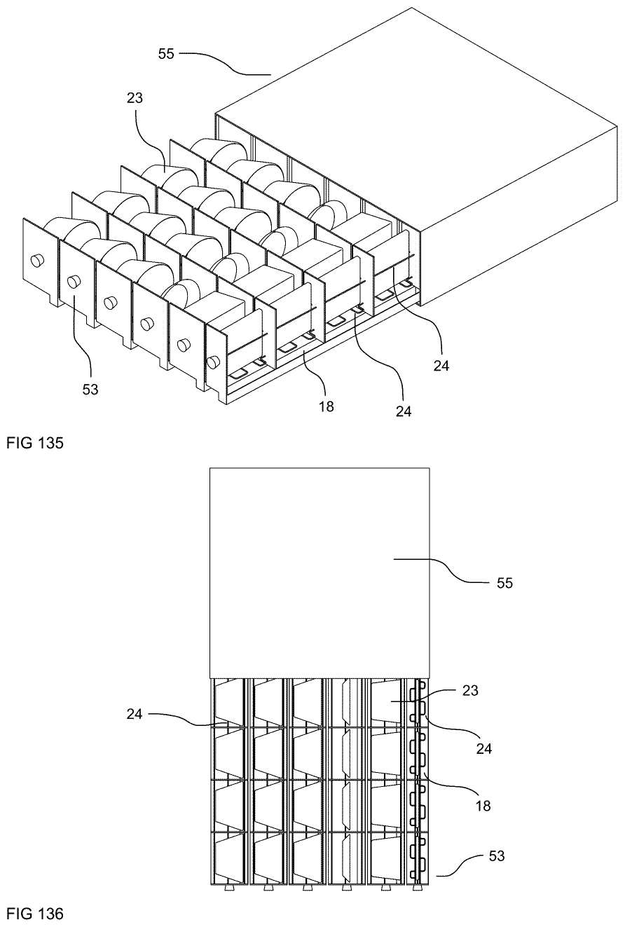

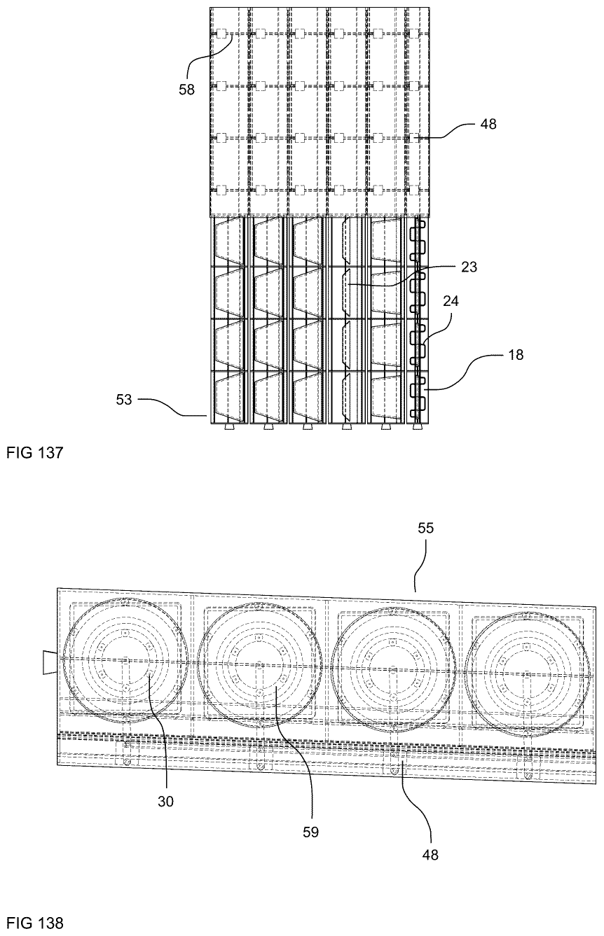

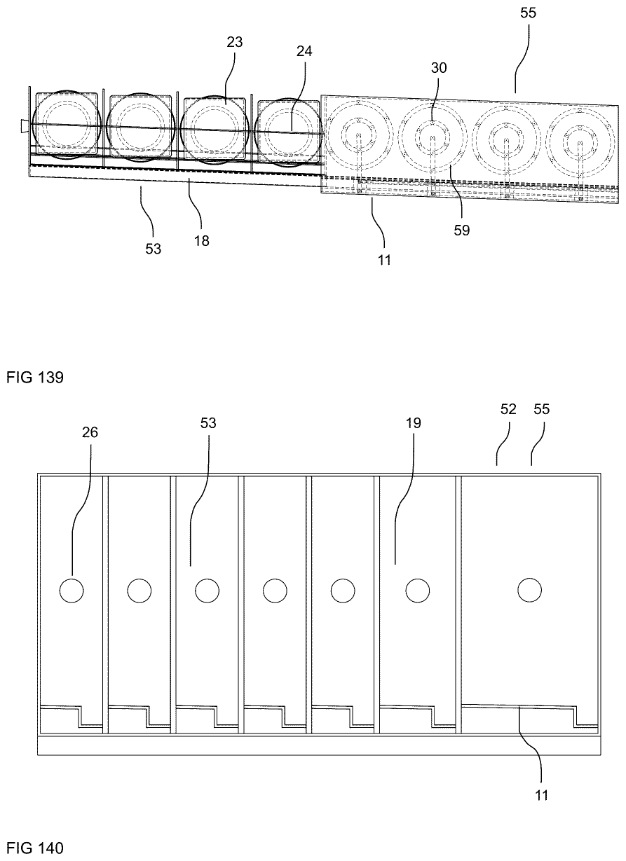

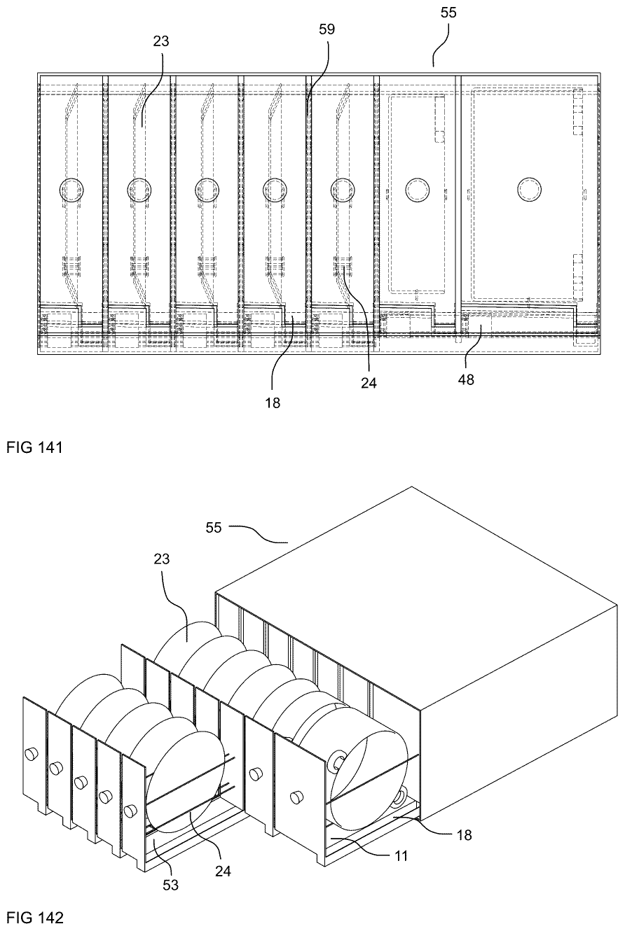

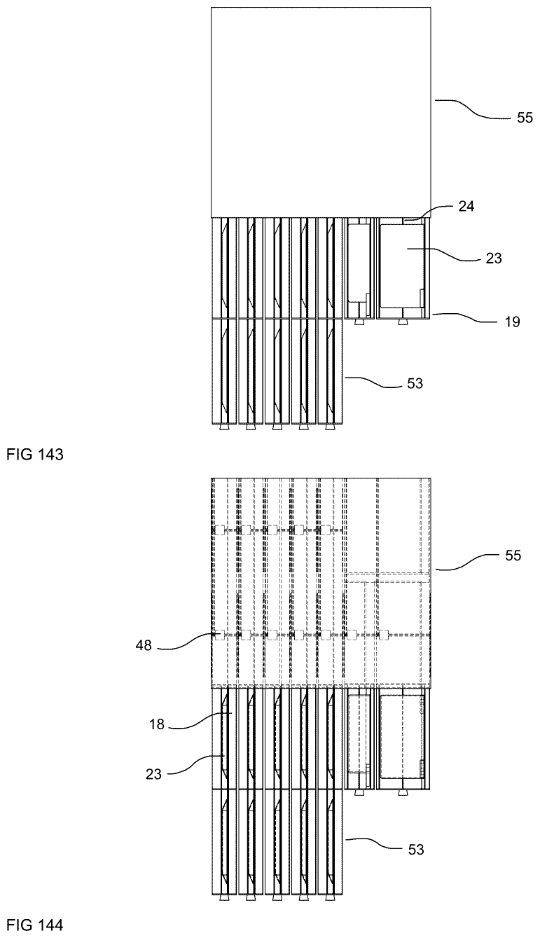

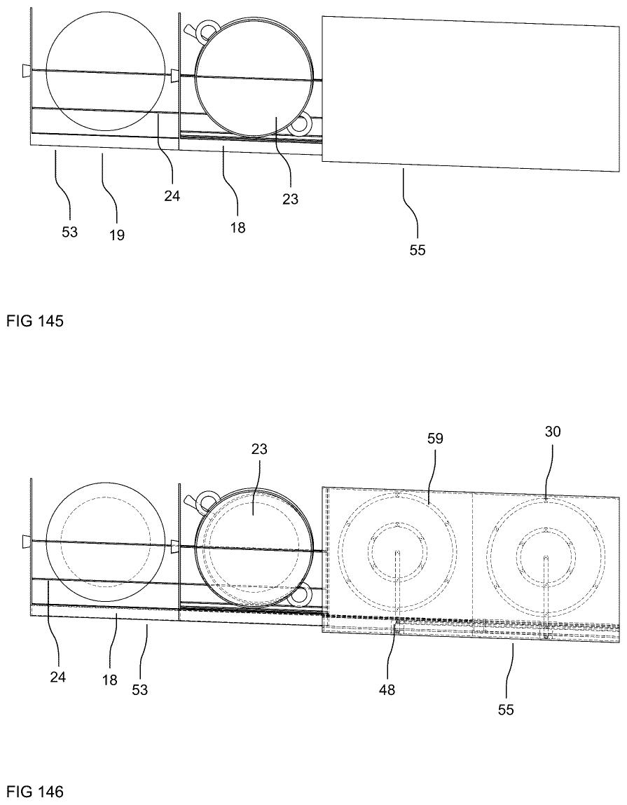

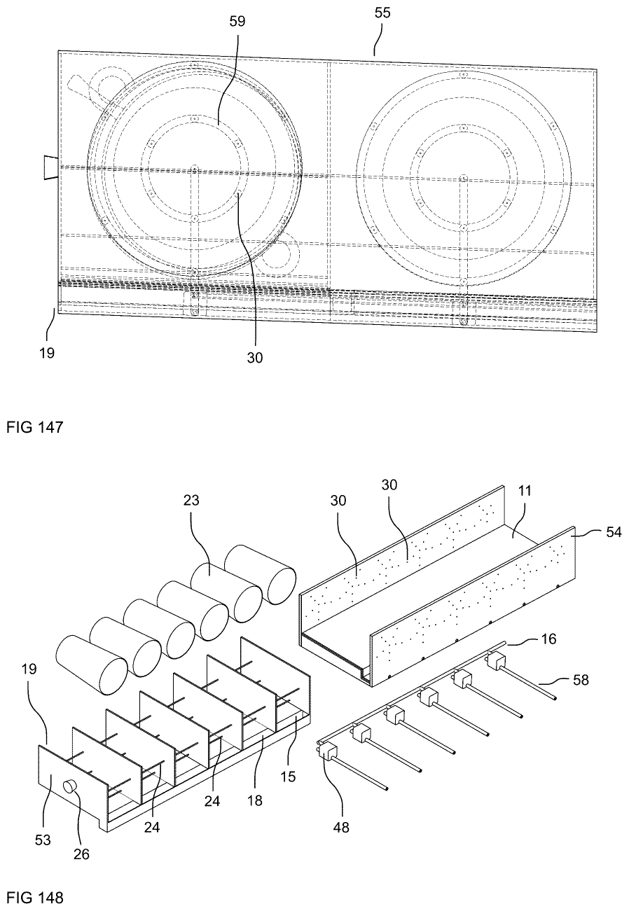

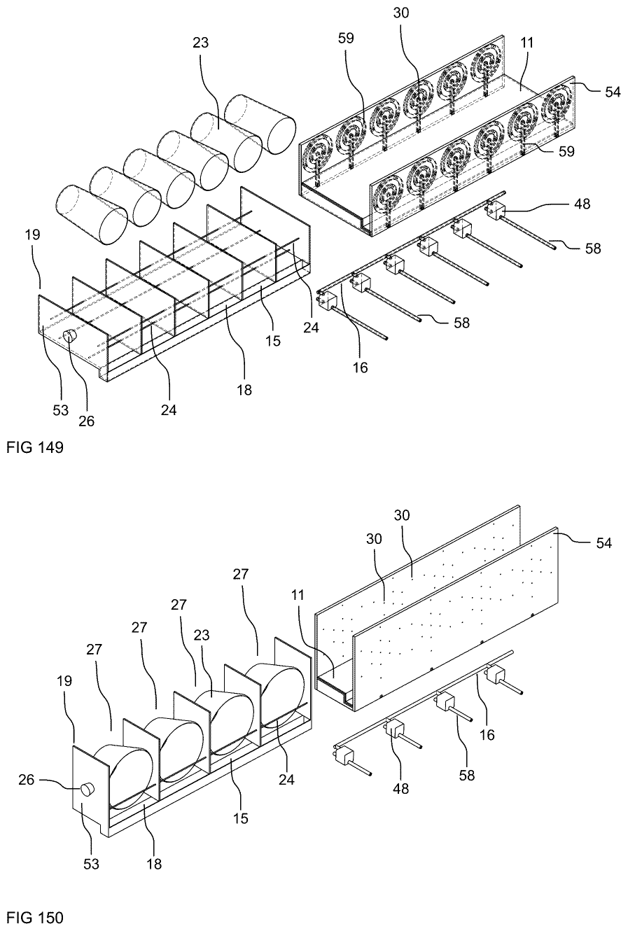

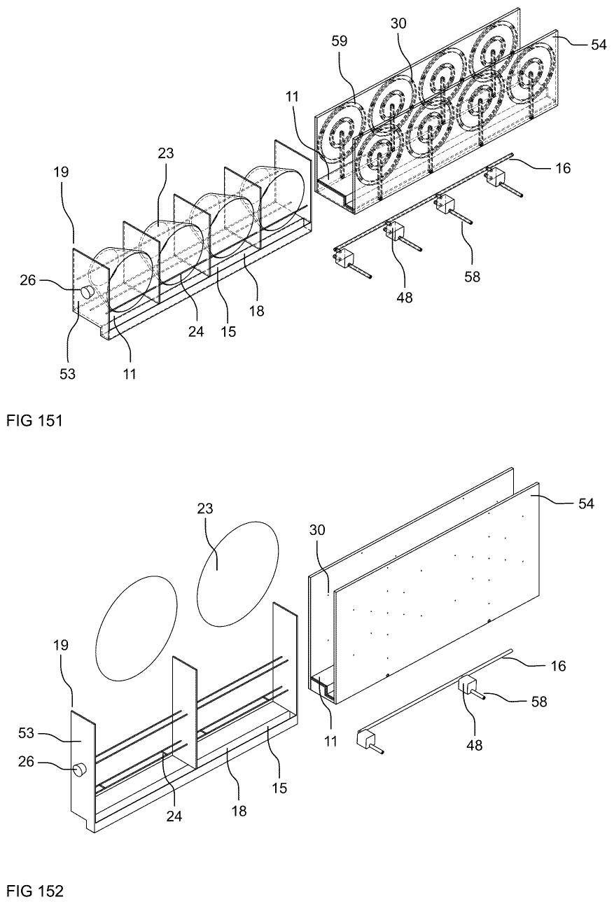

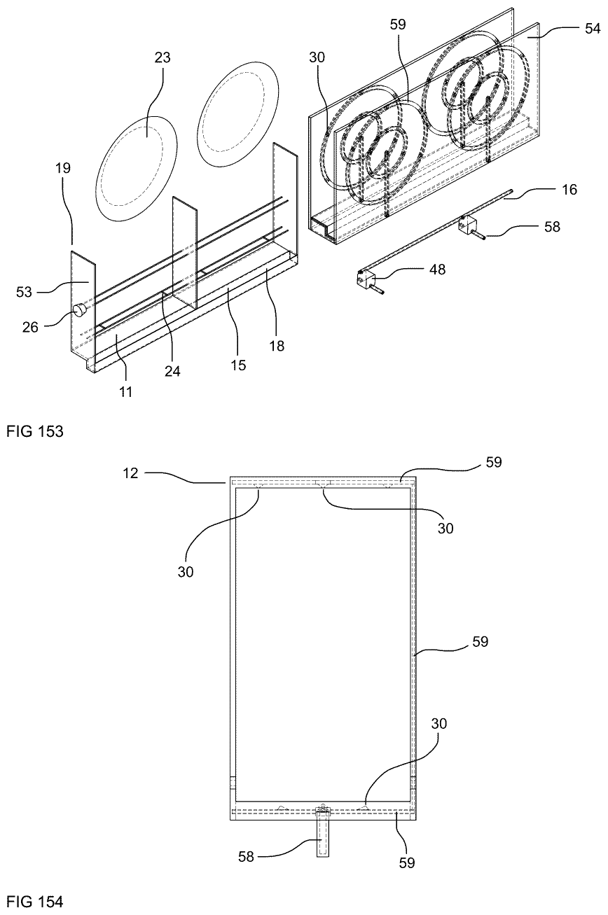

Every sliding drawer compartment 53 contains two or more kitchen item cubbies 27 (FIG. 150). A compartment 53 can lay out kitchen item cubbies 27 in either a 1D line or a 2D grid pattern. FIG. 150, for example, depicts a sliding drawer compartment 53 in a horizontal line cubby layout 50. Each sliding drawer compartment 53 slides in and out of a drawer housing 54, which contains the fluid delivery lines 16, fluid direction control devices 48, and the spray mechanisms for each cubby slot 27 (FIG. 113). One variation to this design is to house the fluid delivery lines 16, fluid direction control devices 48 and spray mechanisms inside the sliding drawer compartment 53 itself instead. This would make repairing or replacing faulty valves 48 easier, however it would also require a push connect component to connect and disconnect the delivering fluid line(s) 16 and any electrical wires with a connector, each time the drawer is accessed. Multiple drawer housings 54 can be laid out side by side, often in a drawer housing shelf 55. Multiple shelves can then be stacked to form a grid of drawers on a vertical plane 52 (FIG. 109).

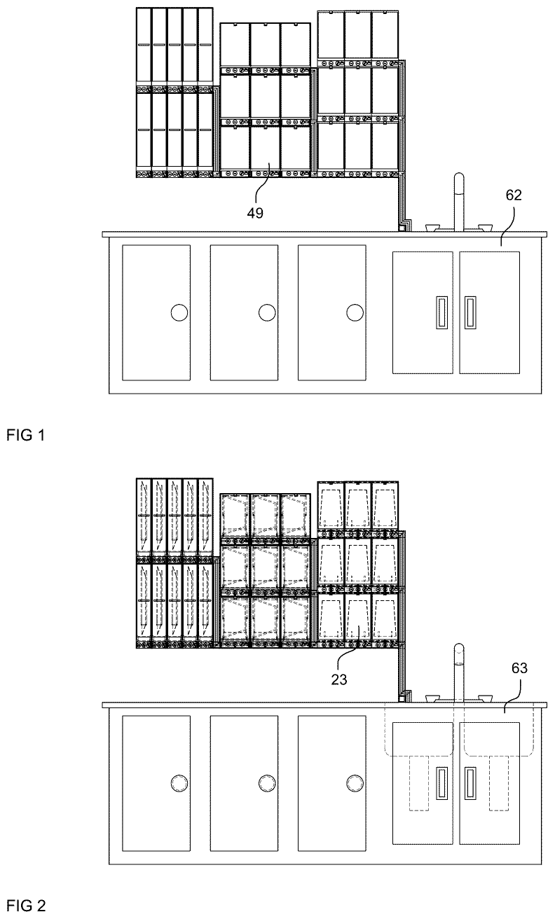

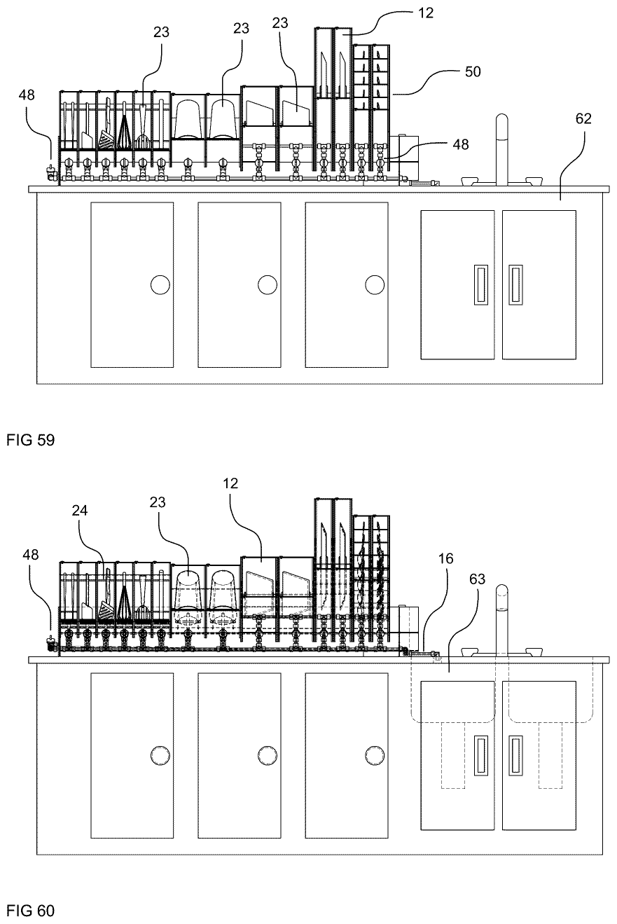

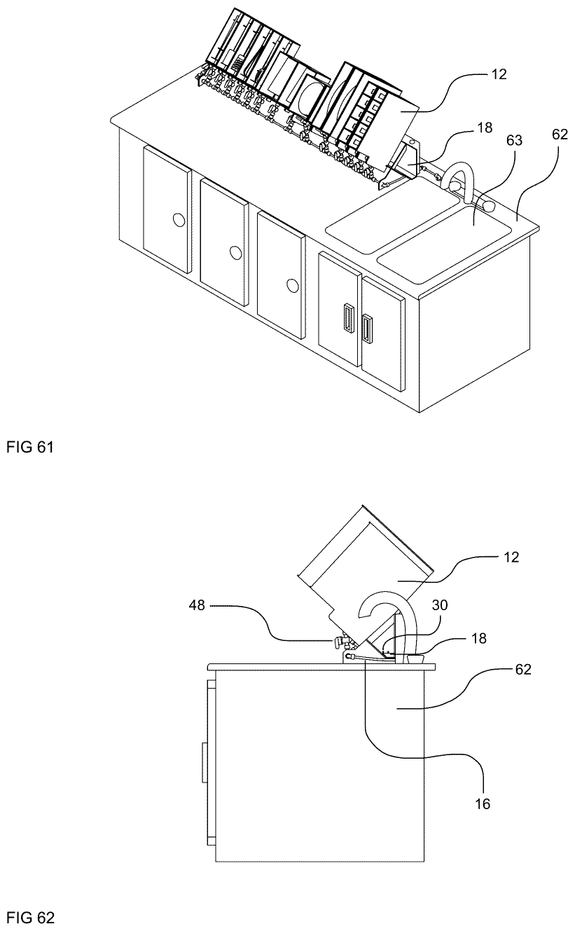

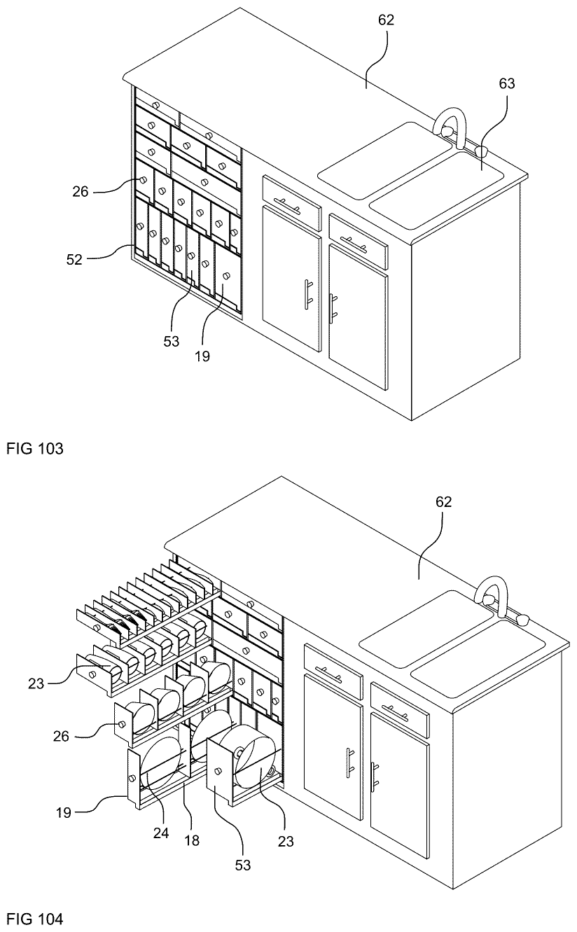

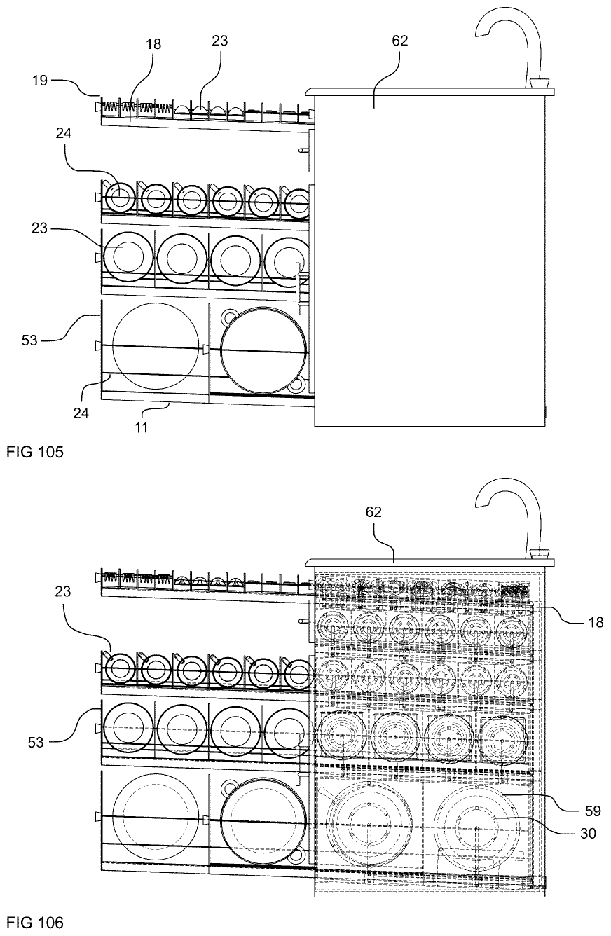

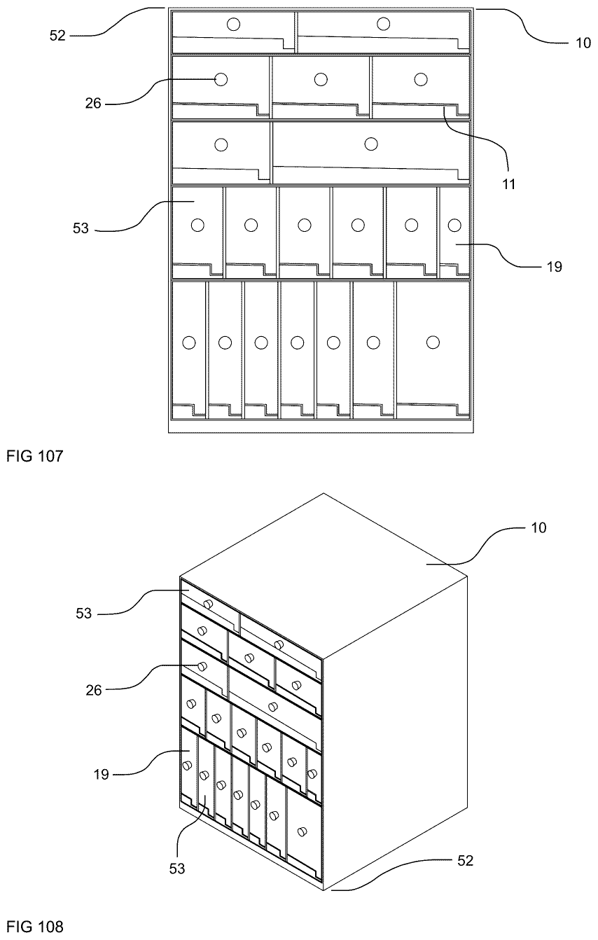

Four main embodiments are presented in the drawings: a cabinet kitchen storage system 10 (FIG. 1), a countertop kitchen storage system 10 (FIG. 59), an in-counter kitchen storage system 10 (FIG. 94), and a sub-counter kitchen storage system 10 (FIG. 103). All four embodiments consist of a plurality of compartments of various types 12 14 53, each compartment housing one or more kitchen item cubbies 27, each of which may house one kitchen item 23. Each kitchen item cubby 27 has access to one or more spray mechanisms 56 57 59 64 65, which connects to a fluid line stem connector 58, which connects to a fluid direction control device 48, which connects to one or more shared fluid delivery line(s). Each kitchen cubby 27 also has access to a drainage conduit 18, through a drainage opening 15, and a sloped floor 11.

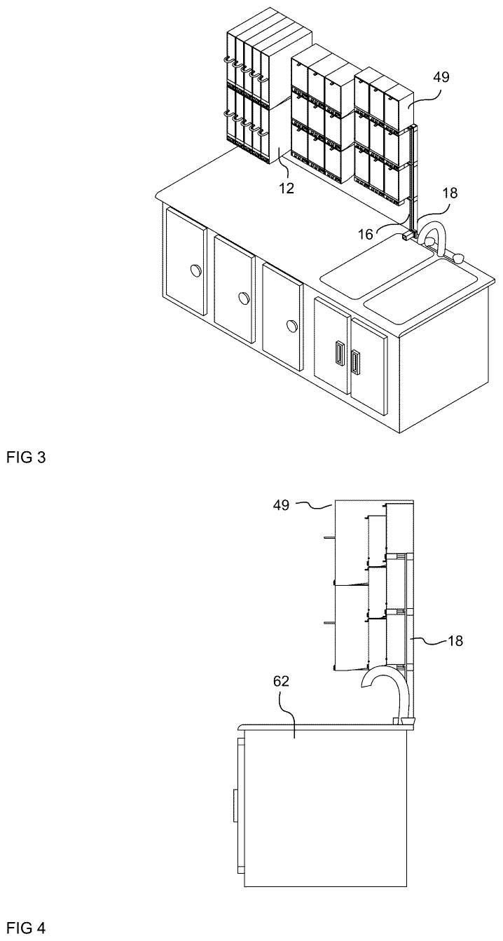

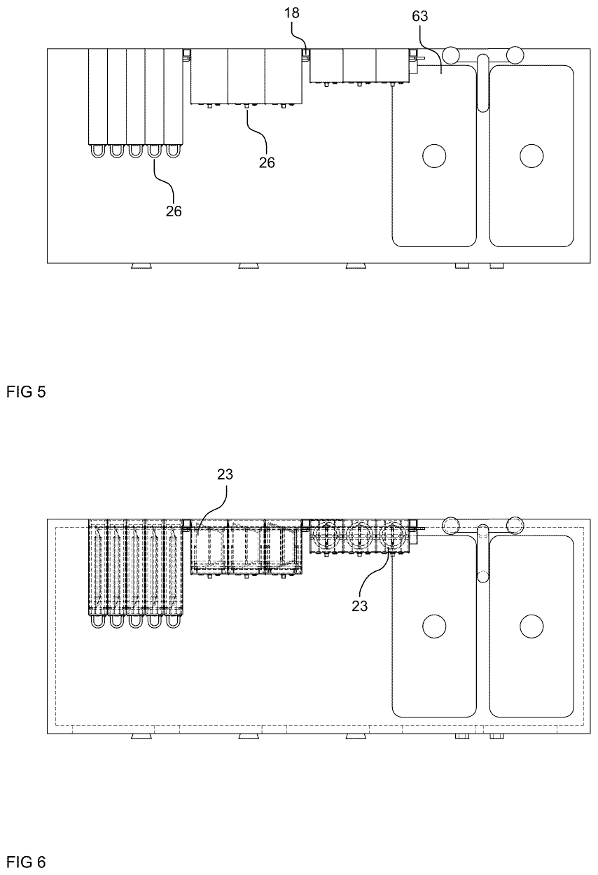

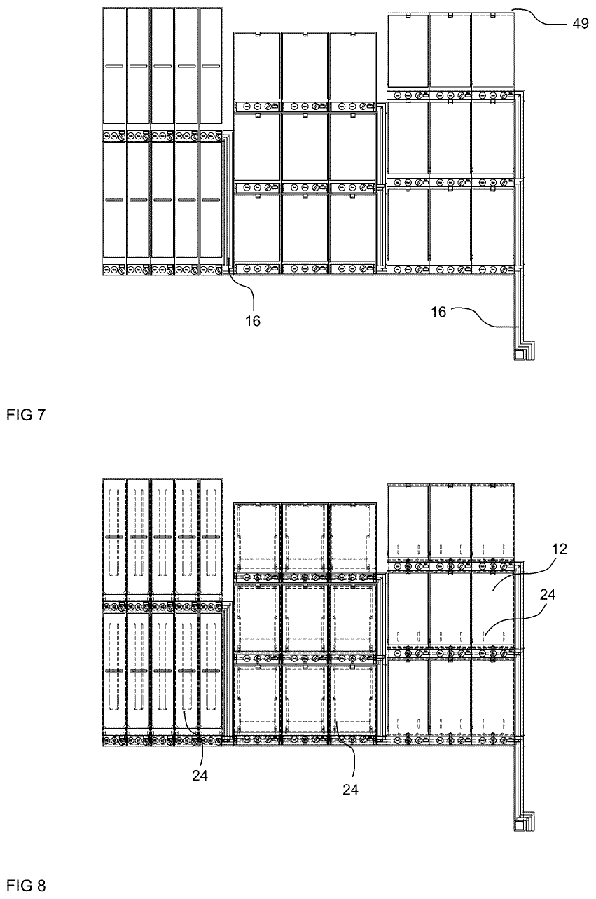

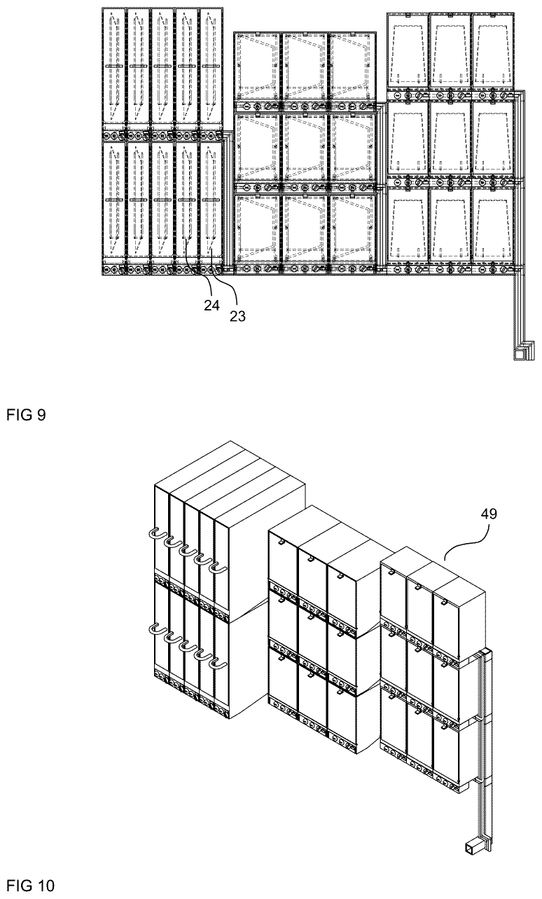

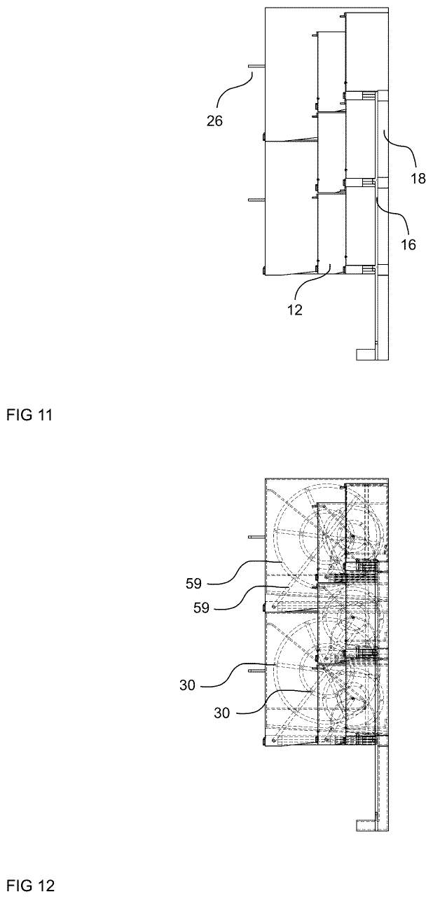

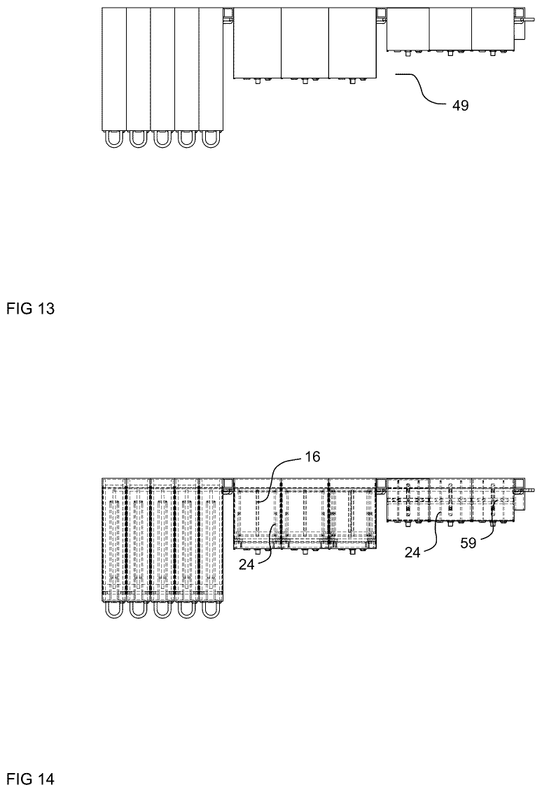

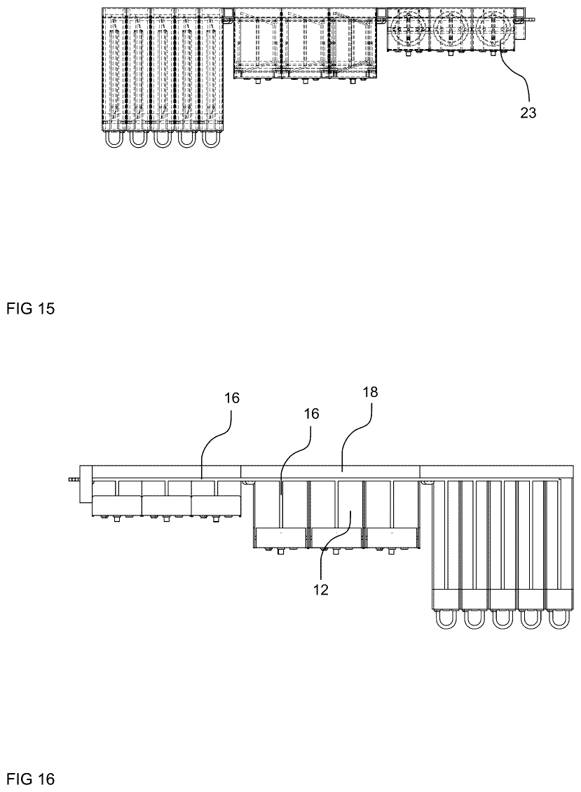

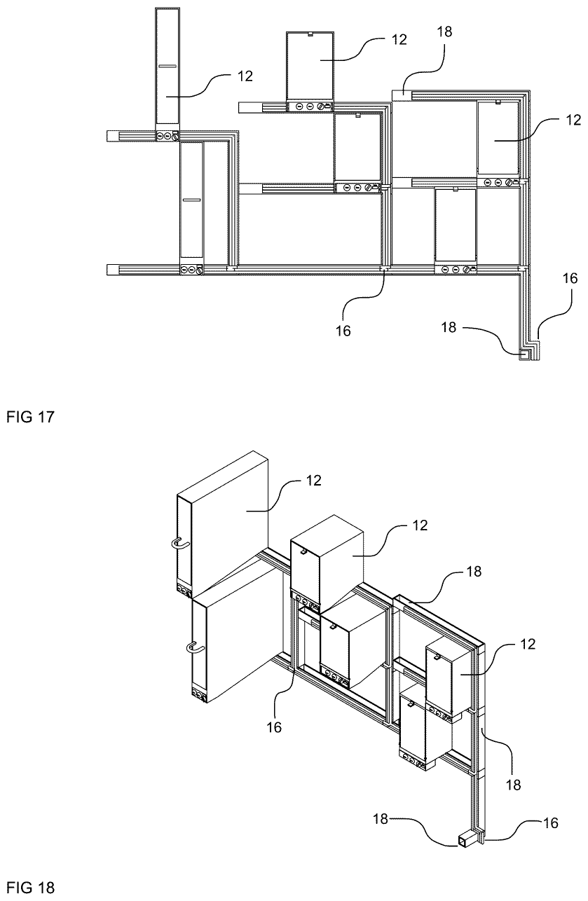

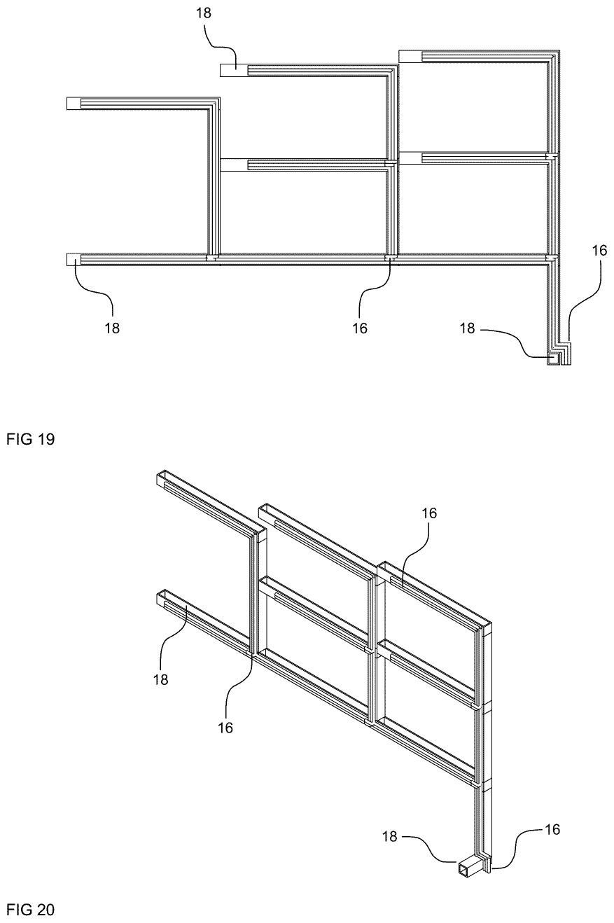

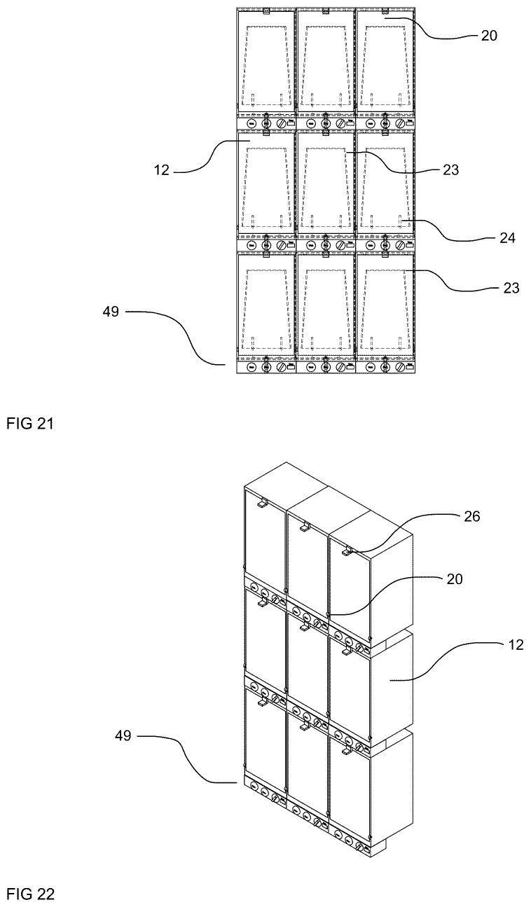

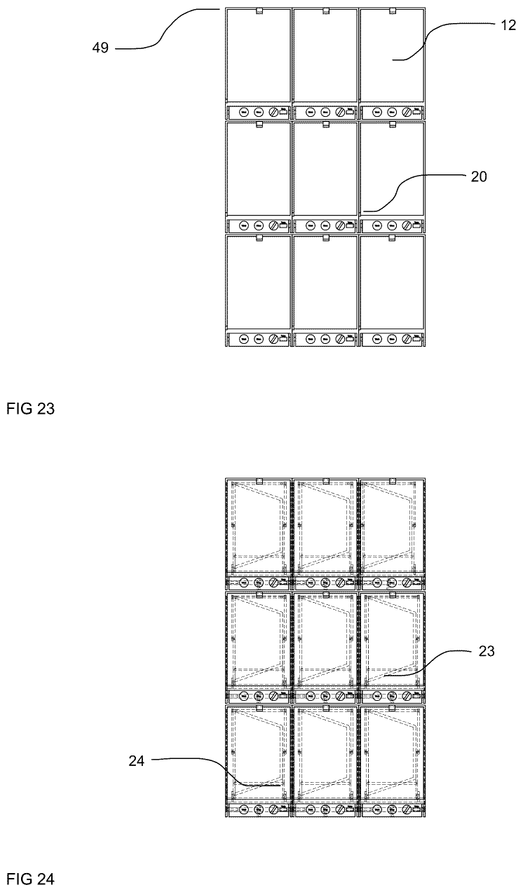

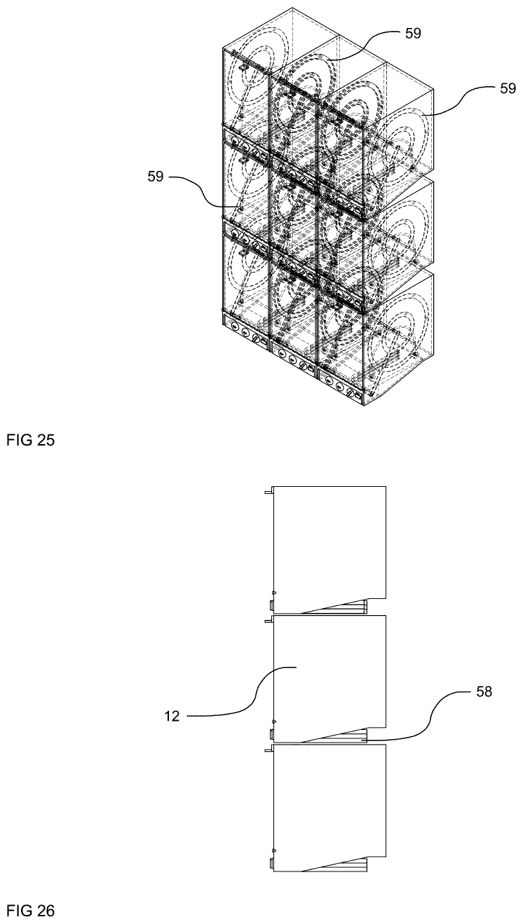

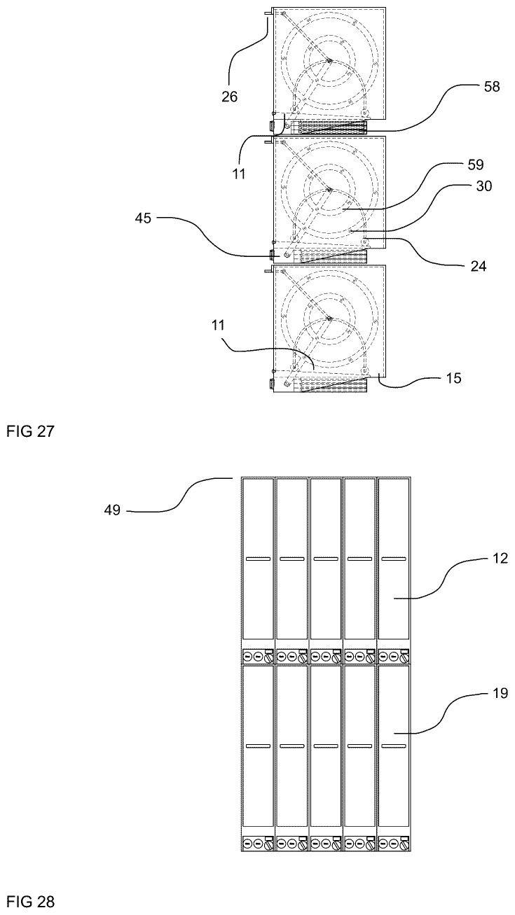

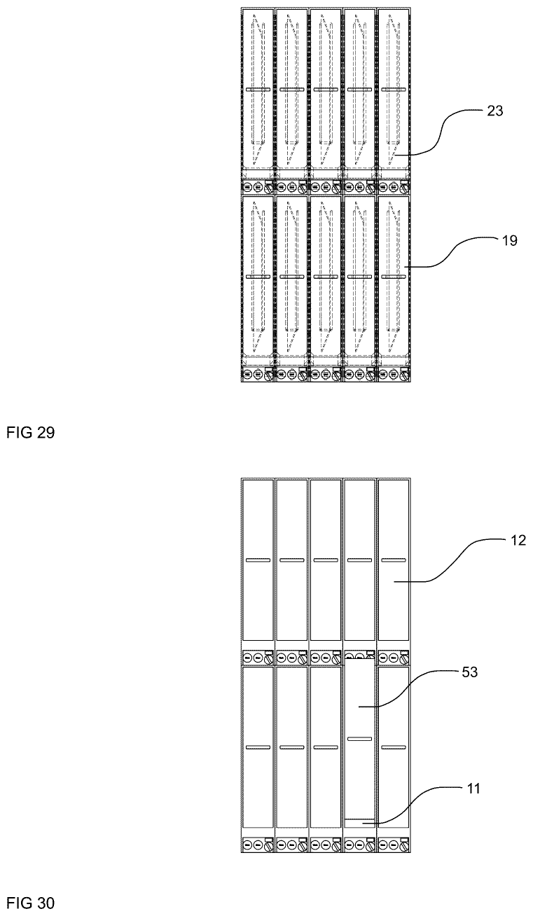

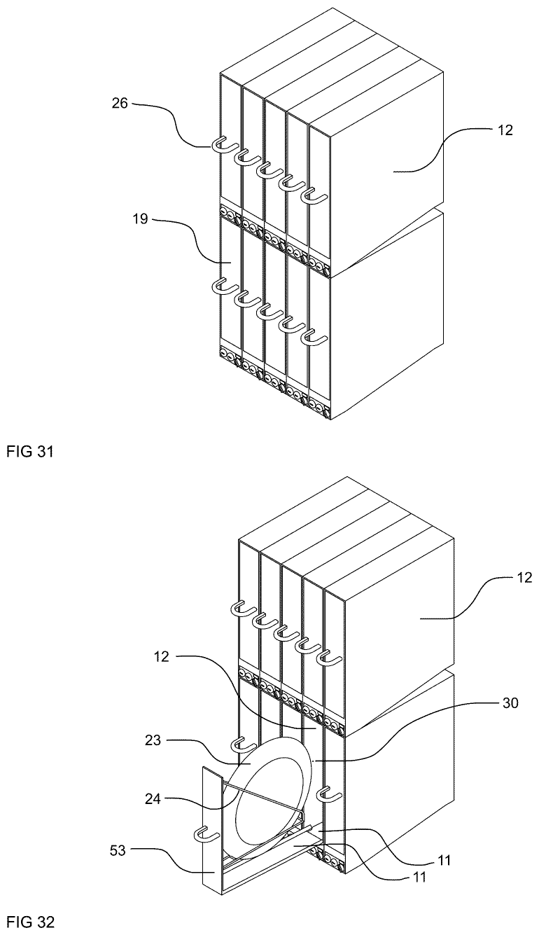

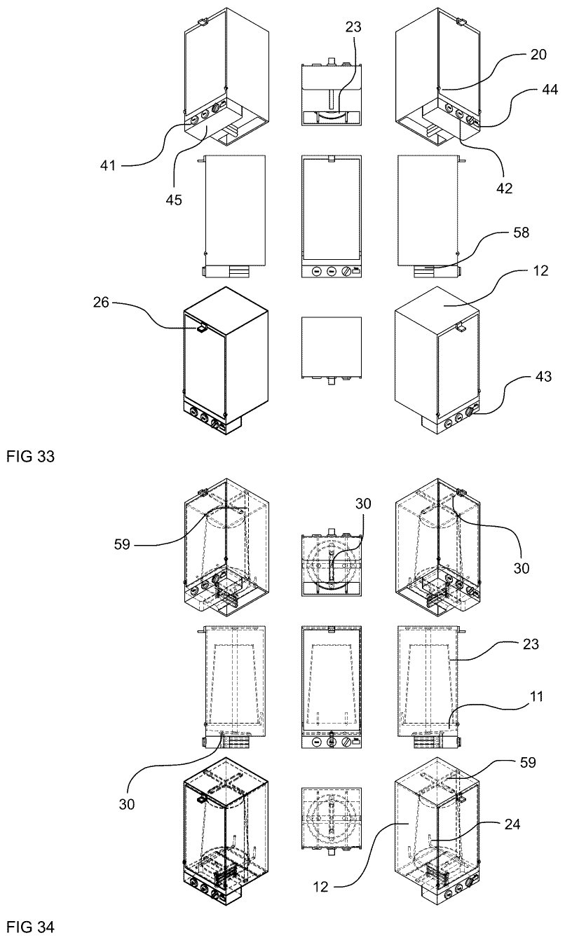

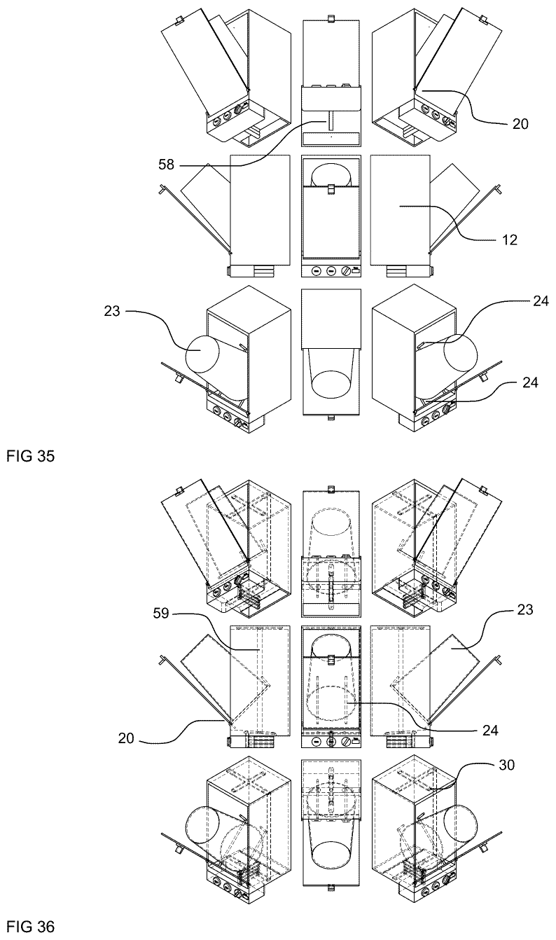

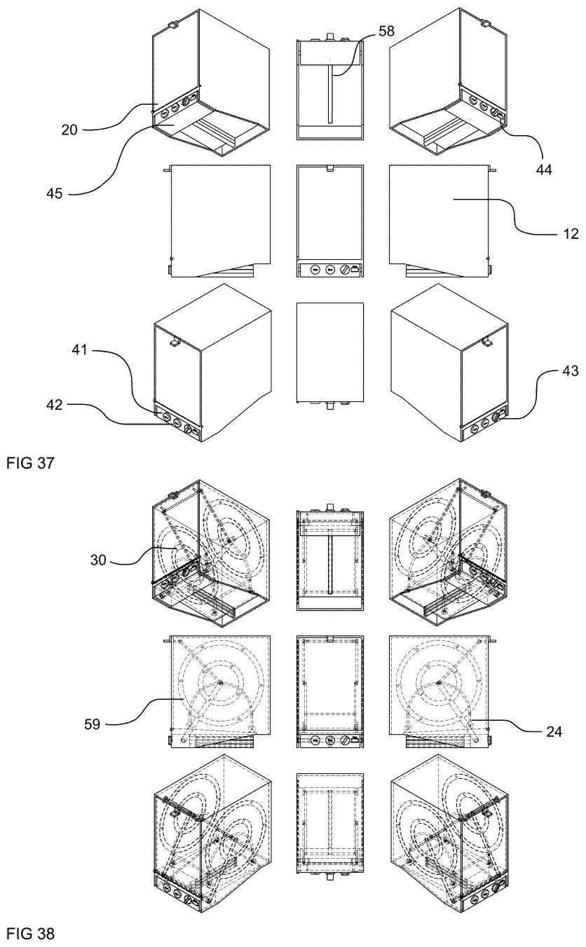

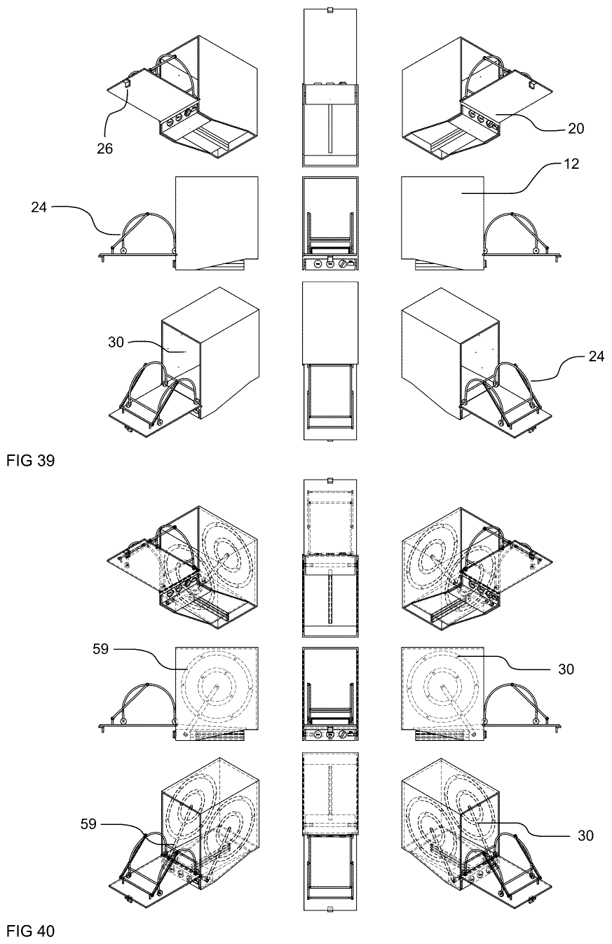

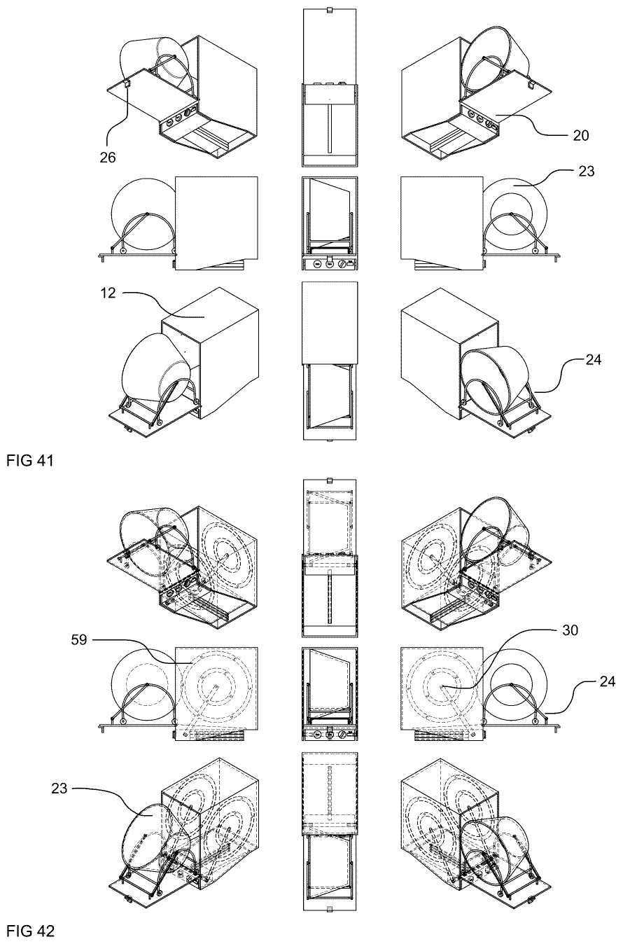

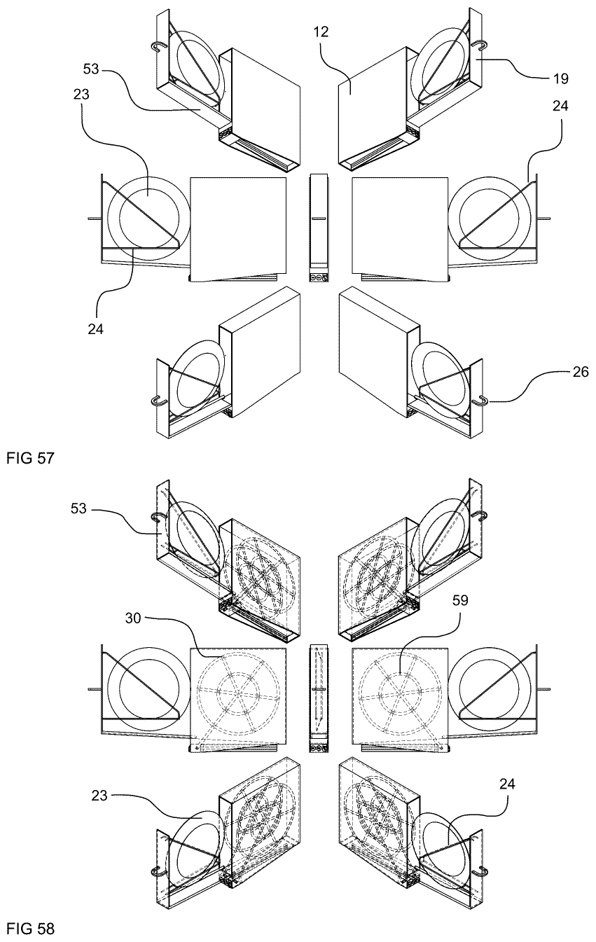

The “cabinet” style embodiment shown in FIG. 3 consists of 28 fixed single item compartments 12 oriented in a vertical plane cubby layout 49. From left to right, there are 10 plate compartments (FIG. 29), 9 bowl compartments (FIG. 24), and 9 cup compartments (FIG. 21). The plate compartments have drawer access points 19 (FIG. 57), while the bowl and cup compartments have single cubby hinge lid access points 20, with a bottom hinge lid to catch falling waste when open (FIG. 33, 47). Each compartment 12 is equipped with an interface 45, consisting of a wash button 41, rinse button 42, temperature control knob 43, and a screen 44 (FIG. 43). There are three delivering fluid lines (FIG. 19, 20) that connect to each compartment 12—one for hot water, one for soapy water, and one for air. This means that each compartment's fluid direction control device 48 intakes three types of fluid (one for each fluid line), and outtakes just one fluid type through the fluid line stem connector(s) 58. The fluid then travels through internal grooves 59 in the compartment wall(s) and out the nozzle holes 30. Each compartment 12 also connects to a multi-level drainage conduit 18 (FIG. 19, 20). Notice the differences in the kitchen item retainers 24 of each compartment type.

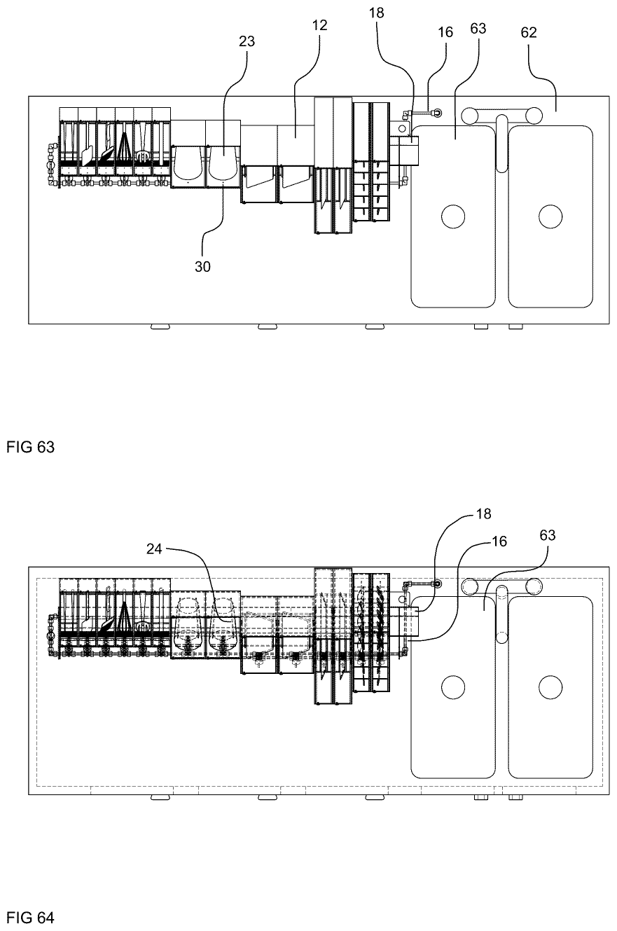

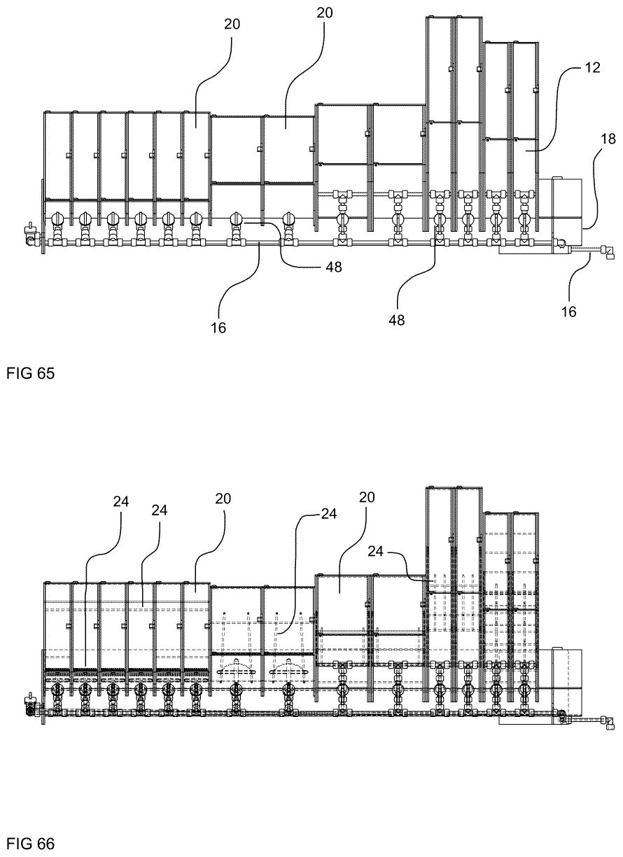

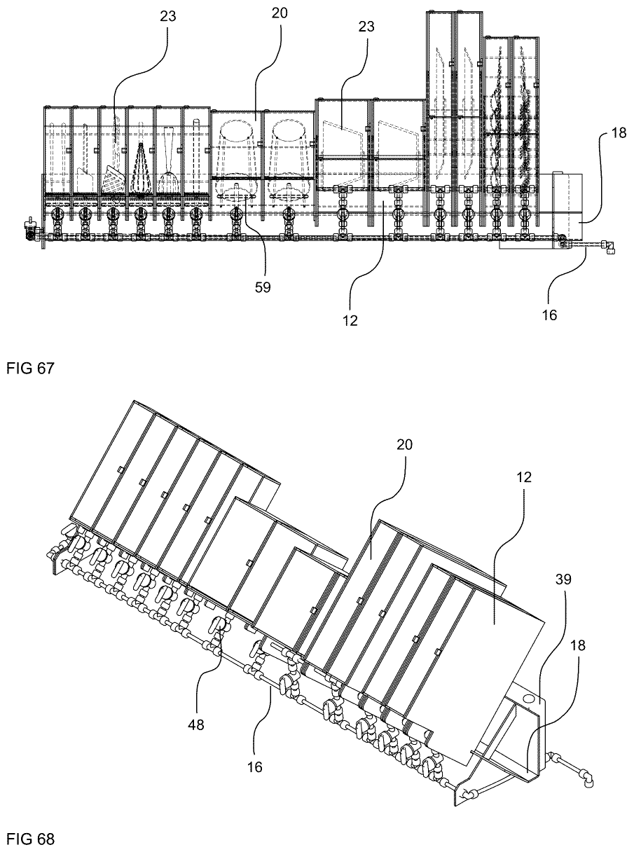

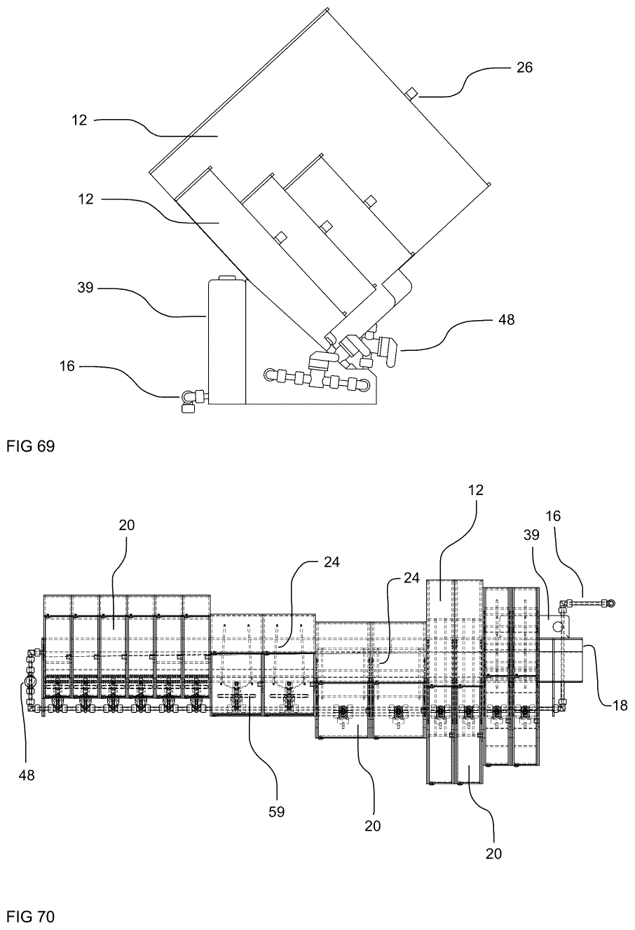

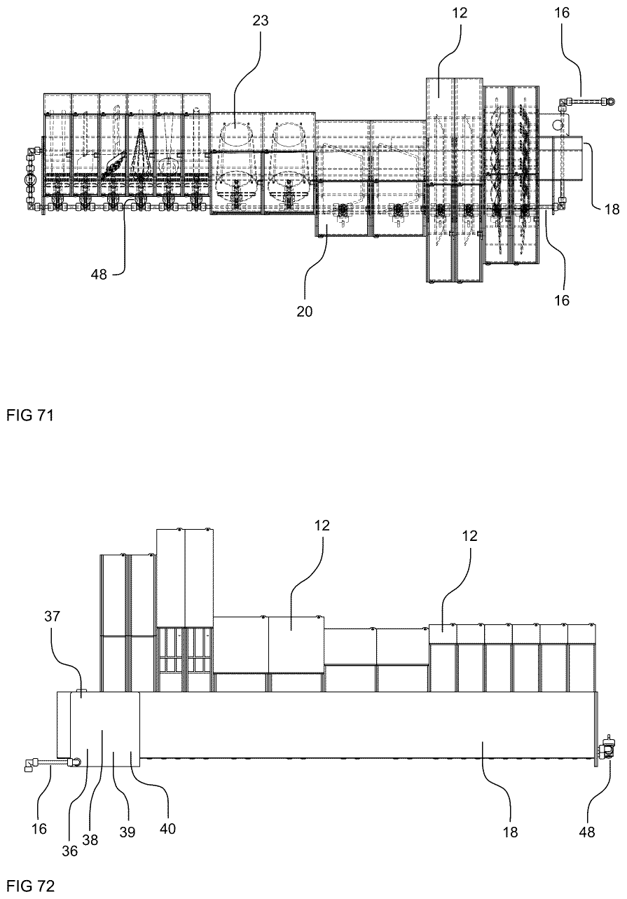

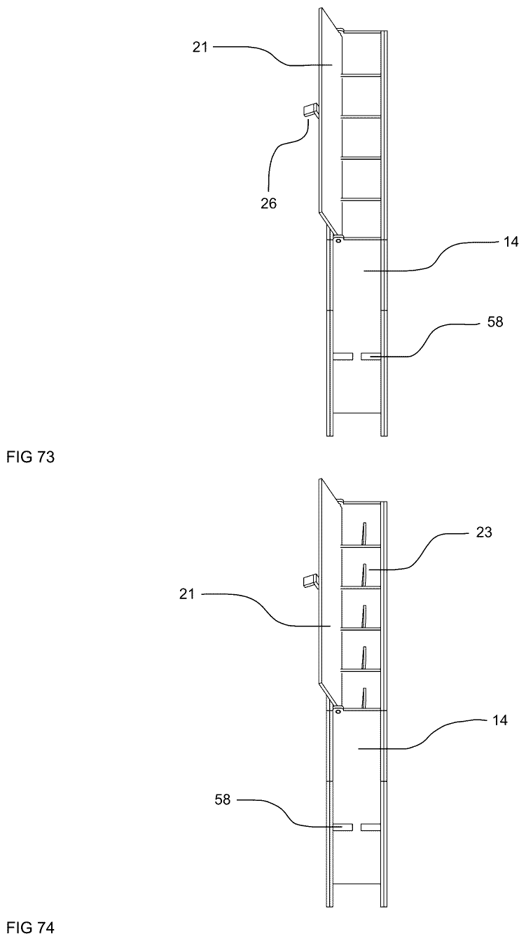

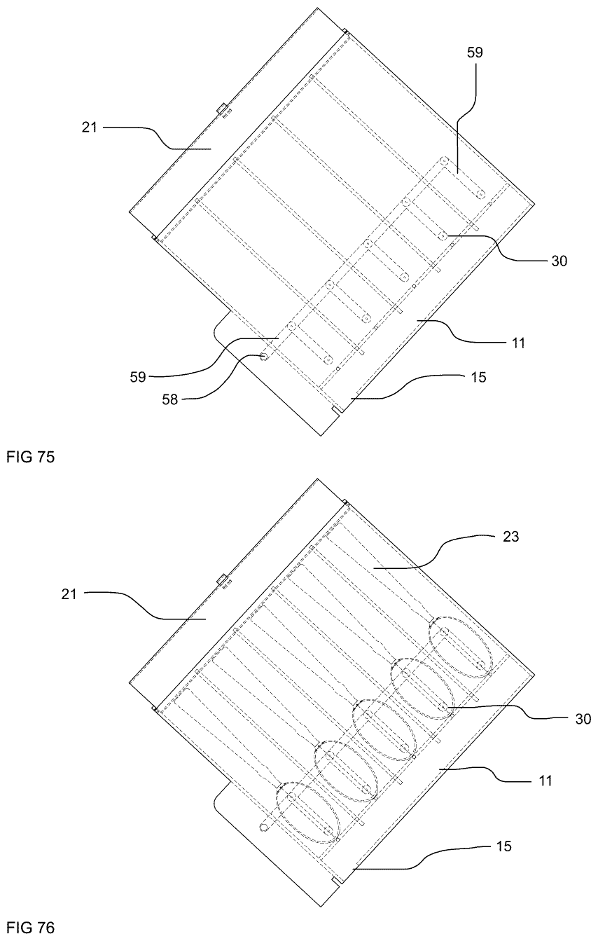

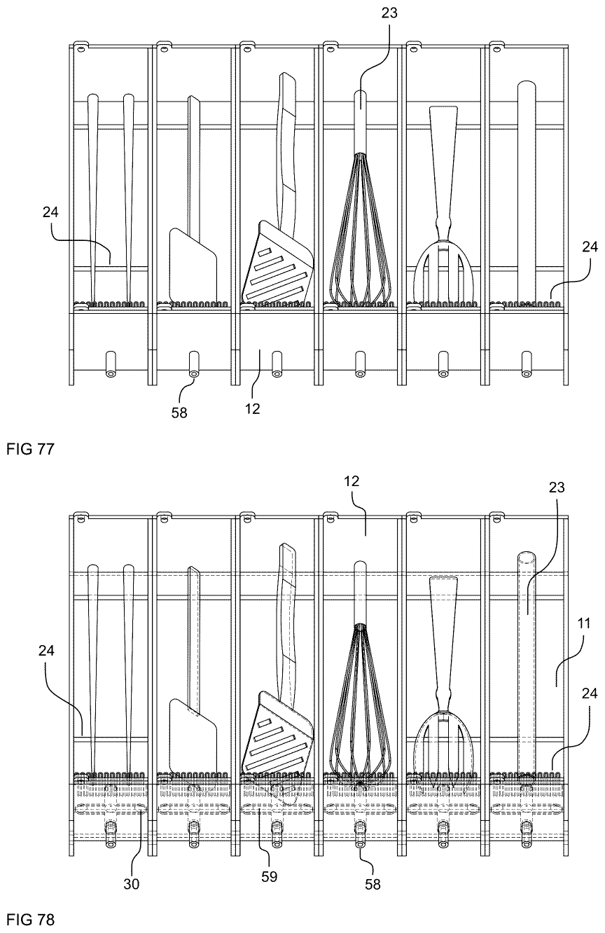

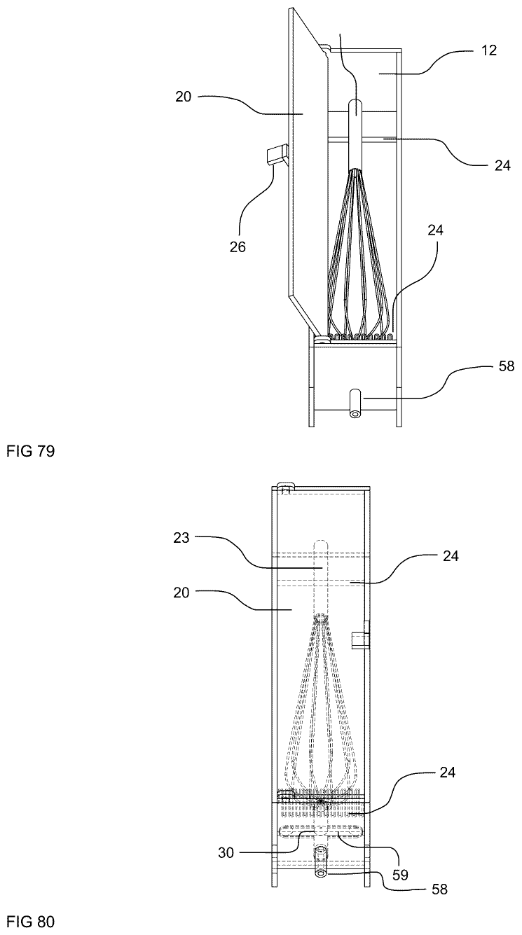

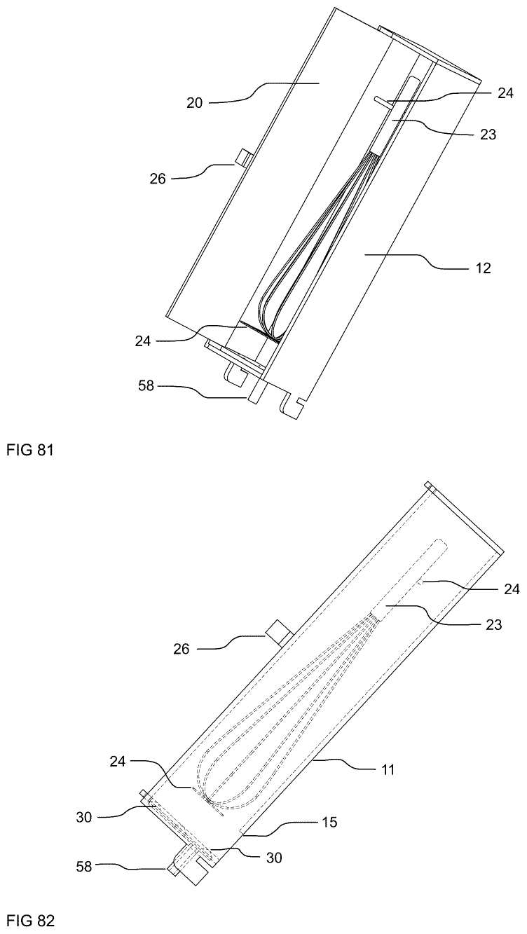

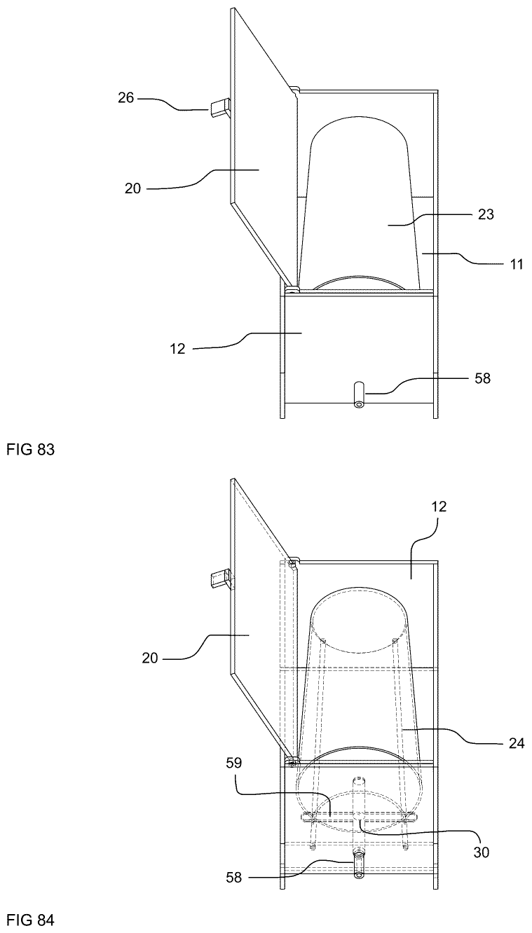

The “countertop” style embodiment shown in FIG. 59 consists of 14 fixed single item compartments 12 oriented in a horizontal line cubby layout 50. From left to right, the compartments house: chopsticks, spatula, metal spatula, whisk, salad spoon, straw, cups, bowls, plates, spoons, and forks. This kitchen storage system 10 sits on top of a countertop 62 next to a sink 63 for disposal access. This embodiment contains a single delivering fluid line 16 and a single drainage conduit 18 (FIG. 63, 65). On the end wall of the drainage conduit 18 there is an internal groove spray mechanism 59 which connects to its own fluid line stem connector 58 and ball valve 48. The purpose of this sprayer is to be able to flush out any lingering waste in the drain. Each compartment 12 utilizes an internal grooves spray mechanism 59, which connects to a mechanically actuated ball valve 48 through a fluid line stem connector 58. The ball valve 48 is then connected to the single fluid delivery line 16. The compartments 12 of this embodiment are positioned at an angle, tilted slightly towards the user. The purpose of this tilt is to ensure that the hinge lid 20 does not encroach on counter space, while also ensuring any overhanging cabinets don't interfere with accessing kitchen items 23. Despite the tilt, this design is still considered a horizontal line cubby layout 50, since it more closely relates to a “top access” access point, the way it catches waste without help from a lid or a drawer. The compartment interface 45 in this design is simply the ball valve 48 itself. There is also a control unit box 36, shown in FIG. 72 responsible for regulating temperature 40, pressure 38, and storing 37 and injecting soap 39 into the delivering fluid line 16.

The “in-counter” or “in-sink” style embodiment shown in FIG. 94 is a fixed shared items compartment 14 (FIG. 96) oriented in a horizontal grid cubby layout 51 with a shared hinge lid access point 21 (FIG. 95). This kitchen storage system 10 contains a single delivery fluid line 16 (FIG. 99), and drainage conduits 18 (FIG. 96), both laid out in a horizontal grid pattern underneath the compartments. This design employs a spinning nozzle spray mechanism 57, involving one or two spinning spray arms targeting each cubby 27.

The “sub-counter” or “traditional dishwasher” style embodiment shown in FIG. 102 is conveniently located in the same space where traditional dishwashers are located underneath the countertop 62. This embodiment consists of multiple drawer housing shelves 55 stacked on top of one another, each shelf 55 containing one or more drawer housings 54, which each contain a sliding drawer compartment 53, which contains one or more kitchen item cubby 27.

To further understand the invention I will present a hypothetical example scenario describing a user interacting with the kitchen storage system 10. Imagine the following situation. A family with three children (five people in total) wants to eat a stir fry with vegetables and noodles. A parent starts by preparing the meal. During meal preparation the parent grabs zucchini 23 from one compartment, peppers from another compartment 12, and bok choy 23 from another. Before grabbing the bok choy, the parent presses a “quick rinse” button 42 on the bok choy compartment 12 to clean the bok choy leaves off. The zucchini and peppers were already previously rinsed. The parent chops up the vegetables, throws them in the stir fry and continues meal preparation until finishing. While cooking, the parent turns a temperature control knob 43 to the right on each of the five plate compartment interfaces 45 to preheat five plates. The parent then turns the knobs 43 to the left on each wine glass compartment interface 45 to “chill” two wine glasses before dinner. Once finished with cooking, the parent grabs five clean cups 23 from five cup compartments 12 for the whole family to drink water, two clean and chilled wine glasses 23 for the two parents to drink wine, and the five (now hot) clean plates 23 from the five plate compartments 12. The parent also grabs five clean forks 23 and five clean knives 23 from ten utensil compartments 14. The table is then set and the family has dinner. After dinner a parent instructs each child to put away their own dishes 23. The first child brings his/her dirty plate, fork, knife and cup to the appropriate compartment 12. He/she drops his/her dirty plate in an empty plate compartment 12 (there should be at least five available), his/her dirty fork and dirty knife in two separate empty utensil compartments (there should be at least ten available), and his/her dirty cup in an empty cup compartment 12 (there should be at least five available). The child then closes all four compartments 12. The other two children do the same as the first child, followed by each parent. The parents have the extra task of putting their two dirty wine glasses in two empty wine compartments 12 and closing the access points doors 20. The family can now go about their day. Depending on the specific design variation, the system 10 will either 1) wash each dirty dish simultaneously immediately once the lid/door 20 has been closed, or 2) wash each dish one by one in a queue. The former would be faster than the latter, but either way, all the dishes will be clean and sitting where they were placed in a matter of minutes. The next time the family wants to eat or drink they can simply open a compartment 12 and grab a clean dish 23. There are no dirty dishes 23 from dinner sitting on the counter, no dirty dishes stacked in the sink 63, no clean dishes drying in a drying rack beside the sink, and no traditional dishwasher to load or unload into cabinets and drawers. Also it's important to note that in most scenarios, there would be more dishes than people. For example, there may be eight plate compartments 12, each housing a separate plate 23. This would mean that, going back to the scenario above, even before the dirty dishes from dinner are finished being cleaned, there would still be three clean plates 23 to grab from the other three remaining “ready” compartments 12. To provide feedback to the user, an indicator light 46, like the glowing interface 45 in FIG. 43, on each compartment 12 could display the status of the dish in that compartment 12 (e.g. red for dirty, blue for washing, and green for clean and ready to grab).

While a “one kitchen item per compartment” solution is presented, a “stack to stack” design is contemplated which involves feeding a dirty stack of dishes (one or more dirty dishes) into the top of a system. Such a system contemplates three types of dirty stacks: a bowl stack, a plate stack, and a cup stack. However, this design will involve many moving compartments which takes up a significant amount of space, so the “one item per compartment” concept is preferred.

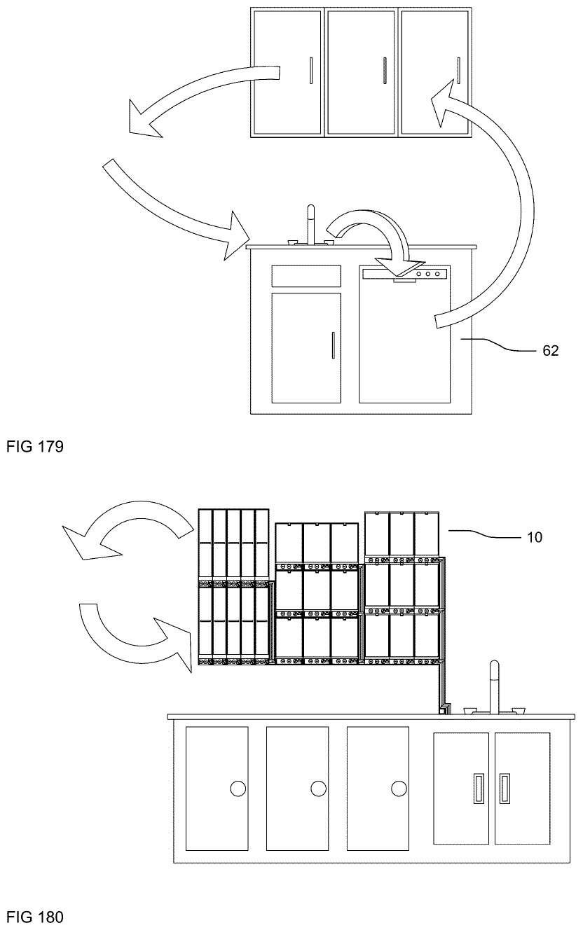

It's important to note that the stack to stack design also adheres to the same user interaction flow described in FIG. 180, where a dirty dish 23 can simply be dropped, and a clean dish 23 can be taken, without the usual added bottlenecks involved in the traditional system of FIG. 179. However, if the kitchen item 23 is excessively dirty (eg: a full bowl of soup), it may need to be rinsed in the sink 63 first, in order not to interfere too much with the stacking and dispensing mechanisms.

Stacks are very space efficient. However, transferring one stack to another and cleaning each dish 23 in a shared space one at a time requires several moving parts and mechanisms, and most importantly a good deal of space or volume. With the same amount of space, it was found that one could simply create several little static “cubbies” or compartments where each dish 23 lives. This requires less moving parts, and seems simpler and cheaper to build.

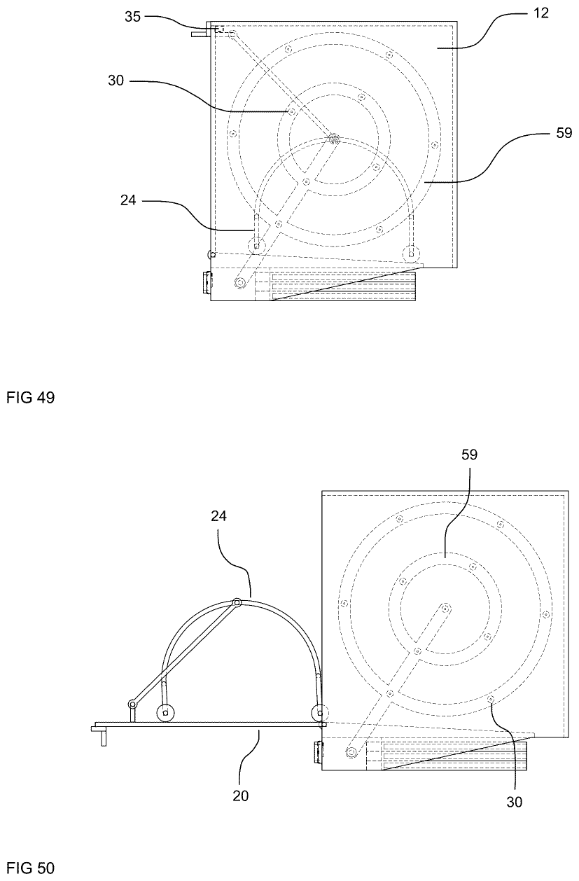

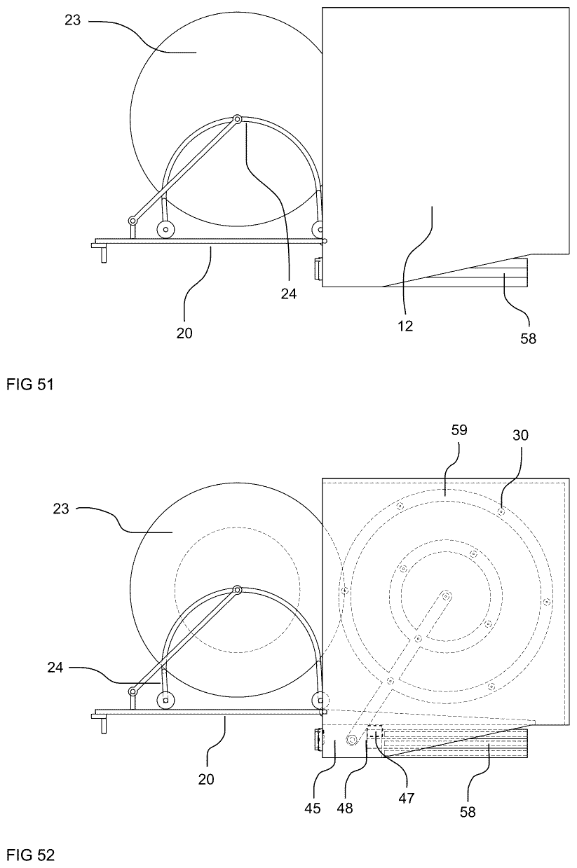

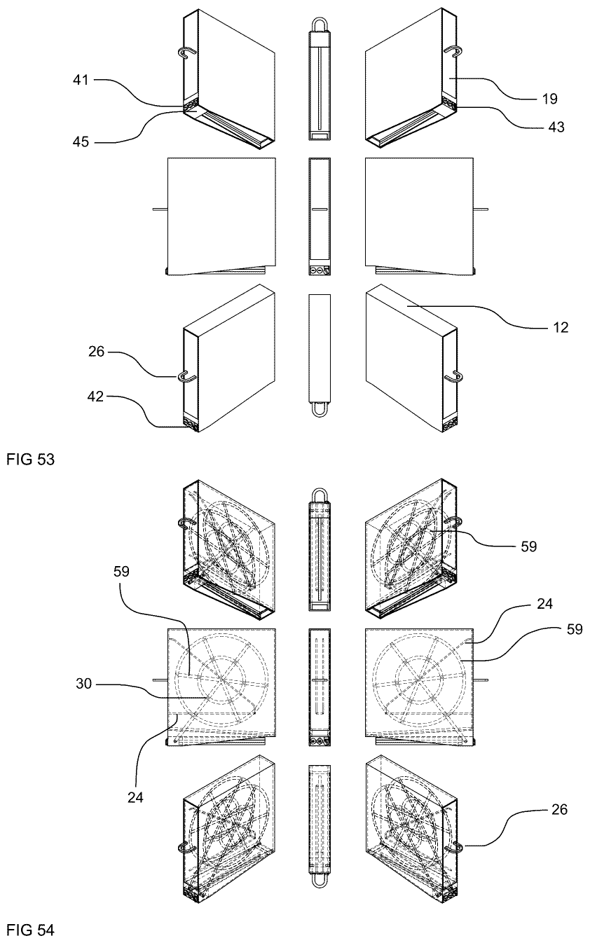

A common denominator for the kitchen storage system 10 is that a user can simply drop a dirty kitchen item 23 into an appropriate empty available cubby 27 housed in a compartment (e.g. single item compartment 12), and then grab a clean kitchen item 12 at his/her convenience. In these initial prototypes, the user may need to manually control a valve 48 associated with each compartment. Ideally the user would only need to worry about opening and closing an access point (e.g. hinge lid access point 20), and possibly interacting with an interface 45 (e.g. buttons, knobs) to control various settings (e.g. temperature, rinse, wash etc). In envisioned embodiments, users may not have to worry about managing an interface at all. A lid detector 35 and a kitchen item detector 47 (FIG. 52) could work in tandem for example to detect the presence of a new dirty kitchen item 23 in a compartment 12, and automatically begin the wash cycle once the lid sensor 35 detects the lid is closed (FIG. 49, 95). This doesn't need to be an electronic process either, the closing of the lid 20 (access point) itself could also physically actuate some mechanical valve 48, which is self closing.

The instant invention aims to solve the problem of “doing the dishes” and also provides a way to store other kitchen items 23 such as food and drinks in controlled isolated specialized cubbies 27 housed by compartments. The idea is that at a given moment, an empty cubby 27 will be available to drop a dirty dish 23 off, and at a given moment, a clean dish 23 will be available to take from a cubby 27 (except for the few minutes it might take to wait for a cubby to be cleaned if all cubbies are in a “not ready” state at the same time). Kitchen item cubbies 27 are independent from one another, meaning that for example, one cubby 27 can exist in a totally different state from the cubby 27 right next to it. This eliminates the typical bottleneck problem involved in doing the dishes 23, since one dish 23 is not dependent on the state of another to be processed. The cubbies 27 can be laid out in one of several possible orientations in 1D, 2D or 3D space. Kitchen item cubbies 27 can also share walls with adjacent cubbies 27 in a shared items compartment 14. Compartment 12 can optionally be modular, meaning it can be connected or removed from the frame, delivering fluid line(s) 16 and drainage conduit(s) 18. The two main parts of the backend are 1) fluid input 16: the fluid which can have temperature and pressure controls built in and 2) fluid output 18: a drainage pipe or channel for waste fluids to be discarded.

All in all, this invention combines together the functionality of the large boxy appliances we have gotten so used to using in kitchens all across the world, and drastically reduces the amount of user work that goes into maintaining a kitchen (especially in doing the dishes). Note that earlier “stack to stack” designs and prototypes are also included in this writeup, since they follow the same principles of the “drop and go” and “grab and go” concept of FIG. 180, however they are not the primary design being worked on at this time (compared to the “one dish per compartment” design).

What is claimed is:

1. A storage system for use in a habitat, which includes:
at least one compartment housing one or more kitchen item cubbies which are individually and separately sprayed with fluid, and are connected to at least one conduit operably disposed in the habitat to receive and convey fluid to or from said compartment.

2. The storage system of claim 1, wherein said cubby is configured with at least one device to control the direction of fluid flow as it enters said compartment.

3. The storage system of claim 1, wherein said cubby is configured with at least one device to control the direction of fluid flow as it exits said cubby.

4. The storage system of claim 1, wherein said cubby is configured with at least one device to control the velocity of fluid flow as it enters said compartment.

5. The storage system of claim 1, which includes at least two said conduits, wherein one said conduit is delivering one of fluid and air and interconnects to one of a fluid source and air source and another said conduit takes one of said fluid and said air from said cubby to a disposal area.

6. The storage system of claim 1, wherein said delivering fluid line is operably connected to a fluid/air temperature altering device for altering the temperature of the fluid and or air delivered to the cubby.

7. The storage system of claim 1, wherein said cubby is configured to retain a kitchen item.

8. The storage system of claim 1, wherein said kitchen item is one of a utensil, dish, cup, glass, vegetable and meat.

9. The storage system of claim 1, which further includes a valve connected to said conduit for controlling flow therethrough.

10. The storage system of claim 9, wherein said valve is one of manually and automatically actuated.
